(19) United States
(12) Patent Application Publication
(10) Pub. No.: US 2016/0328998 A1
(43) Pub. Date: Nov. 10, 2016

(54) VIRTUAL INTERACTIVE SYSTEM FOR ULTRASOUND TRAINING

(71) Applicant: Worcester Polytechnic Institute, Worcester, MA (US)

(72) Inventors: Peder C. Pedersen, Sterling, MA (US); Jason Kutarnia, Lunenburg, MA (US); Li Liu, Marlborough, MA (US)

(73) Assignee: Worcester Polytechnic Institute, Worcester, MA (US)

(21) Appl. No.: 15/151,784

(22) Filed: May 11, 2016

Related U.S. Application Data
(63) Continuation-in-part of application No. 12/728,478, filed on Mar. 22, 2010.
Application No. 12/728,478 is a continuation-in-part of application No. PCT/US09/37406, filed on Mar. 17, 2009.
(60) Provisional application No. 62/280,859, filed on Jan. 20, 2016.
(60) Provisional application No. 62/243,253, filed on Oct. 19, 2015.
(60) Provisional application No. 62/160,198, filed on May 12, 2015.
(60) Provisional application No. 61/037,014, filed on Mar. 17, 2008.

(51) Int. Cl. G09B 23/28; G09B 23/30

(52) U.S. Cl. CPC G09B 23/286; G09B 23/30

(57) ABSTRACT

A virtual interactive ultrasound training system provides training of medical personnel in the practical skills of performing ultrasound scans, including recognizing specific anatomies and pathologies. The training system can be utilized in an asynchronous mode in which the system is used locally by a learner for personal training. The system can also be used in a synchronous mode in which multiple systems are connected over a network, allowing multiple user located remotely from each other and/or from a training instructor to train under the supervision of the instructor.

### CROSS REFERENCE TO RELATED APPLICATIONS

This application is a continuation-in-part of U.S. patent application Ser. No. 12/728,478, filed in the U.S. Patent and Trademark Office (USPTO) on Mar. 22, 2010, entitled VIRTUAL INTERACTIVE SYSTEM FOR ULTRASOUND TRAINING, which is a continuation-in-part of PCT Patent Application Serial Number PCT/US09/37406, entitled VIRTUAL INTERACTIVE SYSTEM FOR ULTRASOUND TRAINING, filed on Mar. 17, 2009, which claims the benefit and priority date of U.S. Provisional Application No. 61/037,014, entitled VIRTUAL INTERACTIVE SYSTEM FOR ULTRASOUND TRAINING, filed on Mar. 17, 2008, all of which applications are incorporated herein by reference in their entirety.

This application also claims the benefit and priority date of U.S. Provisional Application No. 62/160,198, filed on May 12, 2015, entitled OBSTETRIC ULTRASOUND SIMULATOR WITH TASK-BASED TRAINING AND ASSESSMENT; 62/243,253, filed on Oct. 19, 2015, entitled ULTRASOUND E-TRAINING SYSTEM BASED ON NETWORKED SIMULATORS; and 62/280,859, filed on Jan. 20, 2016, entitled ULTRASOUND SIMULATOR FOR SYNCHRONOUS AND ASYNCHRONOUS SCAN TRAINING; all of which applications are incorporated herein by reference in their entirety.

### BACKGROUND

Simulation-based training is a well-recognized component in maintaining and improving skills. Consequently, simulation-based training is critically important for a number of professionals, such as airline pilots, fighter pilots, nurses and medical surgeons, among others. Such skills require hand-eye coordination, spatial awareness, and integration of multi-sensory input, such as tactile and visual. People in these professions have been shown to increase their skills significantly after undergoing simulation training.

A number of medical simulation products for training purposes are on the market. They include manikins for CPR training, obstetrics manikins, and manikins where chest tube insertion can be practiced, among others. There are manikins with an arterial pulse for assessment of circulatory problems or with varying pupil size for practicing endotracheal intubation. In addition, there are medical training systems for laparoscopic surgery practice, for surgical planning (based on three-dimensional imaging of the existing condition), and for practicing the acquisition of biopsy samples, to name just a few applications.

Ultrasound imaging is the only interactive, real time imaging modality. Much greater skill and experience is required for a sonographer to acquire and store ultrasound images for later analysis than for performing CT or MRI scanning. Effective ultrasound scanning and diagnosis based on ultrasound imaging requires anatomical understanding, knowledge of the appearance of pathologies and trauma, proper image interpretation relative to transducer position and orientation on the patient's body, the effect of compression on the patient's body by a transducer, and the context of the patient's symptoms.

Such skills are today primarily obtained through hands-on training in medical school, at sonographer training programs, and at short courses. These training sessions are an expensive proposition because a number of live, healthy models, ultrasound imaging systems, and qualified trainers are needed, which detract from their normal diagnostic and revenue-generating activities. There are also not enough teachers to meet the demand because qualified sonographers and physicians are required to earn Continuing Medical Examination (“CME”) credits annually.

Various ultrasound phantoms have been developed and are widely used for medical training purposes, such as prostate phantoms, breast phantoms, fetal phantoms, phantoms for practicing placing IV lines, etc. There are major limitations to the use of these phantoms for ultrasound training purposes. First, they need to be used together with an available ultrasound scanner. Thus, such simulation training can only occur at the hospital and only when the ultrasound scanner is not otherwise used for patent examination. Second, with a few exceptions, phantoms are not generally available for training to recognize trauma and pathology situations. Thus, formal automated training to locate an inflamed pancreas, find gallstones, determine abnormal fetal development, detect venous thrombosis, to name a few, is generally not available. When a trauma case occurs, treatment is of course paramount, and there is no time available for training. In addition, these phantoms are static or have specialized parts, and so fall short of simulating a dynamic, interactive human.

Given the ubiquitous use of ultrasound for medical diagnosis and the large number of potential users, there is a large and unmet need for cost-effective ultrasound training. Training needs comes in several forms, including: (i) training active users in using new ultrasound scanners; (ii) training active users in new diagnostic procedures; (iii) training active users for re-certification, to maintain skills and earn continuing medical education credit on an annual basis; and (iv) training new users, such as primary care physicians, emergency medicine personnel, paramedics and EMTs.

What is needed is a better system and method of use that can help train ultrasound operators on a wide-range of diagnostic subjects in a cost-effective, realistic, and consistent way.

### SUMMARY

The needs set forth herein as well as further and other needs and advantages are addressed by the present embodiments, which illustrate solutions and advantages described below.

According to one aspect, an ultrasound training simulator system is provided. The system includes a physical scan surface for simulating an anatomical surface and a mock transducer for moving over the physical scan surface to simulate an ultrasound transducer scanning the anatomical surface. A memory stores data for a three-dimensional (3-D) image volume. A processor receives one or more signals generated by the mock transducer related to position and orientation of the mock transducer as the mock transducer is moved over the physical scan surface, the processor identifying data for a two-dimensional (2-D) image data slice within the data for the 3-D image volume based on the signals related to position and orientation of the mock transducer. The mock transducer comprises an optical tracking system for tracking the position of the mock transducer on the physical scan surface and an inertial tracking system for tracking orientation of the mock transducer, the optical tracking system and the inertial tracking system generating signals from which the one or more signals related to position and orientation of the mock transducer are generated.

In some exemplary embodiments, the optical tracking system comprises a digital-paper-based optical tracking system. The digital-paper-based optical tracking system can be an Anoto® system.

In some exemplary embodiments, the optical tracking system comprises a 2-D array of optically detectable elements on the physical scan surface. The optical tracking system can include an optical detector in the mock transducer for detecting the optically detectable elements on the physical scan surface.

In some exemplary embodiments, the optical tracking system comprises an optical detector in the mock transducer for detecting optically detectable elements of a 2-D array of optically detectable elements on the physical scan surface.

In some exemplary embodiments, the optical tracking system is an infrared (IR) optical tracking system.

In some exemplary embodiments, the inertial tracking system comprises an inertial measurement unit (IMU).

In some exemplary embodiments, the inertial tracking system comprises a three-axis gyroscope.

In some exemplary embodiments, the system further comprises a display coupled to the processor for presenting a 2-D image generated by reslicing the 3-D image volume.

In some exemplary embodiments, the processor presents ultrasound training tasks on display to be performed by a trainee moving the mock transducer over the scanning surface. The training tasks can include at least one of identifying anatomical structures and performing biometric measurements. The processor can generate an assessment of the trainee's performance of the ultrasound training tasks. Assessment criteria for acceptable accuracy of a biometric measurement performed by the trainee can be adjustable.

In some exemplary embodiments, the 3-D image volume includes at least one landmark bound comprising a surface at least partially enclosing an anatomical landmark in the 3-D image volume, an assessment generated by the processor comprising a determination as to whether an identification of the anatomical landmark is within the landmark bound in the 3-D image volume. Accuracy of the assessment can be adjustable by adjusting a distance between the landmark bound and the anatomical landmark. The assessment can be displayed on a display such that feedback is provided to the trainee.

In some exemplary embodiments, a user interface permits the trainee to access instructional information stored in the memory to assist with performance of the training tasks. The instructional information accessed by the trainee can be related to a specific training task being performed by the trainee.

In some exemplary embodiments, the physical scan surface is associated with a virtual torso and the mock transducer is associated with a virtual transducer, the processor performing a transformation between the physical scan surface and the virtual torso and between the mock transducer and the virtual transducer such that the signals related to position and orientation of the mock transducer as the mock transducer is moved over the physical scan surface are associated with positions in the 3-D image volume.

In some exemplary embodiments, the system further comprises at least one second ultrasound training simulator system remote from the first ultrasound training simulator system and coupled to the first ultrasound training simulator system over a network; and at least one second memory coupled to the at least one second ultrasound training simulator system for storing the data for the 3-D image volume. The at least one second ultrasound training simulator system can receive over the network the one or more signals generated by the mock transducer related to position and orientation of the mock transducer as the mock transducer is moved over the physical scan surface, the at least one second ultrasound training simulator system identifying data for a 2-D image data slice within the data for the 3-D image volume based on the signals related to position and orientation of the mock transducer. One of the first and second ultrasound training simulator systems can be an active system defined as an operator simulator, and another of first and second ultrasound training simulator systems can be a passive system defined as an observer simulator. An input provided via a user interface can define which of the first and second ultrasound training simulator systems is defined as the operator simulator. One of the ultrasound training simulator systems is operable by an instructor, and at least one second ultrasound training simulator system is operable by a trainee, wherein the status of operator simulator is assignable by the instructor to either himself or to a selected trainee, wherein at least one second ultrasound training simulator system is assignable the status of observer simulator, and wherein a signal defining the operator simulator and the observer simulators is generated by the instructor's simulator. A 2-D image display on at least one of the observer simulators can be generated by reslicing the 3-D image volume based on signals received over the network from the operator simulator.

The method of present embodiment for generating ultrasound training image material can include, but is not limited to including, the steps of scanning a living body with an ultrasound transducer to acquire more than one at least partially overlapping ultrasound 3D image volumes/scans, tracking the position/orientation of the ultrasound transducer while the ultrasound transducer scans in a preselected number of degrees of freedom, storing the more than one at least partially overlapping ultrasound 3D image volumes/scan and the position/orientation on computer readable media, and stitching the more than one at least partially overlapping ultrasound 3D image volumes/scans into one or more 3D image volumes based on the position/orientation.

The tracking may take place over the body surface of a physical manikin, or it may take place over a scanning surface, emulating a specific anatomical region of a virtual torso appearing on the same screen as the ultrasound image or on a different screen from the ultrasound image. In the case of tracking the position and orientation of the mock transducer over a scanning surface, a virtual transducer on the surface of a virtual torso is moved correspondingly.

The method can optionally include the steps of inserting and stitching at least one other ultrasound scan into the one or more 3D image volumes, storing a sequence of moving images (4D) as a sequence of the one or more 3D image volumes each tagged with time data, digitizing data corresponding to an manikin surface of the manikin, recording the digitized surface on a computer readable medium represented as a continuous surface, and scaling the one or more 3D image volumes to the size and shape of the manikin surface of the manikin.

Optionally, a specified surface area of the virtual torso, equal to its scan-able area, can be displayed to have the exact body appearance as the part of the body surface of the human subject that was scanned to produce the image data. That specified area corresponds to the area of the physical scan surface. The data that need to be obtained to create the scan-able area of the virtual torso can be acquired by moving a tracking system that is attached to the actual ultrasound transducer in a relatively closely-spaced grid pattern over the body surface of the human subject, possibly not collecting image data. These tracking data can be captured by, for example, is capture software, and can be provided to a conventional computer system, such as, for example, a user-contributed library, gridfit, from MATLAB®'s File Exchange, that can reconstruct the body surface based on the tracking data. Ultimately, a user can choose an image from a library of, for example, 3D image volumes containing a given pathological condition, for example, a sixty year old male having a kidney abnormality. As a result of the present teachings, an exact body size can accompany the image volume of a given pathological condition, when the virtual torso and a physical scan surface are used for training instead of the manikin.

The acquisition system for obtaining an image volume from a human subject of the present embodiment can include, but is not limited to including an ultrasound transducer and associated ultrasound imaging system, at least one 6 degrees of freedom tracking sensor integrated with the ultrasound transducer/sensor, a volume capture processor generating a position/orientation of each image frame contained in the ultrasound scan relative to a reference point, and producing at least one 3-D volume obtained with the ultrasound scan, and a volume stitching processor combining a plurality of the at least two 3-D volumes into one composite 3D volume. The system can optionally include a calibration processor establishing a relationship between output of the ultrasound transducer/sensor and the ultrasound scan and a digitized surface of a manikin, an image correction processor applying image correction to the ultrasound scan when there is tissue motion, resulting in the 3D volume reflecting tissue motion correction, and a numerical model processor acquiring a numerical virtual model of the digitized surface, and interpolating and recording the digitized surface, represented as a continuous surface, on a computer readable medium.

The ultrasound training system of the present embodiment can include, but is not limited to including, one or more scaled 3-D image volumes stored on electronic media, the image volumes containing 3D ultrasound scans recorded from a living body, a manikin, a 3-D image volume scaled to match the size and shape of the manikin, a mock transducer having sensors for tracking a mock position/orientation of the mock transducer relative to the manikin in a preselected number of degrees of freedom, an acquisition/training processor having computer code calculating a 2-D ultrasound image from the based on the position/orientation of the mock transducer, and a display presenting the 2-D ultrasound image for training an operator.

Alternatively, the ultrasound training system of the present embodiment can include a virtual torso and a physical scan surface in the place of a manikin, this virtual torso being displayed in 3D rendering on a computer screen. When the body appearance of the virtual torso is an exact replica of the human being that was scanned for the ultrasound image volume, no scaling is needed to scale the image volume to fit the virtual torso. The virtual torso can be scanned by a virtual transducer, whose position and orientation appears on the body surface of the virtual torso and whose position and orientation are controlled by the trainee by moving a mock transducer over a physical scan surface. This scan surface may be flat or curved, optionally resembling the geometry of the human body surface being emulated by the simulator, and can have the mechanical compliance approximating that of a soft tissue surface, for example, a skin-like material backed by ½ inch to 1 inch of appropriately compliant foam material. If optical tracking is used, then the skin surface must have the necessary optical tracking characteristics. Alternatively, a graphic tablet such as, for example, but not limited to, the WACOM® tablet can be used, covered with the compliant foam material and a skin-like surface. As a further alternative, the scanning surface can be embedded with a dot pattern, such as, for example, the ANOTO® dot pattern, as used with a digital paper and digital pen.

The acquisition/training processor can record a training scan pattern and a sequence of time stamps associated with the position and orientation of the mock transducer, scanned by the trainee on the manikin or on a physical scan surface, compare a benchmark scan pattern, scanned by an experienced sonographer, of the manikin with the training scan pattern, and store results of the comparison on the electronic media. The system can optionally include a co-registration processor co-registering the 3-D image volume with the surface of the manikin in 6 DOF by placing the mock transducer at a specific calibration point or placing a transmitter inside the manikin, a pressure processor receiving information from pressure sensors in the mock transducer, and a scaling processor scaling and conforming a numerical virtual model to the actual physical size of the manikin as determined by the digitized surface, and modifying a graphic image based on the information when a force is applied to the mock transducer and the manikin surface of the manikin. The system can further optionally include instrumentation in or connected to the manikin to produce artificial physiological life signs, wherein the display is synchronized to the artificial life signs, changes in the artificial life signs, and changes resulting from interventional training exercises, a position/orientation processor calculating the 6 DoF position/orientation of the mock transducer in real-time from a priori knowledge of the manikin surface and less than 6 DoF position/orientation of the mock transducer on the manikin surface, an interventional device fitted with a 6 DoF tracking device that sends real-time position/orientation to the acquisition/training processor, a pump introducing artificial respiration to the manikin, the pump providing respiration data to an mock transducer processor, an image slicing/rescaling processor dynamically rescaling the 3-D ultrasound image to the size and shape of the manikin as the manikin is inflated and deflated, and an animation processor representing an animation of the interventional device inserted in real-time into the 3-D ultrasound image volume.

The method of the present embodiment for evaluating an ultrasound operator can include, but is not limited to including, the steps of storing a 3-D ultrasound image volume containing an abnormality on electronic media, associating the 3-D ultrasound image volume with a manikin or a virtual torso and a physical scan surface (together referred to herein as a body representation), receiving an operator scan pattern associated with the body representation from a mock transducer, tracking mock position/orientation of the mock transducer in a preselected number of degrees of freedom, recording the operator scan pattern using the mock position/orientation, displaying a 2-D ultrasound image slice from the 3-D ultrasound image volume based upon the mock position/orientation, receiving an identification of a region of interest associated with the body representation, assessing if the identification is correct, recording an amount of time for the identification, assessing the operator scan pattern by comparing the operator scan pattern with an expert scan pattern, and providing interactive means for facilitating ultrasound scanning training. The method can optionally include the steps of downloading lessons in image-compressed format and the 3-D ultrasound image volume in image compressed format through a network from a central library, storing the lessons and the 3D ultrasound image volume on a computer-readable medium, modifying a display of the 3-D ultrasound image volume corresponding to interactive controls in a simulated ultrasound imaging system control panel or console with controls, displaying the location of an image plane in the 3-D ultrasound image volume on a navigational display, and displaying the scan path based on the digitized representation of the body representation surface of the body representation.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims

### BRIEF DESCRIPTION OF THE DRAWINGS

FIG. 1 is a pictorial depicting one embodiment of the method of generating ultrasound training material;

FIG. 2A is a pictorial depicting one embodiment of the ultrasound training system;

FIG. 2B is a pictorial depicting the conceptual appearance of interactive training system with virtual torso;

FIG. 2C is a block diagram depicting the main components of interactive training system with virtual torso;

FIG. 2D is a pictorial depicting the compliant scan pad with built-in position sensing; mock transducer with Micro-Electro-Mechanical Systems (MEMS)-based angle sensing capabilities;

FIG. 2E is a pictorial depicting the compliant scan pad without built-in position sensing mock transducer with optical position sensing and MEMS-based angle sensing capabilities;

FIG. 3 is a block diagram describing another embodiment of the ultrasound training system;

FIG. 4 is a block diagram describing yet another embodiment of the ultrasound training system;

FIG. 5 is a pictorial depicting one embodiment of the graphical user interface for the display of the ultrasound training system;

FIG. 6 is a block diagram describing one embodiment of the method of distributing ultrasound training material;

FIG. 7 is a pictorial depicting one embodiment of the manikin used with the ultrasound training system;

FIG. 8 is a block diagram describing one embodiment of the method of stitching an ultrasound scan;

FIG. 9 is a block diagram describing one embodiment of the method of generating ultrasound training image material;

FIG. 10 is block diagram describing one embodiment of the mock transducer pressure sensor system;

FIG. 11 is a block diagram describing one embodiment of the method of evaluating an ultrasound operator;

FIG. 12 is a block diagram describing one embodiment of the method of distributing ultrasound training material; and

FIG. 13 is a block diagram of another embodiment of the ultrasound training system.

FIG. 14 is a block diagram of an ultrasound simulation system, according to exemplary embodiments;

FIG. 15A is a pictorial of an exemplary display on the graphical user interface of the ultrasound simulation system, according to exemplary embodiments;

FIG. 15B is a pictorial of a physical scan surface and mock transducer, according to exemplary embodiments;

FIG. 16 is a schematic illustration of the interaction between a digital pen in mock transducer and a digital paper pattern on a physical scan surface, according to some exemplary embodiments;

FIG. 17 includes a schematic functional block diagram of a mock transducer, according to exemplary embodiments;

FIG. 18 is a schematic cross-sectional view of a physical scan surface, according to exemplary embodiments;

FIG. 19 is an image of a 3D volume mesh, with the surface of the image volume shown in darker shading, according to exemplary embodiments;

FIG. 20, is an image of an abdominal image surface (AIS), according to exemplary embodiments;

FIG. 21 is a block diagram of an ultrasound simulator structure, according to exemplary embodiments;

FIG. 22 is a pictorial and schematic functional block diagram illustrating a position and orientation transformation, according to exemplary embodiments;

FIG. 23 is a schematic functional diagram of three modules of the training of an ultrasound simulator, according to exemplary embodiments;

FIG. 24 is a schematic logical flow diagram of the three steps executed in training modules, according to exemplary embodiments;

FIG. 25 presents the comparison between clinical images and simulator-generated images from the same subject, according to exemplary embodiments;

FIG. 26 is a schematic functional block diagram of a procedure for generating a virtual scan surface (VSS) and virtual abdominal surface (VAS), according to exemplary embodiments;

FIG. 27 is a pictorial image of a best fit cylinder for an abdominal surface, according to exemplary embodiments;

FIG. 28 is a pictorial image of an abdominal surface in standard position, according to exemplary embodiments;

FIG. 29 is a pictorial image of a cylinder cross-section angle, determined by two AIS vertices (p₁ and p₂), which can yield maximal angle, according to exemplary embodiments;

FIG. 30 is a pictorial image of the virtual cylinder segment defining the VSS as a least square fit to a given AIS, according to exemplary embodiments;

FIG. 31 is a pictorial image of a best fit ellipsoid, according to exemplary embodiments;

FIG. 32 is a pictorial image of the virtual ellipsoid segment defining the VAS as a least square fit to a given AIS, according to exemplary embodiments;

FIG. 33 is schematic cross-sectional diagrams of the PSS and VSS, illustrating deviation angles, according to exemplary embodiments;

FIG. 34 is a schematic cross-sectional diagrams of the VSS and VAS, illustrating deviation angles, according to exemplary embodiments;

FIG. 35 is a pictorial image of a dynamic PSS-based local coordinate system, according to exemplary embodiments;

FIG. 36 is a pictorial image of an identity quaternion in PSS coordinates, according to exemplary embodiments;

FIG. 37 is a schematic diagram depicting an ultrasound simulator in synchronous mode and in asynchronous mode, according to exemplary embodiments;

FIG. 38 is a schematic functional block diagram illustrating workflow of the ultrasound training simulators in synchronous mode, according to exemplary embodiments;

FIG. 39 includes a 3D presentation of the average scanning times for 24 training medical students, for each of 6 ultrasound training tasks, according to exemplary embodiments;

FIG. 40 is a graph illustrating the average scanning times of each image volume during the evaluation, according to exemplary embodiments.

FIGS. 41A, 41B and 41C show box plots of BPD, AC and FL values, respectively, measured by trainees and by an expert sonographer, according to exemplary embodiments;

FIGS. 42A, 42B and 42C include bar graph plots of the relative error in the BPD, AC and FL measurement values, respectively, when using as reference the values measured by the expert sonographer, according to exemplary embodiments; and

FIG. 43 includes bar graphs, illustrating two-way latencies for the 3 test conditions, from two computers, according to exemplary embodiments.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

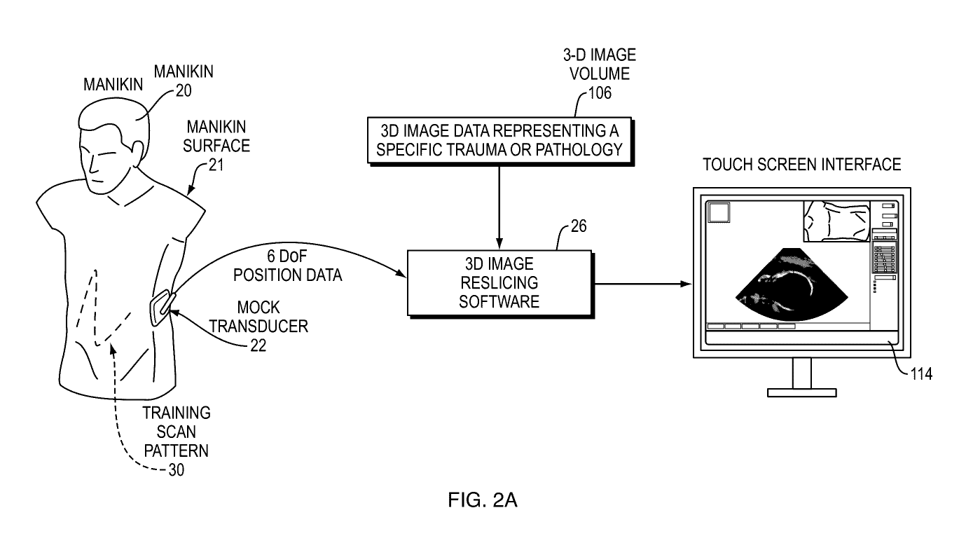

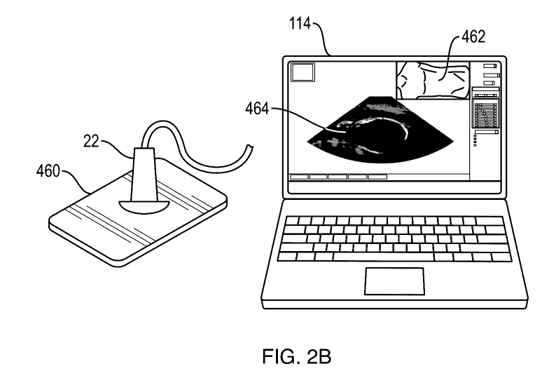

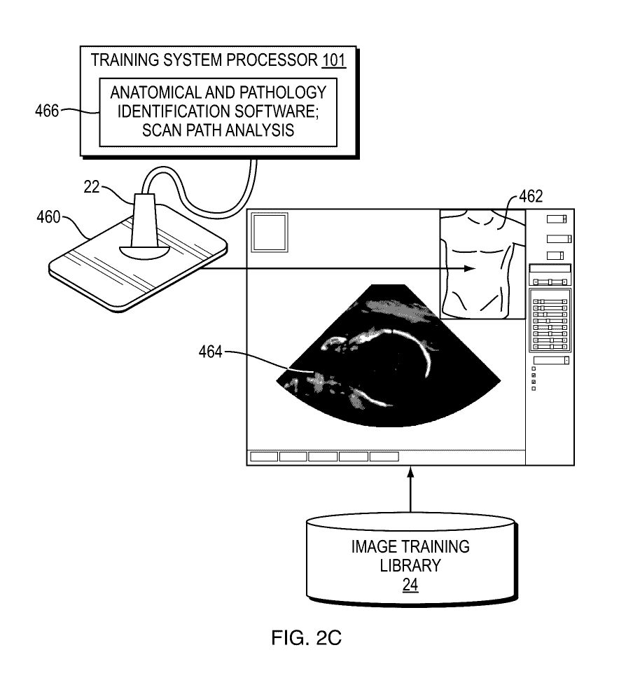

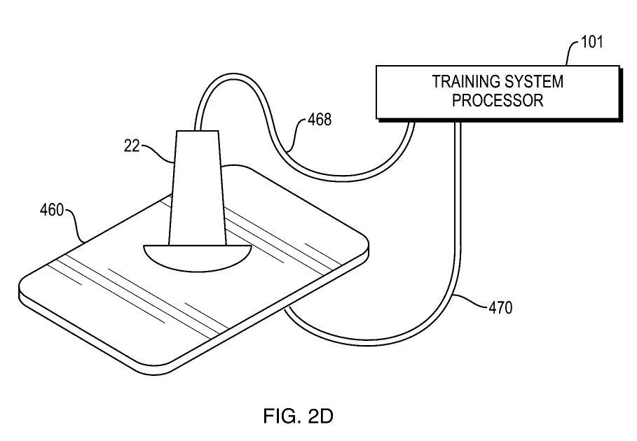

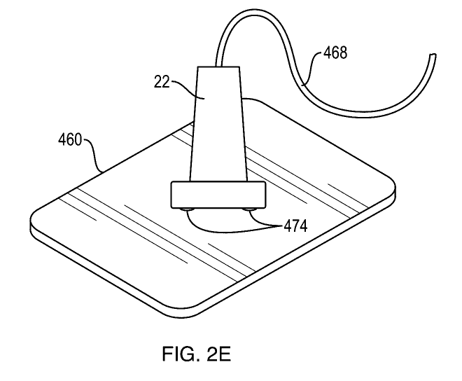

Previous ultrasound simulators are expensive, dedicated systems that present barriers to widespread use. The system described herein is a simple, inexpensive approach that enables simulation and training in the convenience of an office home or training environment. The system may be PC-based and computers used in the office or at home for other purposes can be used for the simulation of ultrasound imaging as described below. In addition, an inexpensive manikin representing a body part such as a torso (possibly with a built-in transmitter), a mock ultrasound transducer with tracking sensors, and the software described below help complete the system (shown in FIG. 2A).

An alternative embodiment can be achieved by scanning with a mock transducer over a physical scan surface with the mechanical characteristics of a soft tissue surface. The mock transducer alone may implement the necessary 5 DoF, or the 5 DoF may be achieved through linear tracking integrated in the scan surface or linear tracking by optical means on the scan surface and angular tracking integrated into the mock transducer. The movements of the mock transducer over the physical scan surface are visualized in the form of a virtual transducer moving over the body surface of a virtual torso.

The simplicity of this approach makes it possible to create low-cost simulation systems in large numbers. In addition, the 3-D ultrasound image volumes used for the training system can be easily mass produced and made downloadable over the Internet as described below.

When using a physical manikin, the sensors of the tracking systems described herein are referred to as external sensors because they require external transmitters in addition to tracking sensors integrated into the mock transducer handle. In contrast, self-contained tracking sensors can be used either with the physical manikin or with physical scan surface (i.e., scan pad) in combination with the virtual torso and the virtual transducer. These sensors only require that sensors be integrated into a mock transducer handle in order to determine the position and the orientation of the transducer with five degrees of freedom, although not limited thereto. The self-contained tracking sensors can be connected either wirelessly or by standard interfaces such as USB to a personal computer. Thus, the need for external tracking infrastructure is eliminated. Alternatively, external tracking can be achieved through image processing, specifically by measuring the degree of image decorrelation. However, such decorrelation may have a variable accuracy and may not be able to differentiate between the transducer being moved with a fixed orientation or being angled at a fixed position.

The sensors in the self-contained tracking system may be of a MEMS-type and an optical type, although not limited thereto. An exemplary tracking concept is described in International Publication No. WO/2006/127142, entitled Free-Hand Three-Dimensional Ultrasound Diagnostic Imaging with Position and Angle Determination Sensors, dated Nov. 30, 2006 (142), which is incorporated by reference herein in its entirety. The position of the mock transducer on the surface of a body representation may be determined through optical sensing, in a principle similar to an optical mouse that uses the cross-correlation between consecutive images captured with a low-resolution CCD array to determinate change in position. However, for the sake of a compact design near the phantom surface, the image may be coupled from the surface to the CCD array via an optical fiber bundle. Excellent tracking has been demonstrated. Very compact, low-power angular rate sensors are now available to determine the orientation of the transducer along three orthogonal axes. Occasionally, however, the transducer may need to be placed in a calibration position to minimize the influence of drift.

The optical tracking described above is a single optical tracker, which can provide position information, but has no redundancy. In contrast, a dual optical tracker, which can include, but is not limited to including, two optical tracking computer mice, one in each end of the mock transducer, provides two advantages: if one optical tracker should lose position tracking because one end of the mock transducer is momentarily lifted, the other can maintain tracking. In addition, a dual optical tracker can determine rotation and can provide redundancy for the MEMS rotation sensing. For example, using an optical mouse, an image of the scanned surface can be captured as is known in the art. If two computer mice are attached, a dual optical tracker device can be constructed which can detect rotation (see '142). A third alternative is to embed or cover the physical scan surface with a coded dot pattern, such as the ANOTO® dot pattern, as used with a digital paper and digital pen as described in U.S. Pat. No. 5,477,012, which is incorporated herein in its entirety by reference. The dot pattern is non-repeating, and can be read by a camera which can, because of the dot pattern, unambiguously determine the absolute location on the scan surface.

The manikin may represent a certain part of the human anatomy. There may be a neck phantom or a leg phantom for training on vascular imaging, an abdominal phantom for internal medicine, and an obstetrics phantom, among others. In addition, a phantom with cardiac and respiratory movement may be used. This may require a sequence of ultrasound image volumes to be acquired (where the combined sequence of image volumes may be referred to as a 4D image volume, with the 4^{th} dimension being time), where each image volume corresponds to a point in time in the cardiac cycle. In this case, due to the data size, the information may need to be stored on a CD-ROM or other storage device rather than downloaded over a network as described below. The manikin can be solid, hollow, even inflatable, as long as it produces an anatomically realistic shape, and it provides a good surface for scanning. Optionally, the outer surface may have the touch and feel of a real skin. Another variation of the phantom could be made of transparent “skin” and actually contain organs. Even in this case, there will be no actual scanning, and the location of the organ must correspond to what is seen on the ultrasound training image.

In another embodiment the manikin may not necessarily have the outer shape of a body part but may be a more arbitrary shape such as a block of tissue-mimicking material. This phantom can be used for needle-guidance training. In this case, both the needle and the mock transducer may have five or six DOF sensors and the position of the needle is overlaid on the image plane selected by the orientation and position of the mock transducer. An image of the part of the needle in the image plane may be superimposed on the usual selected cut plane determined by transducer position, described further below. The 3-D image training material can contain a predetermined body of interest, such as an organ or a vessel such as vein, although not limited thereto. Even though the needle goes in the manikin (e.g., smaller carotid phantom) described above, it may not be imaged. Instead, a realistic simulation needle, based on the 3-D position of the needle, can be animated and overlaid on the image of the cut plane.

In a different embodiment, there is no physical manikin, but a virtual torso which exists only in electronic form, along with the physical scan surface. Of significance is the fact that the scan-able part of the virtual torso may have the exact appearance of part of the body surface of the human subject that was scanned to provide the image material. Image material from male and female, young and old, heavy and thin, can be represented by the corresponding body appearance. This exact appearance is acquired through scanning the body surface with the tracking sensor in a closely spaced grid pattern.

The physical scan surface, such as the scan pad, on which the trainee moves the mock transducer, can represent a given surface area of the virtual torso. The location on the body surface of the virtual torso that is represented by the scan pad can be highlighted. This location can be shifted to another part of the body surface by the use of arrow keys on the keyboard, by the use of a computer mouse, by use of a finger with a touch screen, by use of voice commands, or by other interactive techniques. Likewise, the area of the body surface represented by the scan pad can correspond to the same area of the body surface of the virtual torso, or to a scaled up or scaled down area of the body surface.

The physical scan surface, i.e., scan pad, may be a planar surface of unchangeable shape, or it may be a curved surface of unchangeable shape, or it may be changeable in shape so it can be modified from a planar surface to a curved surface of arbitrary shape and back to a planar surface.

Finally, the ultrasound training system can be used with an existing patient simulator or instrumented manikin. For example it can be added to a universal patient simulator with simulated physiological and vital signs such as the SimMan® simulator. Because the present teachings do not require a phantom to have any internal structure, a manikin can be easily used for the purposes of ultrasound imaging simulation.

One aspect of this system is the ability to quickly download image training volumes to a computer over the internet, described further below. In previous simulators, only a limited number of image volumes have been made available due in part to the technical problems with distributing such large files. In one embodiment, the image training volumes can be downloaded from the Internet using a very effective form of image compression, or be available on CD or DVD, likewise using a very effective form of image compression, such as an implementation of MPEG-4 compression.

Downloading the image volumes from the Internet may require special algorithms and software, which give computationally efficient and effective image compression. In this scheme image planes at sequential spatial locations are recorded as an image time sequence (series of image frames) or image loop; therefore, the compression scheme for a moving image sequence can be used to record a 3-D image volume. One codec in particular, H.264, can provide a compression ratio of better than 50 for moving images, while retaining virtually original image quality. In practice this means that an image volume containing one hundred frames can be compressed to a file only a few MBs in size. With a cable modem connection, such a file can be downloaded quickly. Even if the image volumes are stored on CD or DVD, image compression permits far more data storage. The codecs and their parameter adjustments will be selected based on their clinical authenticity. In other words, image compression cannot be applied without verifying first that important diagnostic information is preserved.

A library of ultrasound image training volumes may be developed, with a “sub-library” for each of the medical specialties that use ultrasound. Each sub-library will need to include a broad selection of pathologies, traumas, or other bodies of interest. With such libraries available the sonographer can stay current with advancing technology, and become well-experienced in his/her ability to locate and diagnose pathologies and/or trauma. The image training material may consist of 3-D image volumes—that is, it is composed of a sequence of individual scan frames. The dimensions of the scan frames can be quantified, either in distances or in round-trip travel times, as well as the spacing and spatial orientation of the individual scan planes. The image training material may also consist of a 3D anatomical atlas, which is treated by the ultrasound training system as if it were an image volume.

The image training volumes may be of two types: (i) static image volumes; and (ii) dynamic image volumes. A static image volume is generated by sweeping the transducer over a stationary part of a body and does not exhibit movement due to the heart and respiration. In contrast, a dynamic volume includes the cardiac generated movement of organs. For that reason it would appropriately be called a 4-D volume where the 4th dimension is time. In the 4-D case, the spatial locations of the scan planes are the same and are recorded at different times, usually over one cardiac cycle. For example, for 4-D imaging of the heart the time span will be equal to one cardiac cycle. The total acquisition time for each 3-D set in a 4-D dynamic volume set is usually small compared with the time for a complete cycle. A dynamic image volume will typically include 10-15 3-D image volumes, acquired with constant time interval over one cardiac cycle.

The image training volumes in the library/sub-libraries may be indexed by many variables: the specific anatomy being scanned; whether this anatomy is normal or pathologic or has trauma; what transducer type was used; and/or what transducer frequency was used, to name a few. Thus, one may have hundreds of image volumes, and such an image library may be built up over some time.

The training system provides an additional important feature: it can evaluate to what extent the sonographer has attained needed skills. It can track and record mock transducer movements (scan patterns) made to locate a given organ, gland or pathology, and it can measure how long it took the operator to do so. By touch screen annotation, the operator/trainee can identify the image frame that shows the pathology to be located. In another exercise, for example, although not limited thereto, the sonographer may be presented with ten image volumes, representing ten different individual patients, and be asked to identify which of these ten patients have a given type of trauma (e.g., abdominal bleeding, etc.), or a given type of pathology (e.g., gallstones, etc.).

The value of the virtual interactive training system is greatly increased by enabling the system to demonstrate that the student has improved his/her scanning ability in real-time, which will allow the system to be used for earning Continuing Medical Education (CME) credits. With touch screen annotation or another interactive method, the user can produce an overlay to the image that can be judged by the training system to determine whether a given anatomy, pathology or trauma has been located. The user may also be asked to determine certain distances, such as the biparietal diameter of a fetal head. Inferences necessary for diagnosis can also be evaluated, including the recognition of a pattern, anomaly or a motion.

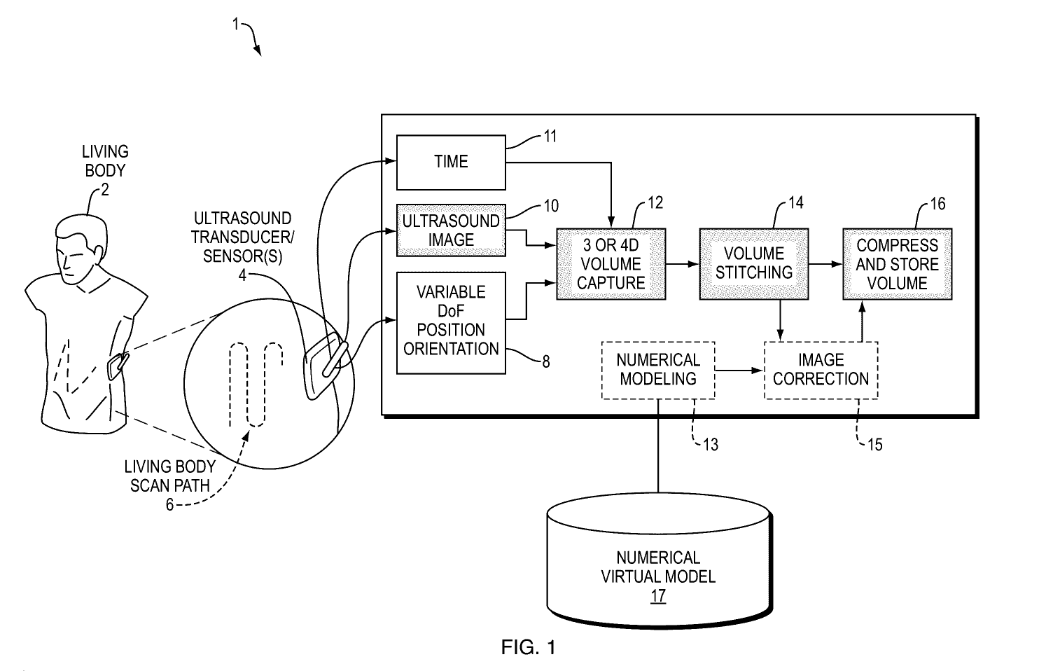

Referring to FIG. 1, shown is a pictorial depicting one embodiment of the method of generating ultrasound training image material. The ultrasound training image material is in the form of 3-D composite image volumes which are acquired from any number of living bodies 2. To be useful for training purposes, the training material should cover a significant segment of the human anatomy, such as, although not limited thereto, the complete abdominal region, a total neck region, or the lower extremity between hip and knee. A library of ultrasound image volumes can being assembled using many different living bodies 2. For example, although not limited thereto, humans having varying types of pathologies, traumas, or anatomies (collectively positions of interest) could be scanned in order to help provide diagnostic training and experience to the system operator/trainee. Any number of animals could also be scanned for veterinarian training. In addition, a healthy human could be scanned to create a 3-D image volume and one or more ultrasound scans containing some predetermined body of interest (e.g., trauma, pathology, etc.) could then be inserted, discussed further below.

Due to the size of the ultrasound transducer 4, a complete ultrasound scan of the living body 2 cannot be acquired in a single sweep. Instead, the scan path 6 will comprise multiple sweeps over the living body 2 being scanned. To aid in stitching separate 3-D ultrasound scans acquired using this freehand imaging approach into a single image volume, discussed further below, tracking sensors are used with the ultrasound transducer 4 to track its position and orientation 126. This may be done in 6 degrees of freedom (“DoF”), although not limited thereto. In such a way, each ultrasound image 10 of the living body 2 corresponds with position and orientation 126 information of the transducer 4. Alternatively, a mechanical fixture can be used to translate the transducer 4 through the imaging sequence in a controlled way. In this case, tracking sensors are not needed and image planes are spaced at uniform known intervals.

Because the individual ultrasound images 10 will be combined into a single 3-D image volume 12, it is helpful if there are no gaps in the scan path 6. This can be accomplished by at least partially overlapping each scan sweep in the scan path 6. A stand-off pad may be used to minimize the number of overlapping ultrasound to scans. Since the position and orientation 8 of the ultrasound transducer 4 is also recorded, any redundant scan information due to overlapping sweeps can be removed when the ultrasound images 10 are volume stitching 14, discussed further below.

Once the ultrasound images 10 are captured in a 3-D or 4-D (also using time 11) volume 12, any overlaps or gaps in the scan pattern 6 can be fixed by using the position and orientation 126 during volume stitching 12. In 3-D, stitching can prove difficult to do manually. Custom 3^{rd} party software, such as Stradwin software developed by Treeece et al can be used to stitch the individual ultrasound images 10 into complete 3-D volumes which completely representing the living body 2. The conventional software can line up the scans based on the recorded position and orientation 126. The conventional software can also implement a modified scanning process designed for multiple sweep acquisition, called “multi-sweep gated” mode. In this mode, recording starts when the probe has been held still for about a second and stops when the probe is held still again. When the probe is lifted up and moved over, then held still again, another sweep is created and recording resumes. This can be repeated for any number of sweeps to form a multi-sweep volume, thus avoiding having to manually specify the extents of the sweeps in the post-processing phase. Alternatively, the acquired image planes of each sweep can be corrected for position and angle and interpolated to form a regularized 3D image volume that consists of the equivalent of parallel image planes.

Carrying out ultrasound image 10 acquisitions from actual human subjects presents several challenges. These arise from the fact that it is not sufficient to simply translate, rotate and scale one image volume to make it align with an adjacent one (affine transformation) in order to accomplish 3-D image volume stitching 14. The primary source of difficulties is motion of the body and organs due to internal movements and external forces. Internal movements are related to motion within the body during scanning, such as that caused by breathing, heart motion and—in the case of obstetrics image volumes—fetal movements. This causes relative deformation between scans of the same area. As a consequence, during 3-D image volume stitching 14 such areas do not line up perfectly, even though they should, based on position and orientation 126. External forces include irregular ultrasound transducer 4 pressure. When probe pressure is varied during the sweep, for example when the transducer is moved over the body, internal organs are compressed to different degrees, especially near the skin surface. Scan sweeps in different directions may also push organs in slightly different ways, further altering the ultrasound images 10. Thus, distortion due to varying ultrasound transducer 4 pressure presents the same type of alignment challenges as do the distortion due to internal movements.

3-D image volume stitching 14 can be accomplished first based on position and orientation 126 alone. Within and across ultrasound images 10 plane, registration based on similarity measures can be used in the overlap areas to determine regions that have not been deformed due to either internal or external forces. A fine degree of affine transformation may be applied to such regions for an optimal alignment, and such regions can serve as “anchor regions.” For 4-D image volumes (including time 11), a sequence of moving images can be assembled where each image plane is a moving sequence of frames.

Most of the methods of registration use some form of a comparison-based approach. Similarity measures are typically statistical comparisons of two values, and a number of different similarity measures can be used for comparison of 2-D images and 3-D data volumes, each having their own merits and drawbacks. Examples of similarity measures are: (i) sum of absolute differences, (ii) sum-squared error, (iii) correlation ratio, (iv) mutual information, and (v) ratio image uniformity.

Regions adjacent to “anchor regions” need to be aligned through higher degrees of freedom alignment processes, which also permits deformation as part of the alignment process. There are several such methods, such as twelve-degree-of-freedom alignment. This involves aligning two images by translation, rotation, scaling and skewing. Following the affine alignment, a free-form deformation is performed to non-rigidly align the two images. For both of these alignments the sum of squared difference similarity measure may be used.

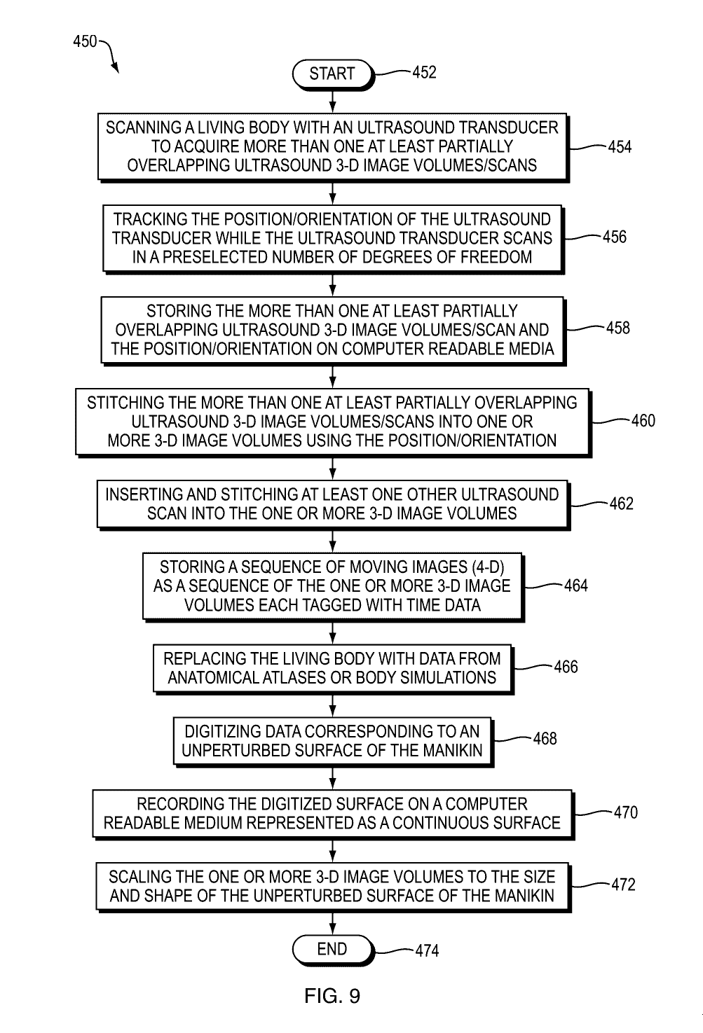

Whether dealing with a composite healthy image volume or a composite pathology or trauma image volume (FIG. 9, described further herein), the last processing step is an image volume scaling to make the acquired composite (stitched) image volume match in physical dimensions to the dimensions of the particular manikin in use. Using a numerical virtual model 17 and numerical modeling 13, image correction 15 scales and sizes the combined, stitched volume to match the dimensions of the manikin or the physical scan surface for virtual scanning. Image correction 15 may also correct inconsistencies in the ultrasound images 10 such as when the transducer 4 is applied with varying force, resulting in tissue compression of the living body 2.

Once the 3-D image volume stitching 14 and image correction 15 is complete, the training volume can be compressed and stored 16 in a central location. The composite, stitched 3-D volume can be broken into mosaics for shipping. Each mosaic tile can be a compressed image sequence representing a spatial 3-D volume. These mosaic tiles can then be uncompressed and repackaged locally after downloading to represent the local composite 3D volume.

Referring now to FIG. 2A, shown is a pictorial depicting one embodiment of the ultrasound training system. The system is designed to be an inexpensive, computer-based training system, in which the trainee/operator “scans” a manikin 20 using a mock transducer 22. The system is not limited to use with a lifelike manikin 20. In fact, “dummy phantoms” with varying attributes such as shape or size could be used. Because the 3-D image volumes 106 are stored electronically, they can be rescaled to fit manikins of any configuration. For instance, the manikin 20 may be hollow and/or collapsible to be more easily transported. A 2-D ultrasound image is shown on a display 114, generated as a “slice” of the stored 3-D image volume 106. 3D volume rendering, modified for faster rendering of voxel-based medical image volumes, is adjusted to display only a thin slice, giving the appearance of a 2-D image. Additionally, orthographic projection is used, instead of a perspective view, to avoid distortion and changes in size when the view of the image is changed. The “slicing” is determined by the mock transducer's 22 position and orientation in a preselected number of degrees of freedom relative to the manikin 20. The 3-D image volume 106 has been associated with the manikin 20 (described above) so that it corresponds in size and shape. As the mock transducer 22 traverses the manikin 20, the position and orientation permit “slicing” a 2-D image from the 3-D image volume 106 to imitate a real ultrasound transducer traversing a real living body.

Based on the selected 3-D image volume 106, the ultrasound image displayed may represent normal anatomy, or exhibit a specific trauma, pathology, or other physical condition. This permits the trainee/operator to practice on a wide range of ultrasound training volumes that have been generated for the system. Because the presented 2-D image will be derived from a pre-stored 3D image volume 106, no ultrasound scanner equipment is needed. The system can simulate a variety of ultrasound scanning equipment such as different transducers, although not limited thereto. Since an ultrasound scanner is not needed and since the patient is replaced by a relatively inexpensive manikin or manikin 20, the system is inexpensive enough to be purchased for training at clinics, hospitals, teaching centers, and even for home use.

The mock transducer 22 uses sensors to track its position in training scan pattern 30 while it “scans” the manikin 20. Commercially available magnetic sensor may be used that dynamically obtain the position and orientation information in 6 degrees of freedom (“DoF”). All of these tracking systems are based on the use of a transmitter as the external reference, which may be placed inside or adjacent to the surface of the manikin. Magnetic or optical 6 DoF tracking systems will subsequently be referred to as external tracking systems.

For a PC-based simulation system, the tracking system represents in the order of ⅔ of the total cost. In order to overcome the complexity and expense of external tracking systems, the mock transducer 22 may use optical and MEMS sensors to track its position and orientation in 5 DoF relative to a start position. The optical system tracks the mock transducer's 22 position on the manikin 20 surface in two orthogonal directions, while the MEMS sensor tracks the orientation of the mock transducer 22 along three orthogonal coordinates.

This tracking system does not need an external reference (transmitter) as a reference, but uses the start point and the start orientation as the reference. This type of system will be referred to as a self-contained tracking system. Nonetheless, registration of the position and orientation of the mock transducer 22 to the image volume and to the manikin 20 is necessary. Thus, the manikin 20 will need to have a reference point, to which the mock transducer 22 needs to be brought and held in a prescribed position before scanning can start. Due to drift, especially in the MEMS sensors, recalibration will need to be carried out with regular intervals, discussed further below. An alert may tell the training system operator when recalibration needs to be carried out.

As the training system operator “scans” the manikin 20 with the mock transducer 22, the position and orientation information is sent to the 3-D image slicing software 26 to “slice” a 2-D ultrasound image from the 3-D image volume 106. The 3-D image volume 106 is a virtual ultrasound representation of the manikin 20 and the position and orientation of the mock transducer 22 on the manikin 20 corresponds to a position and orientation on the 3-D image volume 106. The sliced 2-D ultrasound image shown on the display 114 simulates the image that a real transducer in that position and orientation would acquire if scanning a real living body. As the mock transducer 22 moves in relation to the manikin 20, the image slicing software 26 dynamically re-slices the 3-D image volume 106 into 2-D images according to the mock transducer's 22 position and orientation and shows them in real-time the display 114. This simulates the ultrasound scanning of a real ultrasound machine used on a living body.

Referring now to FIG. 2B, an embodiment of the present teachings is shown in which virtual torso 462 is displayed, for example, on the same display 114 as 2D ultrasound image 464 of torso subject 462.

Referring now to FIG. 2C, a 3D image data representing a specific anatomy or pathology is drawn from an image training library 106 and combined with unique virtual torso appearance. As the trainee scans virtual torso 462 with mock transducer 22 on scan pad 460, anatomical and pathology identification and scan path analysis systems 466 provide 2D ultrasound image 464 based on the particular pathology selected.

Referring now to FIG. 2D, details of scan pad 460, which is a specific embodiment of the physical scan surface, and mock transducer 22 are shown in which scan pad 460 includes built-in position sensing, and mock transducer 22 includes MEMS-based gyro, giving 3 DoF angle sensing capabilities. Connecting transducer 22 to a computing processor, for example, training system processor 101, is transducer cable 468 providing 3 DoF orientation information of the mock transducer. Likewise, connecting scan pad 460 to training system processor 101 is scan pad cable 470 providing position information of mock transducer 22 relative to scan pad 460 to training system processor 101.

Referring now to FIG. 2E, scan pad 472 without built-in position sensing is shown along with mock transducer 22 with optical position sensing and MEMS-based angle sensing capabilities. Mock transducer 22 can include a 3 DoF MEMS gyro for angle sensing and an optical tracking sensor for position sensing. The optical tracking sensor may be a single sensor or a dual sensor with dual optical tracking elements 474. Transducer cable 468 can provide position and orientation information of the mock transducer relative to the scan pad. The configuration shown in FIG. 2E also includes optical tracking using the Anoto dot pattern tracking previously disclosed.

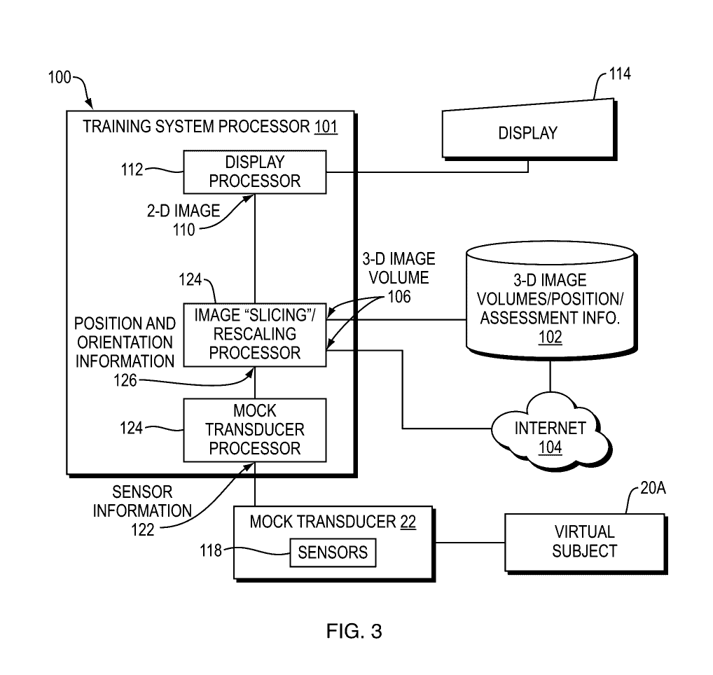

Referring now to FIG. 3, shown is a block diagram describing another embodiment of the ultrasound training system 100. 3-D image Volumes/Position/Assessment Information 102 containing trauma/pathology position and training exercises are stored on electronic media for use with the training system 100. 3-D image Volumes/Position/Assessment Information 102 may be provided over any network such as the Internet 104, by CD-ROM, or by any other adequate delivery method. A mock transducer 22 has sensors 118 capable of tracking the mock transducer's 22 position and orientation 126 in 6 or fewer DoF. The mock transducer's 22 sensor information 122 is transmitted to a mock transducer processor 124, which translates the sensor information 122 into mock position and orientation information. Sensors 118 can capture data using a compliant scan pad and a virtual torso 20A, the data resulting from either a scan pad, for example, a scan pad to capture the position data, and a MEMS gyro in the mock transducer to capture angular data, or from an optical tracker in the mock transducer to capture the position data, and MEMS gyro in the mock transducer to capture the angular data. As shown, this embodiment produces two images on display 114 (or on separate displays), the virtual torso with the virtual transducer (which moves in accordance with the movement of the mock transducer), and the ultrasound image corresponding to the virtual torso and the position of the virtual transducer.

The image slicing/rescaling processor 108 uses the mock position and orientation information to generate a 2-D ultrasound image 110 from a 3-D image volume 106. The slicing/rescaling processor 108 also scales and conforms the 2-D ultrasound image to the manikin 20. The 2-D image 110 is then transmitted to the display processor 112 which presents it on the display 114, giving the impression that the operator is performing a genuine ultrasound scan on a living body.

The position/angle sensing capability of the image acquisition system 1 (FIG. 1), or a scribing or laser scanning device or equivalent can be used to digitize the unperturbed manikin surface 21 (FIG. 2A). The manikin 20 can be scanned in a grid by making tight back-and-forth motions, spaced approximately 1 cm apart. A secondary, similar grid oriented perpendicular to the first one can provide additional detail. A surface generation script generates a 3-D surface mapping of the manikin 20, calculates an interpolated continuous surface representation, and stores it on a computer readable medium as a numerical virtual model 17 (shown on FIG. 1).

When a numerical virtual model 17 (shown on FIG. 1) has been generated, the 3D image volume 106 is scaled to completely fill the manikin 20. Calibration and sizing landmarks are established on both the living body 2 (FIG. 1) and the manikin 20 and a coordinate transformation maps the 3D image volume 106 to the manikin 20 coordinates using linear 3 axis anisotropic scaling. Only near the manikin surface 21 (FIG. 2A) will non-rigid deformation be needed.

For a mock transducer 22 having a self-contained tracking system with less than 6 DoF, the a priori information of the numerical virtual model 17 (shown on FIG. 1) of the manikin surface 21 (FIG. 2A) can be used to recreate the missing degrees of freedom. The manikin surface 21 (FIG. 2A) can be represented by a mathematical model as S(x,y,z). Polynomial fits or non-uniform rational B-splines can be used for the surface modeling, for example. Calibration references points are used on the manikin 20 which are known absolutely in the image volume coordinate system of the numerical virtual model 17 (shown on FIG. 1). The orientation of the image plane and position of the mock transducer 22 sensors 118 are known in the image coordinate system at a calibration point. The local coordinate system of the sensor, if optical, senses the traversed distance from an initial calibration point to a new position on the surface. This distance is sensed as two distances along the orthogonal axes of the sensor coordinates, u and v. These distances correspond to orthogonal arc lengths, lᵤ and lᵥ along the surface. Each arc length lᵤ can be expressed as:

$${𝓁}_{u} = {\int }_{a}^{x} \sqrt{[ 1 + {( \frac{\partial S}{\partial u} )}^{2} ]} d u$$

where S is the surface model, a is the x-coordinate of the calibration start point, and x is the x-coordinate of the new point, both in the image volume coordinate system. Because the arc length is measured, this equation can be solved iteratively for the x. Similarly, the arc length along the y axis lᵥ can be used to find y. The final coordinate of the new point, z, can be found by inserting x and y into the surface model S. The new known point replaces the calibration point and the process is repeated for the next position. The attitude of the mock transducer 22 in terms of the angles about the x, y, and z-axes can be determined from the divergence of S evaluated at (x,y,z), if the transducer is normal to the surface, or from angle sensors. The relationship among the coordinate systems is described further below.

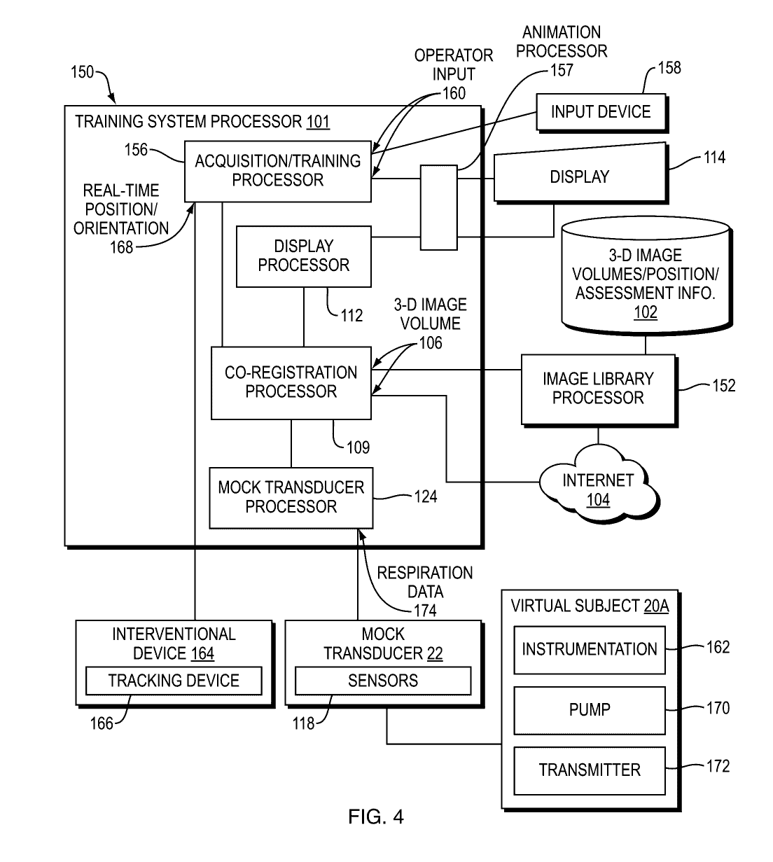

Referring now to FIG. 4, shown is a block diagram describing yet another embodiment of the ultrasound training system 150. FIG. 4 is substantially similar to FIG. 3 in that it uses a display 114 to show 2-D ultrasound images “sliced” from a 3-D image volume 106 using the mock transducer 22 position and orientation information. Also shown is an image library processor 152 which provides access to an indexed library of 3-D image volumes/Position/Assessment Information 102 for training purposes. A sub-library may be developed for any type of medical specialty that uses ultrasound imaging. In fact, the image volumes can be indexed by a variety of variables to create multiple libraries or sub-libraries based on, for example, although not limited thereto: the specific anatomy being scanned; whether this anatomy is normal or pathologic or has trauma; what transducer type was used; what transducer frequency was used, etc. Thus, as the size and diversity of the training system user group expands, there will be a need for many image volumes, and such an image library and sub-libraries will need to be built up over some time.

An important part of the training system is the ability to assess an operator's skills, discussed further below. Specifically, the training system can offer the following training and assessment capabilities: (i) it can identify whether the trainee operator has located a pertinent trauma, pathology, or particular anatomical landmarks (body of interest or position of interest) which has been a priori designated as such; (ii) it can track and analyze the operator's scan pattern 160 for efficiency of scanning by accessing optimal scan time 258; (iii) it allows an “image save” feature, which is a common element of ultrasound diagnostics; (iv) it measures the time from start of the scanning to the diagnostic decision (whether correct decision or not); (v) it can assess improvement in performance from the scanning of the first case to the scanning of the last case by accessing assessment questions 260; and (vi) it can compare current scans to benchmark scans performed by expert sonographers.

The 3-D image volumes/Position/Assessment Information 102 stored on electronic media has learning assessment information, for example, benchmark scan patterns and optimal times to identify bodies of interest, associated with the ultrasound information. The training system can determine the approximate skill level of the sonographer in scanning efficiency and diagnostic skills, and, after training, demonstrate the sonographer's improvement in his/her scanning ability in real-time, which will allow the system to be used for earning CME Credits. One indicator of skill level is the operator's ability to locate a predetermined trauma, pathology, or abnormality (collectively referred to as “bodies of interest” or “position of interest”). Any given image volume for training may well contain several bodies of interest. Other training exercises are possible, such as where the sonographer is presented with several image volumes, say ten image volumes, representing 10 different individual patients, and is asked to identify which of these ten patients have a given type of trauma such as abdominal bleeding, or a given type of pathology such as gallstones.

A co-registration processor 109 co-registers the 3-D image volume 106 with the surface of the manikin 20 in a predetermined number of degrees of freedom by placing the mock transducer 22 at a calibration point or placing a transmitter 172 inside said manikin 20. A training processor 156 can then compare the operator's training scan, determined by sensors 118, against, for example, a benchmark ultrasound scan. The training processor 156 could compare the operator's scan with a benchmark scan pattern and overlap them on the display 114, or compare the time it takes for the operator to locate a body of interest with the optimum time. The operator's scan path can be shown on a display 114 with a representation of the numerical virtual model 17 (FIG. 1) of the manikin 20. If instrumentation 162 or a pump 170 is used with the manikin 20 in order to produce artificial physiological life signs data 174 such as respiration, discussed further below, an animation processor 157 may provide animation to the display 114. The pump 170 may be used with an inflatable phantom to enhance the realism of respiration with a rescaling processor dynamically rescaling the 3-D ultrasound image volume to the size and shape of the manikin as it is inflated and deflated.

An interventional device 164, such as a mock IV needle, can be fitted with a 6 DoF tracking device 166 and send real-time position/orientation 168 to the acquisition/training processor 156. This permits the trainee operator to practice other ultrasound techniques such as finding a vein to inject medication. Using the position/orientation 168, the animation processor 157 can show the simulation of the needle injection position on the display 114.

If a touch screen display is used, the trainee can indicate the location of a body of interest by circling it with a finger or by touching its center, although not limited thereto. If a regular display 114 is used, then another input device 158 such as a mouse or joystick may be used. The training processor 156 can also determine whether a given pathology, trauma, or anatomy has been correctly identified. For example, it can provide a training goal and then determine whether the user has accomplished the goal, such as correctly locating kidney stones; liver lesions, free abdominal fluid, etc. The operator may also be asked to determine certain distances, such as the biparietal diameter of a fetal head. Inferences necessary for diagnosis such as the recognition of a pattern and anomaly or a motion can also be evaluated.

The scan path, that is, the movement of the mock transducer 22 on the surface of the manikin 20, can be recorded in order to assess scanning efficiency over time. The effectiveness of the scanning will be very dependent on each diagnostic objective. For example, expert scanning for the presence of gallstone will have a scan pattern that is very different from the expert scanning to carry out a FAST (Focused Abdominal Sonography for Trauma) exam to locate abdominal free fluid. The training system can analyze the change in time to reach a correct diagnostic decision over several training sessions (image volumes and learning assessment information 154), and similarly the development of an effective scan pattern. Scan paths may also be shown on the digitized surface of the manikin 20 rendered on the display 114.

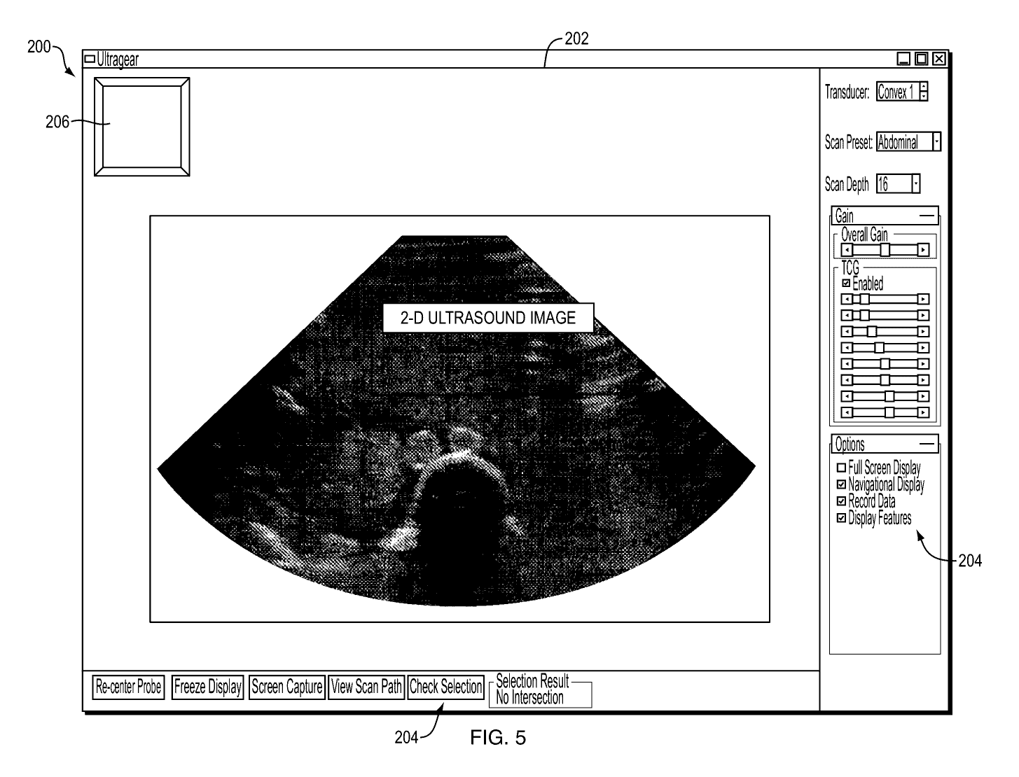

Referring now to FIG. 5, shown is pictorial depicting one embodiment of the graphical user interface (“GUI”) imaging system control panel 200 for the display of the ultrasound training system. The GUI tries to make the training session as realistic as possible by showing a 2-D ultrasound image 202 in the main window and associated ultrasound controls 204 on the periphery. As discussed above, the 2-D ultrasound image 202 shown in the GUI is updated dynamically based on the position and orientation of the mock transducer scanning the manikin. A navigational display 206 can be observed in the upper left hand corner, which shows the operator the location of the current 2-D ultrasound image 202 relative to the overall 3-D image volume.

Miscellaneous ultrasound controls 204 add to the degree of realism on an image, such as focal point, image appearance based on probe geometry, scan depth, transmit focal length, dynamic shadowing, TGC and overall gain. All involve modification of the 2-D ultrasound image 202. In addition, the user can choose between different transducer options and between different image preset options. For example, the GUI may have “Probe Re-center” and “freeze display” and record options. The emulation of overall gain and time gain control (TGC) allow the user to control the overall image brightness and the image brightness as a function of range. For TGC, the scan depth is divided into a number of zones, typically eight, the brightness of which is individually controllable; linear interpolation is performed between the eight adjustment points to create a smooth gradation. The overall gain control is implemented by applying a semi-opaque mask to the image being displayed. This also means that the source image material needs to be acquired with as good a quality as possible; for example, multi-transmit splicing is employed whenever possible to maximize resolution.

Focal point implementation means that image presentation outside the selected transmit focal region is slightly degraded with an appropriate, spatially varying slight smoothing function. Image appearance based on probe geometry involves making modifications near the skin surface so that for a convex transducer the image has a radial appearance, for a linear array transducer it has a linear appearance, and for a phased array it has a pie-slice-shaped appearance. By applying a mask to the image being viewed, it can be altered to take on the appearance of the image geometry of the specific transducer. This allows users to experience scanning with different probe shapes and extends the usefulness of this training system. This masking can be accomplished using a “Stencil Buffer.” A black and white mask is defined which specifies the regions to be drawn or to be blocked. A comparison function is used to determine which pixels to draw and which to ignore. By appropriately drawing and applying the stencil, the envelope of the display can be made to take on any shape. Different stencils are generated based on the selected probe geometry, to accurately portray the viewing area of the selected probe.

Simulation of Time Gain Compensation (TGC) and absorption with depth provide user interaction with these controls. User control settings can be recorded and compared to preferred settings for training purposes. Dynamic shadowing involves introducing shadowing effect “behind” attenuating structures where “behind” is determined by the scan line characteristics of the particular transducer geometry that is being emulated.

By using a finger or stylus on a touch screen or a mouse, trackball, or joystick on a regular screen, the operator can locate on the displayed image specific bodies of interest that may represent a specified trauma, pathology or abnormality training purposes. The training system can verify whether the body of interest was correctly identified, and permits image capture so that the operator has the opportunity to view and play back the entire scan path.

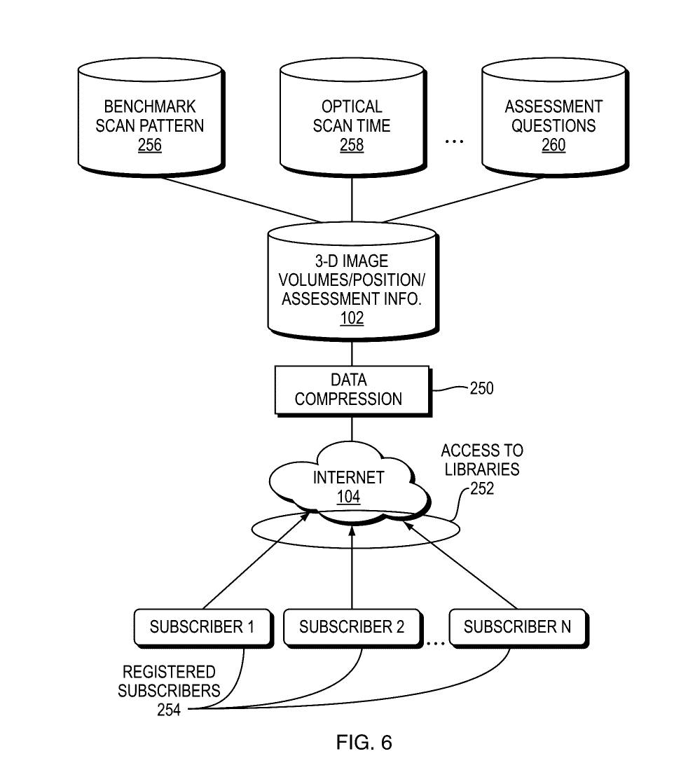

Referring now to FIG. 6, shown is a block diagram describing one embodiment of the method of distributing ultrasound training material. The 3-D ultrasound image volumes and training assessment information 102 may be distributed over a network such as the Internet 104. A central storage location allows a comprehensive image volume library to be built, which may have general training information for novices, or can be as specialized as necessary for advanced users. Registered subscribers 254 may locate pertinent image volumes by accessing libraries 252 where image volumes are indexed into sub-libraries by medical specialty, pathology, trauma, etc.

In order for an image library to be effective, it must be possible to quickly download the image volumes to the training computer over a network such as the Internet 104. To do so may require compression 250 which reduces the size of the downloadable files but retains adequate image quality. One promising codec for this is MPEG-4, part 10, also known as H.264. Use of H.264 has demonstrated that a compression ratio of 50:1 is realistic without discernable loss of image details. This means in practice that a composite image volume can be compressed to a file of maybe 5-10 MBs in size. With a cable modem connection, such a file can be downloaded in 5 to 10 seconds. The download and un-compression can be conveniently carried out using a decoding algorithm such as Apple's QuickTime.

A frame server can produce individual image frames for H.264 encoding. The resulting encoded bit stream will then either be stored to disk or transmitted over TCP/IP protocol to the training computer. A container format stores metadata for the bit stream, as well as the bit stream itself. The metadata may include information such as the orientation of each scan plane in 3-D space, the number of scan planes, the physical size of an image pixel, etc. An XML formatted file header for metadata storage may be used, followed by the binary bit stream.

For 4-D (3-D plus time) and/or Doppler image simulation having larger data sets, two methods can be used. 3D image volumes tagged with relative time of acquisition and are accessed using the same methods previously described for still imaging except that different memory locations are accessed in sequence and repeated according to increasing time tags. In a second method, the previous still methods are employed for stitching and the creation of a 3-D image volume of the first frame. These settings are then used to access a full 4-D data set that is derived from compressed image files (including time) at each spatial image plane location. Frames are cycled through the same set of display operations for a 2D image plane selected for visualization and display.

With such libraries available the sonographer can stay maintain his/her ability to locate and diagnose pathologies and/or trauma. Even if the image volumes are stored on CD or even DVD, image compression permits far more data storage. When a trainee/operator receives the image volumes from the centrally stored library, he or she would need to decompress the image volume cases and placing them in memory of a computer for use with the training system. The training information downloaded would include not only the ultrasound data, but the training lessons, and simulated generic or specific diagnostic ultrasound system display configurations including image display and simulated control panels.

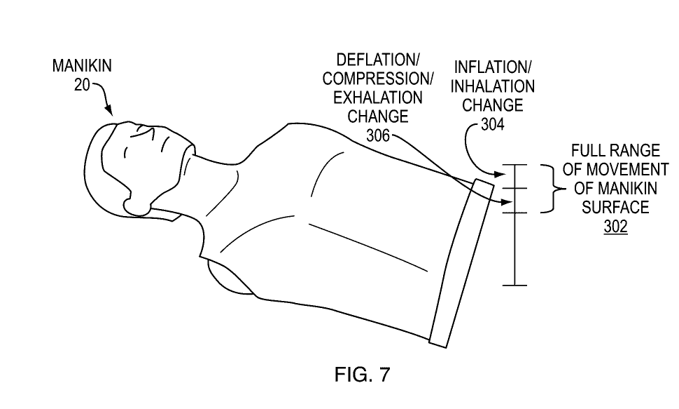

Referring now to FIG. 7, shown is a pictorial depicting one embodiment of the manikin or manikin 20 used with the ultrasound training system. To improve the degree of realism, the ultrasound training system may have as options the ability to simulate respirations or to account for compression of the phantom surface by the mock transducer. Simulated respiration or transducer compression will affect the manikin 20 surface and create a full range of movement 302. For instance, if the manikin 20 “exhales” by pumping air out and reducing the internal volume of air, the surface will experience a deflationary change 306. Similarly, if it “inhales” by pumping air in and increasing the internal air volume, the surface will experience an inflationary change 304. To increase the realism of the training system, any change of the manikin 20 surface should affect the ultrasound image being displayed since the mock transducer will move with the full range of movement 302 of the surface.

In order to add the realism of breathing, one of two methods can be employed. For the first method, the displacement of the skin surface at one of more points will need to be tracked, and if an external tracking system is used, this is easily done by mounting one or more sensors under the skin surface to measure the displacement. This information will then be used to dynamically rescale the image volume (from which the 2-D ultrasound image is “sliced”) so that so that it matches the shape and size of the manikin 20 at any point in time during the respiratory cycle. The image volume may be a 3-D ultrasound image volume, a 4-D image volume or a 3-D anatomical atlas.

A second method may be employed if an external tracking system is not used (the self-contained tracking system is used instead). This involves the acquisition of a 4-D image volume (e.g., several image volumes, each taken at intervals within a respiratory cycle). In this case, an appropriately sized and shaped 3-D image volume, according to the time during the respiratory cycle, is used for “slicing” a 2-D ultrasound image for display. The movement of the phantom surface for each point in time of the respiratory cycle must be determined a priori. The 3-D image volume can then be dynamically rescaled based on the time of the respiratory cycle, according to the known size and shape of the phantom at that point in the respiratory cycle.

Respiration can be emulated by the inclusion of a pump 170 (FIG. 4). A pumping system should be able to regulate the tidal volume and breathing rate. The ability to set a specific breathing pattern with corresponding dynamic image scaling will add a high degree of realism to the ultrasound training system. Controls for respiration may be included in the GUI or placed at a separate location on the training system.

During actual ultrasound scanning, the surface of the living body's skin can be compressed by pressing the transducer into the skin. This can also happen in training if a compressible phantom is being used. This type of image compression can be emulated with the ultrasound training system. If an external tracking system with 6 degrees of freedom is used, the degree of local compression is readily determined from the amount of displacement determined from a comparison of the mock transducer position/attitude to the digitized unperturbed surface of the manikin as stored in the numerical modeling. A rescaling processor may dynamically rescale the 2-D ultrasound image to the size and shape of the manikin as it is compressed by the mock transducer. A local deformation model can be developed to simulate the appropriate degree of local (near surface) image compression based on both numerically-calculated compression as well as shear stress distribution in the scan plane, based on approximate shear modulus values for biological soft tissue.

For tracking systems with 5 DoF (missing the vertical direction normal to the skin surface), the compression displacement cannot be measured directly. However, the force that the mock transducer applies to the phantom surface can be determined through the use of force sensors integrated into the mock transducer (placed inside the surface that makes contact with the phantom). The compliance of the phantom at each point on its surface can be mapped a priori. By combining the known location of the mock transducer on the surface of the phantom, the known compliance of the phantom at that point, and the applied force measured by pressure sensors, actual local compression can be calculated. The image deformation can then be made by appropriately sizing and shaping the image volume as discussed above.

An additional degree of realism can optionally be emulated by detecting whether an adequate amount of acoustic gel has been applied. This can most readily be done with electrical conductivity measurements. Specifically, the part of the mock transducer in contact with the “skin” of the manikin will contain a small number of electrodes (say three or four) equally spaced over the long axis of the transducer. In order for the ultrasound image to appear, the electrical conductivity between anyone pair of electrodes needs to be below a given set value determined by the particular gel in use.

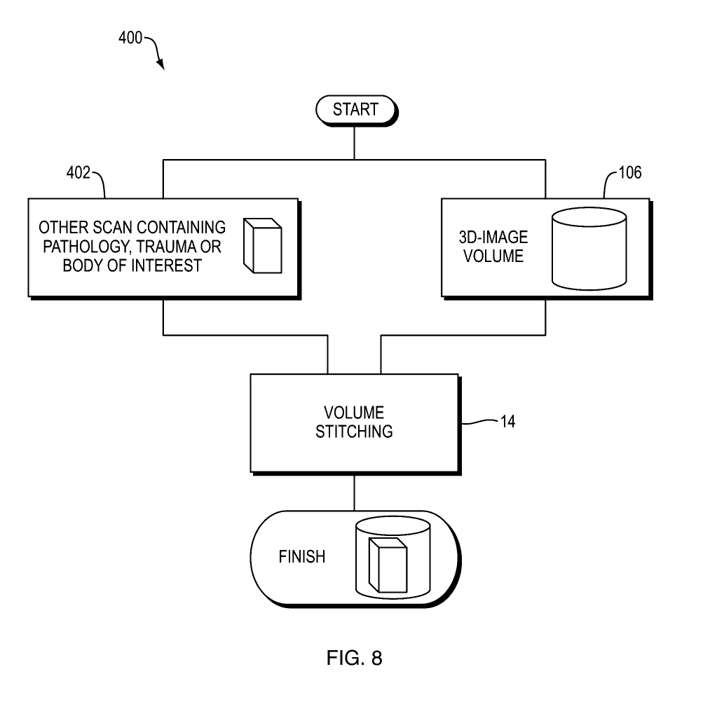

In one embodiment of a recalibration system used to recalibrate the mock transducer, a transducer and 6 DoF sensor can be held in a clamp as shown exemplarily by P-W Hsu, et al. in Freehand 3D Ultrasound Calibration: A Review, December 2007, FIG. 8(b) on page 9. The materials for the recalibration system can be selected to minimize interference with magnetic tracking systems using, for example, nonmagnetic materials. If the anatomical data of the phantom has been collected, it can be shown on the display.

A 6 DoF transformation matrix relates the displayed scan plane to the image volume. This matrix is the product of matrix 1 and matrix 2, yielding matrix 3. Here, matrix 1 is a transformation between the reconstruction volume and the location of the tracking transmitter and is used to remove any offset between the captured image volume and the tracking transmitter, and matrix 2 is the transformation between the tracking transmitter and tracking receiver, which is what is determined by the tracking system. Matrix 3 is the transformation between the receiver position and the scan image. This last matrix is obtained after physically measuring the location of the imaging plane to movements along DoFs in a mechanical fixture.

Referring to FIG. 8, shown is a block diagram describing one embodiment of volume stitching system 400 for stitching ultrasound scans (also shown in FIG. 1). A particular challenge is the stitching of a 3-D image volume image from a patient with a given trauma or pathology (body of interest), into a 3-D image volume from a healthy volunteer. In this case, the first step will be to outline the tissue/organ boundaries inside the healthy image volume which correspond to the tissue/organ boundaries of the trauma or pathology image volume. This step may be done manually. Note that the two volumes probably will not be of the same size and shape. Next, the healthy tissue volume lying inside the identified boundaries will be removed and substituted with the trauma or pathology volume 402. Again, there may be unfilled gaps as well as overlapping regions after this substitution has been completed. Finally, a type of freeform deformation along with scaling, translation and rotation, will be applied to produce a realistic and continuous image volume. This allows pathology or trauma scans to be reused without fear of abusing ill patients by repeatedly scanning them or having to conduct a complete body scan.

Referring now to FIG. 9, shown is a block diagram describing one embodiment of the method of generating ultrasound training image material. The following steps take place: Scanning a living body with an ultrasound transducer to acquire more than one at least partially overlapping ultrasound 3-D image volumes/scans 454; Tracking the position/orientation of the ultrasound transducer while the ultrasound transducer scans in a preselected number of degrees of freedom 456; Storing the more than one at least partially overlapping ultrasound 3-D image volumes/scan and the position/orientation on computer readable media 458; Stitching the more than one at least partially overlapping ultrasound 3-D image volumes/scans into one or more 3-D image volumes using the position/orientation 460; Inserting and stitching at least one other ultrasound scan into the one or more 3-D image volumes 462; Storing a sequence of moving images (4-D) as a sequence of the one or more 3-D image volumes each tagged with time data 464; Replacing the living body with data from anatomical atlases or body simulations 466; Digitizing data corresponding to an unperturbed surface of the manikin 468; Recording the digitized surface on a computer readable medium represented as a continuous surface 470; and Scaling the one or more 3-D image volumes to the size and shape of the unperturbed surface of the manikin 472.

Referring now to FIG. 10, shown is a block diagram describing one embodiment of the mock transducer pressure sensor system. Sensor information 122 provided by sensors 118 in the mock transducer 22 (FIG. 3) is first relayed to the pressure processor 500, which, in one embodiment, receives information from a transmitter that is internal to manikin 20. The pressure processor 500 can translate the pressure sensor information and, together with data from the positional/orientation sensor, can determine the degree of deformation of the manikin's surface, based on a pre-determined compliance map of the manikin or of the physical scan surface. The deformation of the manikin's surface, thus indirectly measured, can be used to generate the appropriate image deformation in the image region near the mock transducer.

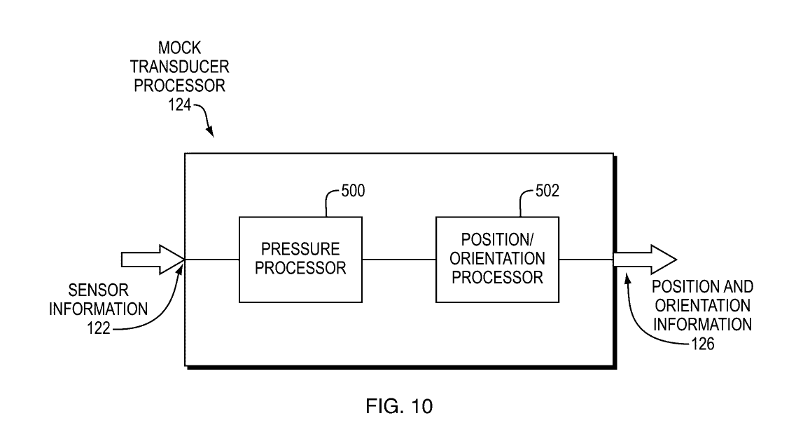

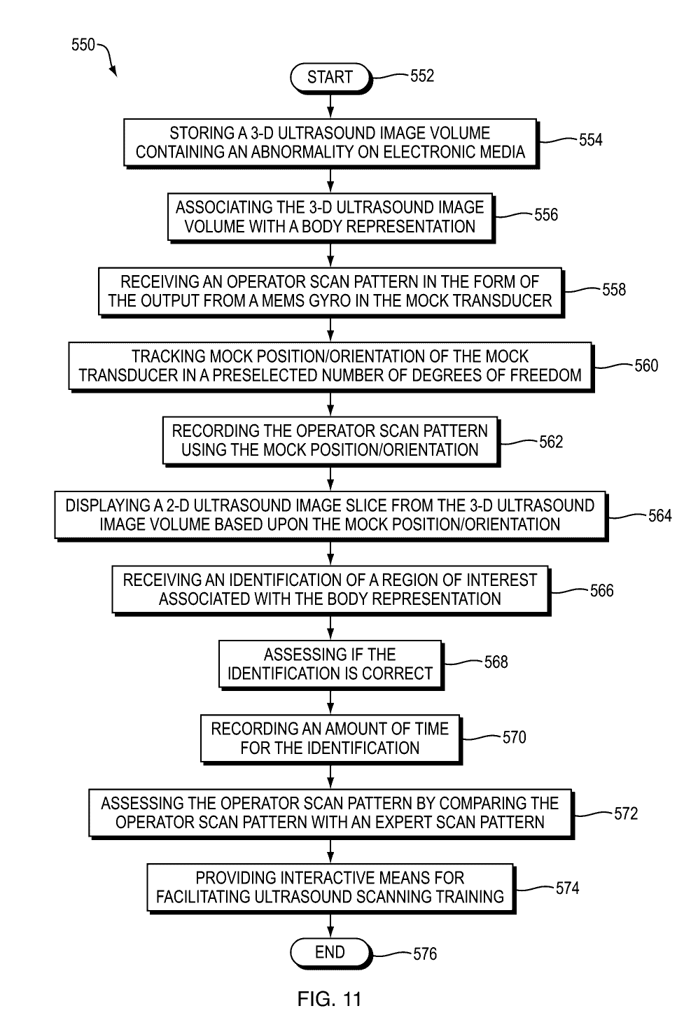

Referring now to FIG. 11, shown is a block diagram describing one embodiment of the method of evaluating an ultrasound operator. Throughout this specification, the term “body representation” refers to embodiments such as, but not limited to the physical manikin and the combination of scan surface and virtual subject. The method can include, but is not limited to including, the steps of storing 554 a 3-D ultrasound image volume containing an abnormality on electronic media, associating 556 the 3-D ultrasound image volume with a body representation, receiving 558 an operator scan pattern in the form of the output from the MEMS gyro in the mock transducer and the output from scan surface or optical tracking, tracking 560 mock position/orientation of the mock transducer (22) in a preselected number of degrees of freedom, recording 562 the operator scan pattern using the position/orientation, displaying 564 a 2-D ultrasound image slice from the 3-D ultrasound image volume based upon the position/orientation, receiving 566 an identification of a region of interest associated with the body representation; assessing 568 if the identification is correct, recording 570 an amount of time for the identification, assessing 572 the operator scan pattern by comparing the operator scan pattern with an expert scan pattern, and providing 574 interactive means for facilitating ultrasound scanning training.

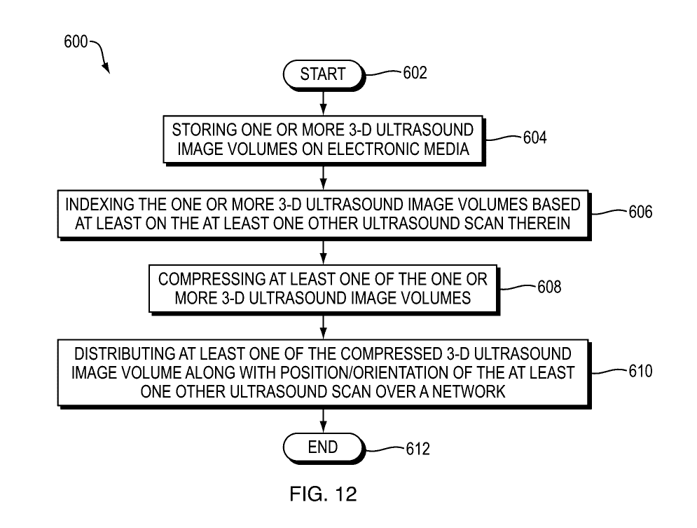

Referring now to FIG. 12, shown is a block diagram describing one embodiment of the method of distributing ultrasound training material. The method can include, but is not limited to including, the steps of storing 604 one or more 3-D ultrasound image volumes on electronic media, indexing 606 the one or more 3-D ultrasound image volumes based at least on the at least one other ultrasound scan therein, compressing 608 at least one of the one or more 3D ultrasound image volumes, and distributing 610 at least one of the compressed 3-D ultrasound image volume along with position/orientation of the at least one other ultrasound scan over a network.

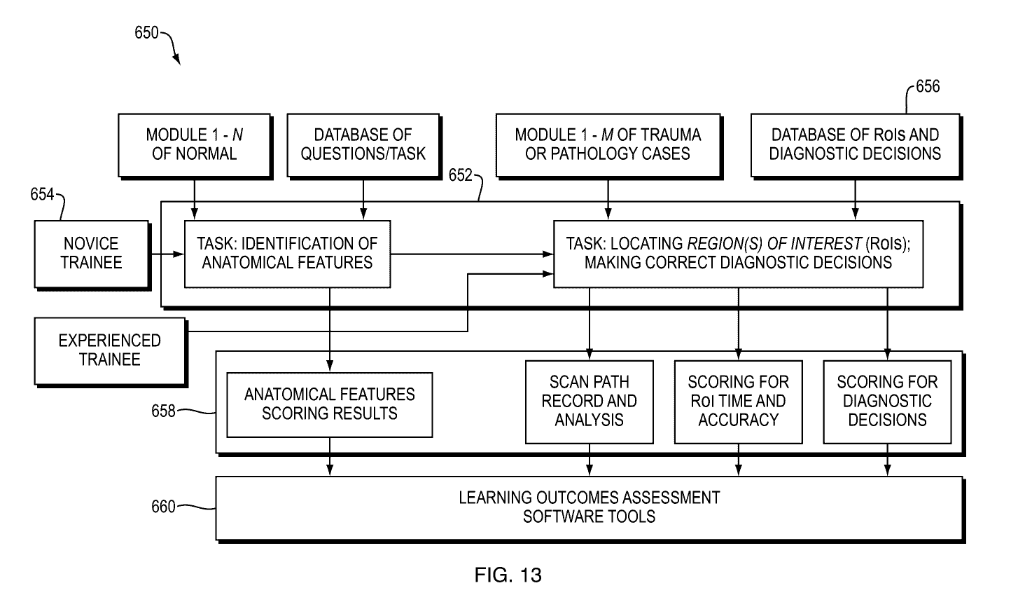

Referring now to FIG. 13, shown is a block diagram of another embodiment of the ultrasound training system. The instructional software and the outcomes assessment software tool have several components. Two task categories 652 are shown. One task category deals with the identification of anatomical features, and this category is intended only for the novice trainee, indicated by a trainee block 654. This task operates on a set of training modules of normal cases, numbered 1 to N, and a set of questions is associated with each module. The trainee will indicate the image location of the anatomical features and organs associated with the questions by circling the particular anatomy with a finger or mouse.

The other task category operates on a set of training modules of trauma or pathology cases, numbered 1 to M, and this category deals with a database 656 of the localization of a given Region of Interest (“RoI”, also referred to as “body of interest”). The trainee operator performs the correct localization of the RoI based on a set of clinical observations and/or symptoms described by the patient, made available at the onset of the scanning, along with the actual image appearance. In addition to finding the RoI, a correct diagnostic decision must also be given by the trainee. This task category is intended for the more experienced trainee, indicated with a trainee block. The source material for these two task categories 652 is given in the row of blocks at the top of FIG. 13. The scoring outcomes 658 of the tasks are recorded in various formats. The scoring outcomes 658 feed the scoring results into the learning outcomes assessment tools 660, which intend to track improvement in scanning performance, along different parameters.

A training module may contain a normal case or a trauma or pathology case, where a given module consists of a stitched-together set of image volumes, as described earlier. Each module has an associated set of questions or tasks. If a task involves locating a given Region of Interest (RoI), then that RoI is a predefined (small) subset of the overall volume; one may think of a RoI as a spherical or ellipsoidal image region that encloses the particular anatomy or pathology in question. The predefined 3-D volume will be defined by a specialist in emergency ultrasound, as part of the preparation of the training module.

The instructional software is likely to contain several separate components such as the development of an actual trauma or performing an exam effectively and accurately. The initial lessons may contain a theory part, which could be based on an actual published text, such as Emergency Ultrasound Made Easy, by J. Bowra and R. E. McLaughlin.

Four individual scoring outcomes 658 are identified in FIG. 13. One scoring system tracks the correct localization of anatomical features, possibly including the time to locate them. Another scoring system records the scan path and generates a scan effectiveness score by comparing the trainee's scan path to the scan path of an expert sonographer for the given training module. Another scoring system scores for diagnostic decision-making, which is similar to the scoring system for the identification of anatomical features.

Scoring for correct identification of the RoI, along with recoding of the elapsed time, is a critical component of trainee assessment. Verification that the RoI has been correctly identified is done by comparing the coordinates of the RoI with the coordinates of the region of the ultrasound image, circled by trainee on the touch screen. The detection system will be based on the Method of Collision Detecting of moving objects, common in computer graphics. Collision detection is applied in this case by testing whether the selection collides with or is inside the bounding spheres or ellipsoids. When the trainee has located the correct region of interest in an ultrasound image, the time and accuracy of the event is recorded and optionally given as feedback to the trainee. The scoring results over several sessions will be given as an input to the learning outcomes assessment software.

3D anatomical atlases can be incorporated into the training material and will be processed the same way as the composite 3D image volumes. This will allow an inexperienced clinical person first to scan a 3D anatomical atlas, and here we can consider a 3D rendering with the 2D slice based on the transducer position highlighted.

Because of the technique that scales the image volume to the manikin surface, it can also be applied to retrofit the composite 3D image volume to an already instrumented manikin. An instrumented manikin has artificial life signs such as a pulse, EKG, and respiratory signals and movements available. Advanced versions also are used for interventional training to simulate an injury or trauma for emergency medicine training and life-saving intervention. The addition of ultrasound imaging provides a higher degree of realism. In this application, the ultrasound image volume(s) are selected to synchronize with the vital signs (or vice versa) and to aid in the diagnosis of injury as well as to depict the results of subsequent interventions.

According to exemplary embodiments, provided herein is an affordable, compact, laptop-based obstetric ultrasound training simulator. The ultrasound simulator described in detail herein provides a realistic scanning experience, task-based training and performance assessment. In exemplary embodiments, the position and orientation of the mock transducer are tracked with 5 degrees of freedom on an abdomen-sized scan surface, referred to as the physical scan surface, with the shape of a cylindrical segment. A virtual torso can be rendered on the simulator user interface. The body surface of the virtual torso models the abdomen of the pregnant scan subject. A virtual transducer scans the virtual torso by following the mock transducer movements on the scan surface. A given 3D training image volume is generated by combining several overlapping 3D ultrasound sweeps acquired from the pregnant scan subject using a Markov random field-based approach. Obstetric ultrasound training is completed through a series of tasks, guided by the simulator and focused on three aspects: basic medical ultrasound, orientation to obstetric space, and fetal biometry. The scanning performance is automatically evaluated by comparing user-identified anatomical landmarks with reference landmarks pre-inserted by sonographers. The simulator renders 2D ultrasound images in real-time with 30 frames per second (fps) or higher with good image quality; the training procedure follows standard obstetric ultrasound protocol. Thus, for learners without access to formal sonography programs, the simulator provides structured training in basic obstetrics ultrasound.

According to the exemplary embodiments described in detail herein, an affordable and compact simulation-based ultrasound training system, which emulates the actual scanning experience in obstetric ultrasound, is provided. This is achieved by an implementation using a combination of readily available and affordable computer, e.g., laptop, equipment and low-cost scanning simulation hardware, and by using mosaicked image volumes that include the fetus, amniotic fluid, the placenta and the uterus. This configuration allows the cost to be lowered to the point of making personal ownership of the simulator feasible. A major component of the simulator system is the task-based training curriculum, organized into three modules, where trainees can complete basic obstetric ultrasound training guided by the simulator. Furthermore, the simulator can automatically evaluate trainees' scanning performance in specified training tasks.

According to the exemplary embodiments described in detail herein, the ultrasound simulator is a compact, adaptable and inexpensive training tool that provides a realistic scanning experience. Physical components are used to realize the psycho-motor aspects of diagnostic ultrasound training, for example, manipulation of a physical mock transducer on a body-like surface while making diagnostic decisions or biometric measurements on the observed ultrasound image. For learners without easy access to formal sonography programs, the ultrasound training simulator can provide structured, competence-based training in basic obstetric ultrasound by means of asynchronous, simulator-guided individual learning and instructor-guided, synchronous group learning.

Diagnostic ultrasound plays a dominant role in medical imaging and accounted in 2010 for 43% of all medical imaging exams. Growth has mainly been driven by the proliferation of compact ultrasound systems, in particular point of care (POC) systems, creating a need for ready access to competency-based training for new users. POC ultrasound exams are typically performed to determine the presence of a specific condition rather than a complete examination.

Competent ultrasound imaging requires both clinical knowledge and scanning (or psycho-motor) skills. The former can be delivered in cost-effective and flexible formats (traditional classroom, online courses or self-study), while the latter are best acquired through apprenticeship model training, in which the learner performs hands-on imaging of patients under the guidance of an experienced sonographer. For medical students, practicing MDs, and nurses, midwives and doctors in developing countries, such one-on-one training formats are often ill-suited or unavailable due to their cost, limited accessibility and/or inflexible training times.

The choice of ultrasound image generation technique is important, and computer-based ultrasound simulators use one of four approaches for image-generation. CT or MRI images volumes can be “ultrasonified” by adding texture and speckle, but such image material typically exhibits too well-defined boundaries and lacks shadowing artifacts. An alternative is a deformable mesh model based approach that synthesizes ultrasound images by simulating ultrasound wave transmission in target organs. This approach is promising, retains diffraction and shadowing effects, but is currently too computationally demanding except for simple tissue structures. The mathematical model based method is usually applied to the non-stationary organs like the heart and blood vessels. This approach is less accurate compared to other three approaches and needs further verification. The last of the four approaches is the interpolation-based method, which uses actual ultrasound image volumes that are commonly created from one or more sequences of 2D images from human subjects; thus, this method normally offers a higher level of realism in real time with acceptable computational requirements. The displayed 2D image is obtained by reslicing the digitalized 3D ultrasound image volume, based on the position and orientation of the mock transducer. The interpolation-based approach is used in the exemplary embodiments of the obstetrics ultrasound simulator described in detail herein.

The simulator of the exemplary embodiments permits scanning over the body surface area associated with a given ultrasound scanning protocol, such as the obstetrics examination. This necessitates a physical scan surface, mapped to cover that particular body surface area, as well as a set of ultrasound image volumes, which for obstetrics ultrasound contains the fetus as well as the maternal anatomical structures, such as uterus, placenta and amniotic fluid. Such large ultrasound image volumes are produced by stitching together several overlapping 3D images while overcoming misalignment artifacts when acquiring fetal images. This mosaicking process is described in detail herein.

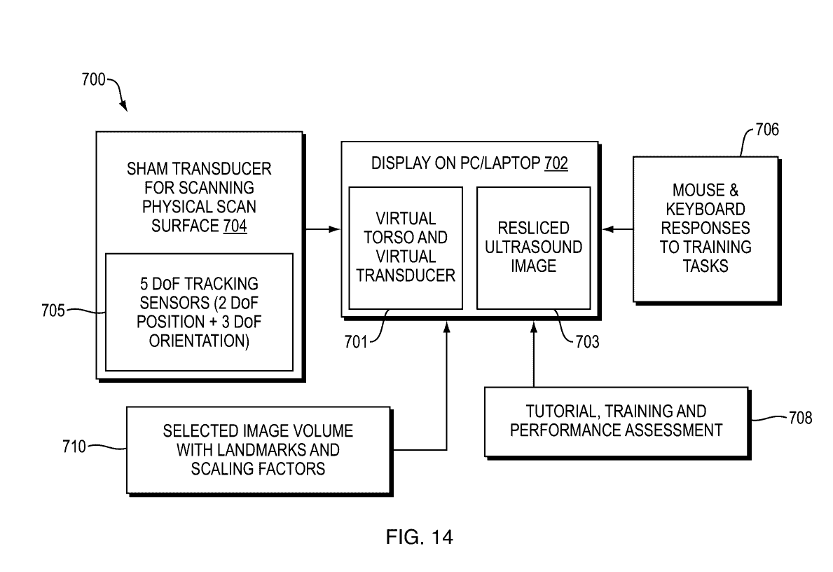

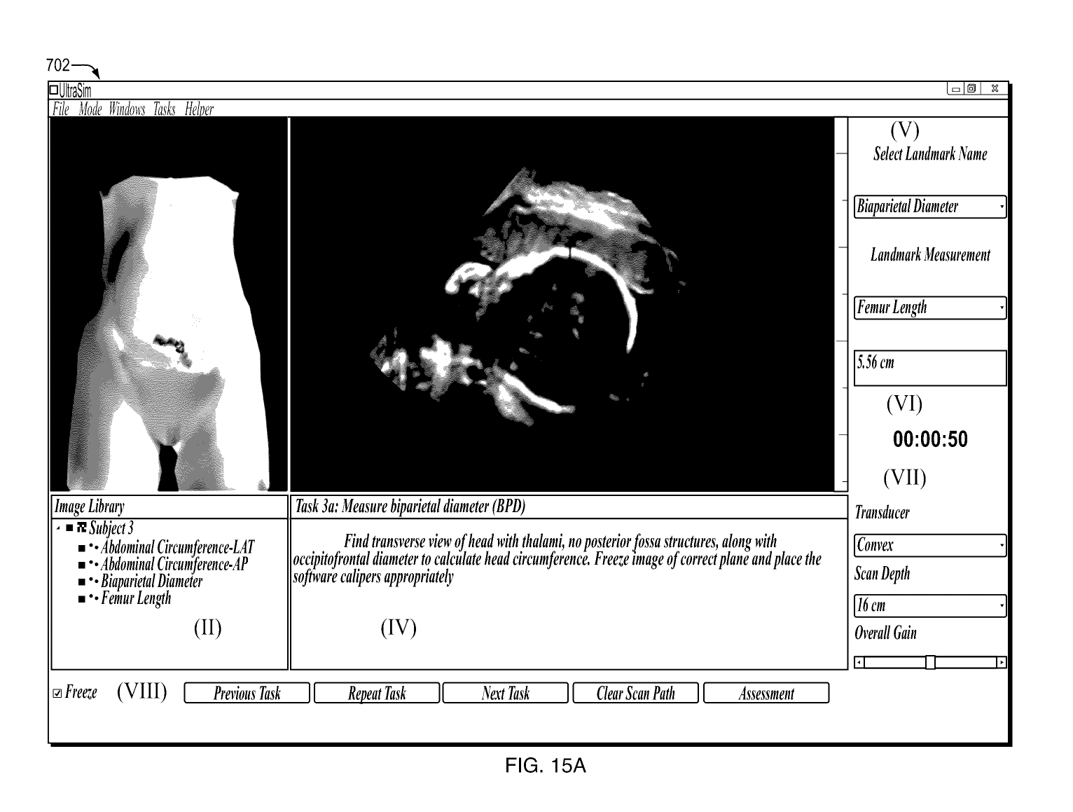

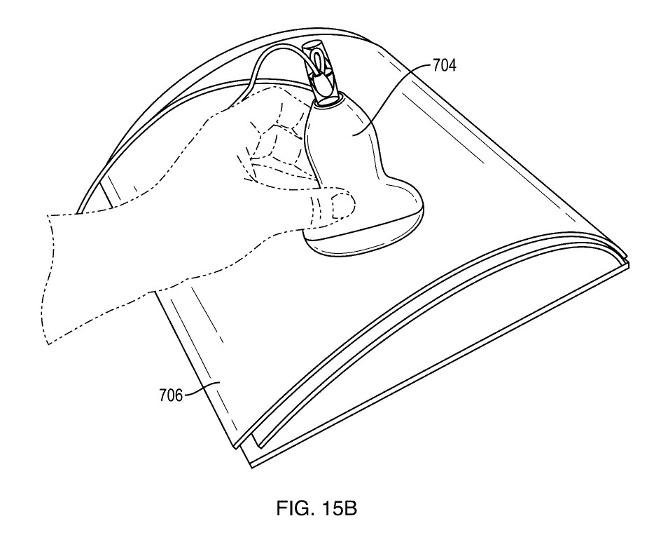

FIG. 14 is a schematic block diagram of an embodiment of an ultrasound simulation system 700, according to exemplary embodiments. FIGS. 15A and 15B are pictorials of an exemplary display on the graphical user interface (GUI) 702 of the system 700 and an exemplary physical scan surface 704 and mock transducer 706, respectively. As shown in FIGS. 14, 15A and 15B, the physical components of system 700 include physical scan surface 704 emulating a specific part of the human anatomy, and the mock transducer 704 with integrated position and orientation tracking sensors 705 providing 5 degrees of freedom (DoF). To minimize cost and space, in some exemplary embodiments, these tracking sensors are selected so that an external physical reference is not required. The physical scan surface 706 is implemented in some embodiments as a cylindrical segment, with a footprint corresponding to the scanning area of a typical adult abdomen, appropriate for obstetrics ultrasound. Referring to FIGS. 15A and 15B, when not connected to a network of other simulators, the obstetric ultrasound simulator is a stand-alone simulator, including three parts: (i) the scanning tracking hardware, comprised of the physical scan surface (PSS) 706, the mock transducer 704 with tracking components and a computer, such as a laptop computer, (ii) the simulator software, which provides a user interface for training purposes and generates simulated 2-D ultrasound image, based on the mock transducer's 2-D position and 3-D orientation on the PSS 706, and (iii) 3-D training image volumes, which are stored in the computer running the simulator software.

The user interface 702 of the system can include several windows, as illustrated in FIG. 15A. In the illustrated embodiment, one window shows a rendering of the body surface (the virtual torso) and a rendering of a transducer that follows the movements of the mock transducer 704 (the virtual transducer). The part of the body surface that can be scanned is unique to the selected 3D image volume. Another window contains the B-mode image, which is a slice through the selected 3D image volume and is determined by the position and orientation of the mock transducer 704 using selected image volume with landmarks and scaling factors 710, and is thus referred to as a ‘resliced’ image. The complete image slice is not shown; instead what is displayed is a ‘stenciled’ segment of the image slice, with the ‘stencil’ determined by the selected transducer type and by the depth setting. At any given moment, the image is determined by the position and orientation of the mock transducer 704 on the physical scan surface 706. The right side of the screen includes a basic ultrasound console (gain, TGC, depth, transducer selection). The graphical user interface 702 also interfaces with mouse and keyboard responses to training tasks 706 and provides tutorial, training and performance assessment 708, as illustrated. Referring to FIG. 15A in detail, the figure depicts the following features, described herein in detail: (I) the virtual transducer and the virtual torso, (II) data manager 724, (III) the 2D image window, (IV) the instruction window, (V) the landmark measurement window, (VI) clock measuring time on task, (VII) ultrasound console 730, and (VIII) control panel. FIG. 15B depicts the tracking hardware, i.e., the PSS 706 and mock transducer 704.

According to the exemplary embodiments, the training simulator 700 tracks the position and orientation (“motion tracking”) of the mock transducer 704 relative to the physical scan surface (PSS) 706. Motion tracking is a process of capturing the movement of objects in a specific coordinate system. Motion tracking devices have been widely used in many interactive applications, such as robot-assisted surgery, interactive entertainment systems and especially in simulation systems, such as military flight simulators. According to the ultrasound simulation systems described herein, the tracking system can utilize as few as three DoF or as many as six DoF to measure the orientation and/or position of the mock transducer 704.

Regarding the implementation of the tracking system, the degree to which simulator-based scanning mimics an actual ultrasound scanning is an important factor in the psycho-motor learning. In some ultrasound simulator designs, the scanning device, in the form of a mock transducer, may track only orientation and thus provide a rotation and angling-only training experience, or it may track both position and orientation to deliver a more realistic scanning experience. The choice of tracking degrees of freedom (DoF) influences the complexity of a simulator, the production of images volumes and the overall cost of a simulator. As described above in detail, the obstetric ultrasound simulator 700 described herein includes a cost-effective tracking system supporting free-hand scanning with 5 DoF, as shown in FIG. 15B, using a combination of digital paper, in the form of the Anoto paper (Anoto AB, Lund, Sweden), for position tracking, and an inertial measurement unit (IMU), specifically the PNI Fusion Sensor (PNI, Santa Rosa, Calif., USA), for orientation tracking. Given that the simulator 700 is designed for obstetric ultrasound training, a PSS 706 shaped as a 120° cylinder segment, with a footprint of 12×10 inches to approximately match the size of the female abdomen, was selected. It will be understood that other PSS configurations can be used according to the invention, depending of the particular anatomical application. The 5 DoF tracking data (θ,z,α,β,γ) enables the simulator 700 to reslice any 2D image from a given 3D image volume, where the (θ,z) and (α,β,y) denote the position and orientation information of the mock transducer 704, respectively.

Generally speaking, there are three categories of tracking systems, namely, electromagnetic, electro-optical and electro-mechanical. An electromagnetic tracking system (EMTS) can be implemented with AC or DC pulsed magnetic fields. It can track the orientation and position of an object in 6 DoF using a small sensor attached to the mock transducer that detects the magnetic field from an electromagnetic field transmitter. The EMTS has small latency (down to 5 ms), high accuracy (≈1 mm), medium cost and no need of line-of-sight to the objects, but it suffers from interferences from metallic structures in the vicinity of the sensor. A distinct disadvantage is the need of an external reference in the form of a transmitter.

The second category of tracking systems covers electro-optical tracking systems (EOTS). In camera-based EOTS, the object(s) to be followed are equipped with markers, and EOTS can provide up to 3 DoF position information. Camera tracking normally has high refresh rates (>60 Hz) and good accuracy (<1 mm). However, limitations arise from the problems of line of sight, environmental configurations (brightness, cameras locations, etc.) and the need for camera(s) to function as external references. In contrast, a cross-correlation based EOTS, such as that used in the optical computer mouse, does not require an external reference, but offers only 2 DoF position data. It also cannot measure the absolute position of objects in a specific space and it performs poorly on some uneven or transparent surfaces. A unique electro-optical tracking method is based on pattern recognition, in the form of so-called digital paper or interactive paper, which is a (paper) surface imprinted with a coded pattern and used in conjunction with a digital pen with an embedded camera. The most widely used coded pattern is the Anoto pattern. While providing only 2 DoF positional information, digital paper overcomes the limitations of the previous two optical tracking techniques and provides absolute position information in the coordinates of the digital paper even while the paper is placed on a curved surface.

The third category of tracking systems, the electro-mechanical tracking, enables orientation tracking by the use of one or more gyroscopes. An important 3 DoF orientational tracking system is the Inertial Measurement System (IMU), which can include a 3-axis gyroscope, a 3-axis accelerometer and a 3-axis geomagnetic sensor. It supplies rotation angle information (α,β,γ) along three orthogonal axes. By using magnetic north and the gravitational field as reference vectors, the IMU's orientation is obtained in world coordinates with the format of quaternion or Euler angles and is free of drift.

According to the exemplary embodiments, the tracking system for the present training simulator 700 is configured to be integrated into a mock transducer 704 preferably having the same or similar shape and size as an actual ultrasound transducer. In addition, it is highly desirable that the tracking system satisfy the following requirements:
(1) Degrees of Freedom: at least 5 DoF needed to offer realistic scanning simulation.
(2) Speed: provide tracking data more than 25 times every second to guarantee smooth visual experience.
(3) Accuracy: measure the position and rotation angle with accuracy of better than 1 mm and 1°.
(4) Robustness: tracking accuracy cannot be affected by the environmental configurations.
(5) Cost and Portability: low cost, suitable for personal ownership.
(6) External reference: not acceptable.

According to the exemplary embodiments, a combination of an IMU and an optical tracking device based on digital paper technology is used to track the mock transducer 704. In some particular embodiments, digital paper, such as Anoto digital paper, of the type sold by Anoto AB, Lund, Sweden, is used. Also, an IMU, such as PNI SpacePoint IMU sensor, of the type sold by PNI Sensor Corp., Santa Rosa, Calif., are used as the specific tracking components. The Anoto pen is mounted in the center of the mock transducer 704, which can include a transducer shell for a convex array transducer, of the type sold by Sound Technology, State College, Pa.). The pen can include an infrared (IR) light source for illuminating a small area of the Anoto pattern, an IR camera for capturing the illuminated pattern area and an image processor to extract the corresponding absolute position of that area. A pressure sensor in the pen activates the light source, which for the ultrasound simulator emulates the transducer contacts with the skin surface (Anoto pattern). In some exemplary embodiments, the Anoto pattern is printed on a durable, compliant skin-colored vinyl surface such as that sold by Visual Magnetics, Mendon, Mass., similar to a flexible magnetic sheet, to provide a more realistic simulation experience. The Anoto technology can correctly measure the absolute position at a rate of 75 Hz with a resolution of around 0.3 mm even when the Anoto pattern is placed on the curved surfaces (cylinder) or tilted at a large angle relative to normal (<55°). The PNI IMU sensor can sample the orientation of the mock transducer 704 along all three axes at a rate of 125 Hz with a resolution better than 0.1°.

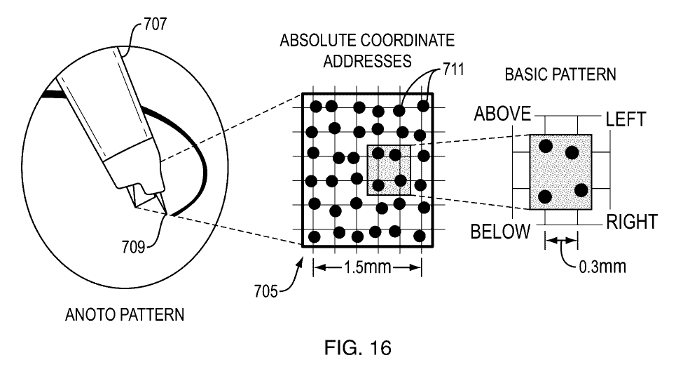

FIG. 16 is a schematic illustration of the interaction between the digital pen 707 in mock transducer 704 and the digital paper pattern 705 on PSS 706, according to some exemplary embodiments. As described above, in some exemplary embodiments, the tracking system is an Anoto system, or similar system. Referring to FIG. 16, pen 707 includes a tip portion 709 which transmits signals, e.g., infra-red (IR) signals, and receives returning signals, e.g., IR signals, from the pattern 705 of reflective dots 711 on PSS 706. Pen tip portion 709 provides an electro-mechanical sensing of contact with PSS 706. As the pen 707, carried by the mock transducer 704, moves over the digital paper dot pattern 705, affixed to the PSS 706, the position of the pen 707, and, therefore, the mock transducer 704, with respect to the digital paper dot pattern 705, and, therefore, the PSS 706, is tracked in two dimensions. Position signals are generated in the mock transducer 704 and are transmitted to the host processing equipment, e.g., computer, over one or more cables 717, which can implement USB or other type of communication with the host processing equipment. It is noted that FIG. 16 includes a detail illustration of a portion of the digital paper dot pattern 705 and specific exemplary dimensions associated with the digital paper dot pattern 705. It will be understood that the detail illustration and dimensions are exemplary only and that other particular digital paper dot pattern layouts and dimensions may be used.

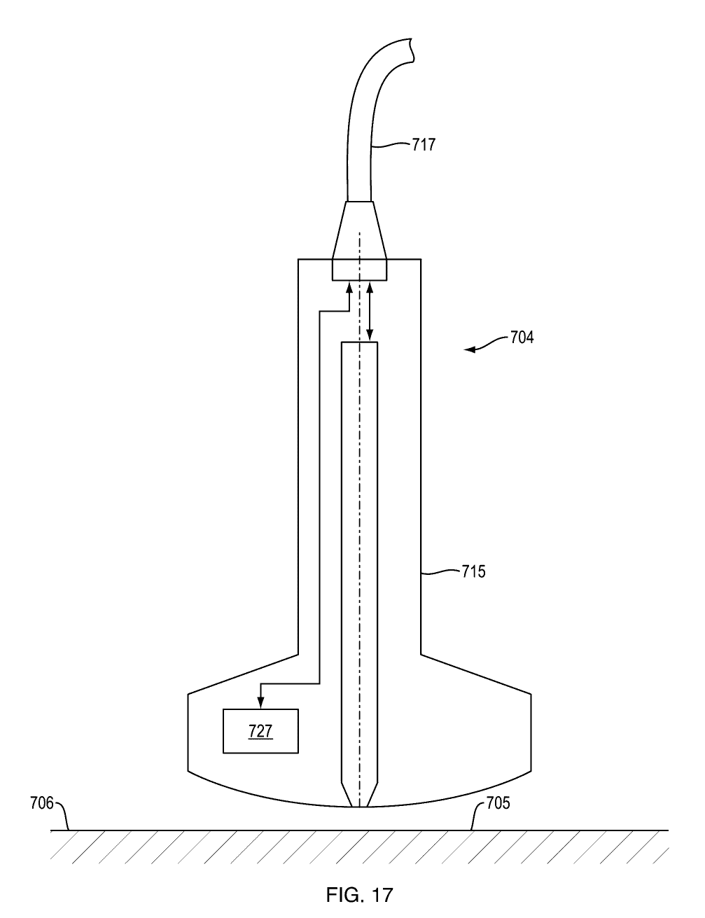

FIG. 17 includes a schematic functional block diagram of a mock transducer 704, according to exemplary embodiments. Referring to FIG. 17, in some embodiments, mock transducer 704 is made in a form factor used to emulate an actual ultrasound transducer. To that end, in some embodiments, mock transducer 704 includes an outer shell or body 715 of a convex array ultrasound transducer. The digital pen 707 is mounted in the transducer body 715 such that its longitudinal axis is aligned with the longitudinal axis 713 of the transducer 704. The tip portion 709 is exposed at the bottom of the transducer 704 such that positional tracking of the transducer 704 along the dot pattern 705 on PSS 706 can be implemented.

IMU 727, described herein in detail, is also mounted in the transducer body 715 such that three-dimensional orientation of mock transducer 704, i.e., pitch (y-axis), roll (x-axis) and yaw (z-axis), can be tracked. In some exemplary embodiments, as illustrated in FIG. 17, the z-axis can be oriented such that it is parallel to the longitudinal axis 713 of the mock transducer 704. Like the position data generated by the digital pen 707, the IMU data is transmitted to the host processing equipment via one or more cables 717, which can implement USB or other type of communication with the host processing equipment.

Thus, according to exemplary embodiments, and as described herein in detail, the digital paper optical tracking system provided 2 DoF transducer position tracking, and the IMU 727 provides 3 DoF of orientation tracking. The mock transducer system therefore provides 5 DoF tracking as the mock transducer 704 moves over the PSS 706.

The PSS 706 of the ultrasound training simulator 700 meets several requirements, such as dimensions and shape that are approximately similar to the body surface to be scanned. In some embodiments, the geometry of the PSS 706 achieves the shapes that can be obtained by curving, but not stretching or in other ways deforming, a planar surface, to ensure no distortion of the Anoto pattern. In addition, every point on the scan surface has a well-defined position and surface normal so that they can be formulated in the chosen coordinate system. For the obstetrics ultrasound simulator 704, the PSS 706 has dimensions similar to the human abdominal region. In some particular exemplary embodiments, the PSS 706 is a 120° segment of a cylindrical surface with a cylinder radius of approximately 6″ and with a footprint of 10″×12″, made from lightweight and inexpensive polyethylene sheet and covered with a 1 cm foam rubber for an appropriate degree of surface compliance, to emulate the compliance of a body surface.

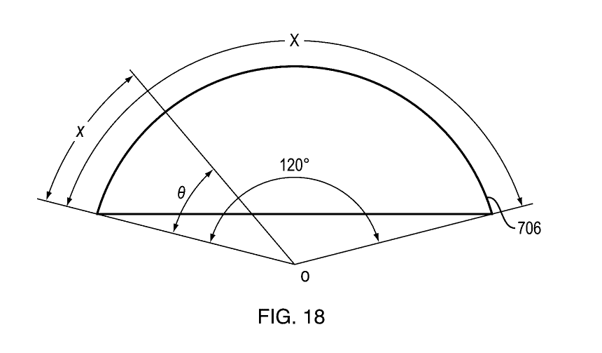

Using the fixed dimensions and geometry for the PSS 706, the simulator 700 can transform the probe position from the 2-D coordinates (x,y) of the Anoto surface, to the 3-D cylindrical coordinates (θ,z) referenced to the PSS 706. This is shown in eq. (1) and FIG. 18, which is a schematic cross-sectional view of the PSS 706, where X and Y are the dimensions of the Anoto surface, and where z is the normalized length. The α, β, γ variables denote rotation angles from the PNI sensor. The 5 DoF tracking data (θ,z,α,β,γ) from the mock transducer 704 are transformed from the PSS coordinates into 3-D image coordinates using a mathematical model before they are used to guide the simulator to extract 2-D images from the 3-D image volume. The model generation and coordinate transformation are described in detail below.

$$\{ \begin{matrix}θ = \frac{2 π}{3} \frac{x}{X} \\ z = \frac{y}{Y}\end{matrix} \qquad ( 1 )$$

According to some exemplary embodiments, a Markov Random Field (MRF) based method for the mosaicking of 3D ultrasound volumes is used for the creation of the 3D image volumes used in the training simulator 700. The process is broken down into five distinct steps, which encompass individual 3D volume acquisition, rigid registration, calculation of a mosaicking function, group-wise non-rigid registration, and final blending. Each of these steps, common in medical image processing, has been investigated in the context of ultrasound mosaicking and has resulted in an improved approach.

The group-wise non-rigid registration problem is first formulated as a maximum likelihood estimation, where the joint probability density function is comprised of the partially overlapping ultrasound image volumes. This expression is simplified using a block-matching methodology, and the resulting discrete registration energy is shown to be equivalent to a Markov Random Field. Graph-based methods common in computer vision are then used for optimization, resulting in a set of transformations that bring the overlapping volumes into alignment. This optimization is parallelized using a fusion approach, where the registration problem is divided into 8 independent sub-problems whose solutions are fused together at the end of each iteration. This method provided a significant speedup over the single-threaded approach with no noticeable reduction in accuracy. Furthermore, the registration problem is simplified by introducing a mosaicking function, which partitions the composite volume into regions filled with data from unique partially overlapping source volumes. These mosaicking functions minimize intensity and gradient differences between adjacent sources in the composite volume. With this method, composite obstetrics image volumes are constructed using clinical scans of pregnant subjects.

A solution to blending, which is the final step of the mosaicking process, has also been implemented. The learner will have a better experience if the volume boundaries are visually seamless, and this usually requires some blending prior to stitching. Also, regions of the volume where no image data was collected during scanning should be given an ultrasound-like appearance before being displayed in the simulator. This ensures that the learner's visual experience is not degraded by clearly missing image material. A discrete Poisson approach has been adapted to accomplish these tasks.

While each 3D image volume has a unique abdominal surface geometry, the dimensions of the PSS 706 are assumed to be fixed. Therefore, the movements of the mock transducer 704 on the PSS 706 can neither directly be translated into the movement of the virtual transducer on the virtual torso nor guide the reslicing of a 3-D image volume for generating a 2-D image. Thus, according to exemplary embodiments, each point on the abdominal surface of a given 3-D image volume is mapped back to the full PSS 706 so that the orientation and position of the mock transducer 704 in the PSS coordinate can be correctly transformed into the unique 3-D image coordinates. The geometry of the abdominal surface of a pregnant woman in the second trimester can be approximated to a truncated ellipsoid segment, that is, a surface obtained by cutting an ellipsoid by a plane parallel to the major axis and then truncating by planes normal to the major axis near both ends. Therefore, defined are a Virtual Scan Surface (VSS), shaped as a cylindrical segment, and Virtual Abdominal Surface (VAS), shaped as a truncated ellipsoid segment, by means of which any location and orientation of the mock transducer 704 on the PSS 706 can be transformed into a corresponding location and orientation of the virtual transducer on the abdominal image surface of a given 3-D image volume and vice versa. The purpose of introducing these additional transformation steps is to improve the accuracy of the transducer position transformation by making the transformed cylindrical coordinates closer to the abdominal image surface coordinates. This cylinder-to-ellipsoid model, or more accurately, the cylindrical-segment-to-ellipsoid-segment model, assists the simulator in transforming 5 DoF tracking data into the 3-D image volume coordinates.

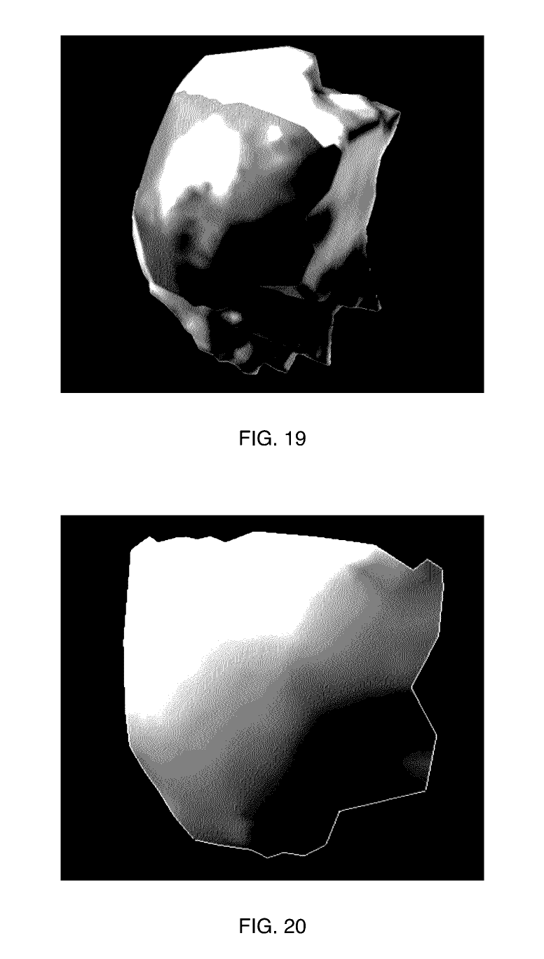

The generation of a composite 3-D image volume includes aligning and merging the overlapping 3-D individual images volumes based on the fetal and the maternal anatomies. Consequently, the abdominal surface of a given composite image volume is often irregular, as seen in FIG. 19, which is an image of a 3-D volume mesh, with the surface of the image volume shown in darker shading, according to exemplary embodiments. Not all surface points represent the true abdominal surface of the pregnant subject. This typically leads to lower accuracy when mapping a 3-D image volume to the PSS 706. In some exemplary embodiments, the image volume mesh is created from the 3D image volume using, for example, the approach described in Q. Fang and D. Boas, “Tetrahedral mesh generation from volumetric binary and gray-scale images,” Proceedings of IEEE International Symposium on Biomedical Imaging, pp. 1142-1145, 2009, which is incorporated herein by reference. To obtain the abdominal surface for model creation, the image volume mesh is preprocessed so that all mesh vertices not likely to represent the true abdominal surface (lighter shaded region in FIG. 20), are manually removed and then smoothed, for example, using 3D graphic software, such as, for example, Blender, which is open-source 3-D graphics software, developed by The Blender Foundation and publicly available at, for example, https://www.blender.org, for example.

The resulting surface is denoted the Abdominal Image Surface (AIS), as shown in FIG. 20, which is an image of the final AIS. It can be considered the best representation of the abdominal surface and is used for creating the cylinder-to-ellipsoid model. In addition, it is also used to create the virtual torso, which is described in detail below.

The process of generating the parameters for the cylinder-to-ellipsoid model is carried out off-line for each image volume, as described in detail below. The calculated parameters for the Virtual Scan Surface (VSS) and the Virtual Abdominal Surface (VAS) are stored and loaded together with each image volume. During training, the simulator probe driver first performs a linear transformation of the position and normal orientation of the mock transducer 704 to the corresponding position and orientation on the VSS, followed by a second linear transformation to the VAS that represents the abdominal surface of the 3D image volume.

One feature of the simulator 700 is that the system 700 provides a smooth visual experience by being able to render a minimum of 25 frames per second on a current, standard laptop computer. Therefore, in some exemplary embodiments, the software for the simulator 700 is based on the open source library, Medical Imaging Interaction Toolkit (MITK), which is an extension of Insight Toolkit (ITK) and Visualization Toolkit (VTK), to balance development flexibility and complexity, system performance and cost-efficiency. VTK is a widely used 2-D/3-D image-rendering library supporting multiple data formats. This library is written in C++, which enables fast image rendering on medium speed computers. Although VTK offers powerful visualization, there are only a limited number of Graphic User Interface (GUI) classes available for developers. In contrast, MITK not only inherits all classes from ITK and VTK but also extends them by providing easy-to-use GUI classes and additional features. It creates a single rendering pipeline so that the image processing algorithms in ITK can be seamlessly integrated into the VTK rendering process.

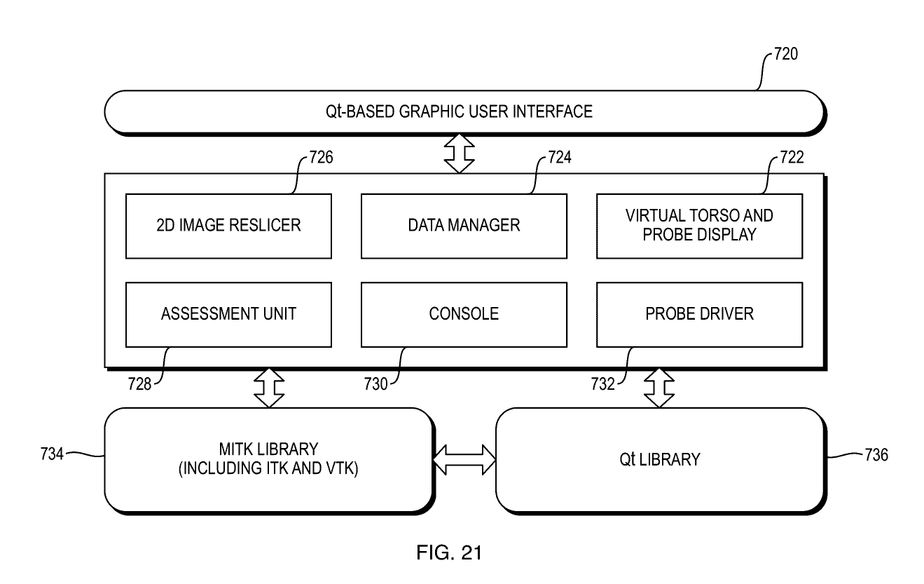

For the GUI design, Qt is used, which is a widely used cross-platform application framework. MITK has implemented some Qt widgets that can bind the image processing and rendering libraries to the simulator quickly. The software contains several components, or blocks, as shown in FIG. 21, which includes a functional block diagram of the simulator structure, according to some exemplary embodiments.

Referring to FIG. 21, the simulator 700 includes a 2-D image reslicer 726, a data manager 724, a virtual torso and probe display 722, an assessment unit 728, a console 730 and a probe driver 732. One or more of these components interface with a Qt-based graphic user interface 720, a MITK library (including ITK and VTK) 734 and a Qt library 736.

The data manager 724 loads and manages training sets while the simulator 700 is running. In exemplary embodiments, a training set contains four types of data: a 3-D image, registered 3-D anatomical landmark bounds (surfaces enclosing landmarks), a corresponding virtual torso and mapping parameters. After a given training set is loaded into the simulator 700, it is managed in a tree architecture in which the 3-D image volume is set as the parent of the other three types of data. The pre-registered landmark bounds from the training set are only needed for performance assessment and are invisible to the user during training; however, a list of landmarks, already identified by the learner for a given image volume, can be seen in the data manager window on the GUI, as shown in FIG. 15A.

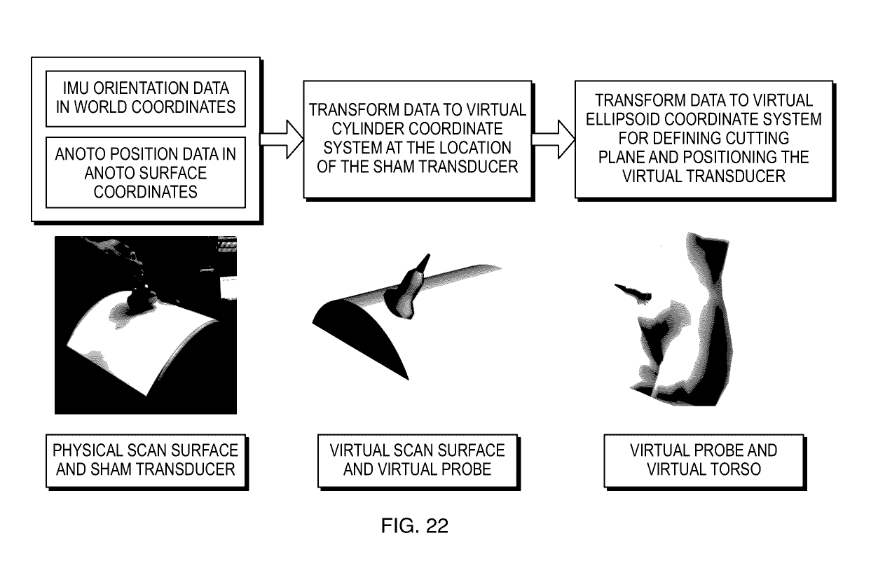

The probe driver 732 is an interface that translates the 5 DoF tracking data from the mock transducer 704 into the corresponding position and orientation data in the selected 3-D image volume coordinates, as shown in FIG. 22, which is a pictorial and schematic functional block diagram illustrating the position and orientation transformation, according to exemplary embodiments. Referring to FIG. 22, the simulator software has three major components, the 2-D image reslicer, the virtual torso and transducer, and the scanning performance assessment tool. While a learner is scanning the PSS 706, the 5 DoF tracking data from the mock transducer 704 are transformed into the corresponding position and orientation data in the coordinates of a selected 3-D image volume, to guide the generation of the 2-D images and to calculate the position and orientation of the virtual transducer on the virtual torso, as shown in FIG. 22. The 2-D image is resliced from the 3-D image volume using a trilinear interpolation approach. The virtual torso was created by manually blending a 3-D mesh object representing a generic female body with the unique abdominal surface of the selected 3-D image volume so that each 3-D image volume has its own unique virtual torso.

The position and orientation on the physical scan surface (PSS) 706 are first transformed to their corresponding position and orientation on the least-square-fit cylinder segment, or VSS, and then on the least-square-fit ellipsoid, or VAS, based on the PSS geometry and the mapping parameters, as shown in eq. (2). The position transformation is described in detail below.

P_{physical} [symbol] P_{cylinder} [symbol] Pₑₗₗᵢₚₑₛᵢₛ (2)

The orientation data from the IMU are referenced in world coordinates, defined by the gravity vector and magnetic north vector and formulated in quaternions, and are transformed to the corresponding orientation in the PSS coordinates and then into dynamic local coordinates established at the scanning point, that is, the point of contact of the mock transducer 704 and the PSS 706, as shown in eq. (3). An auto-calibration routine transforms the IMU's orientation data in world coordinates to the orientation data in the PSS coordinates by leveraging the custom capability of the Anoto pen, which allows the spinning angle around the pen's own axis to be measured. The auto-calibration utilizes the spinning angle and will be triggered whenever the transducer is roughly normal (<5°) to the curved PSS at the contact point. The orientation transformation and auto calibration are described in detail below.

Q_{world} [symbol] Q_{PSS} [symbol] Q_{local} (3)

Regarding the virtual torso and probe display 722, using the PSS 706 with fixed dimensions to emulate the abdomen of a pregnant subject provides a generic representation of the actual abdominal surface of the subject who was scanned to produce the given image volume. A virtual torso rendering is implemented by manually blending a generic female body with the unique abdominal surface (the AIS) of a given 3-D image volume with Blender software, as shown in FIG. 22, to provide a more realistic training experience.

While the learner is performing the ultrasound scanning by moving the physical mock transducer 704 on the PSS 706, a virtual transducer scans the virtual torso by following the (transformed) movement of the mock transducer 704 on the PSS 706 with respect to both position and orientation, as illustrated in FIGS. 15B and 22. Moreover, in some exemplary embodiments, the valid scanning region of the virtual torso is marked with a different shade of skin color. The movement path of the virtual transducer over the valid scanning region can optionally be recorded and visualized, and the recorded path length can be used in the learner's performance assessment. Although the cylinder-to-ellipsoid model has been used to approximate the abdominal surface of 3-D image, the virtual transducer still fails to follow the virtual abdominal surface at some locations, but instead either intersects or separates from the surface of the virtual torso. To correct this, in some exemplary embodiments, the SOftware Library for Interference Detection (SOLID) is incorporated into the simulator software; SOLID detects the intersection depth or the distance of transducer to abdominal surface and then corrects the position data from the cylinder-to-ellipsoid model. SOLID is publicly available at http://solid.sourceforge.net, for example, and is described in detail in, for example, G. van den Bergen. “A Fast and Robust GJK Implementation for Collision Detection of Convex Objects,” Journal of Graphics Tools, 4(2):7-25 (1999), and G. van den Bergen. “Efficient Collision Detection of Complex Deformable Models using AABB Trees.”, Journal of Graphics Tools, 2(4):1-13 (1997).

The 2D Image Reslicer 726 utilizes the transformed orientation and position from the probe driver 732 to define a slicing plane, which guides the extraction of 2-D slices from the 3-D image volume. First, the coordinates of every point on the slicing plane are transformed back to its corresponding coordinates in the 3-D image volume. If a given set of coordinates matches an existing voxel in the image volume, the voxel intensity is sampled directly. Otherwise a trilinear interpolation is used to calculate the voxel intensity of the corresponding point in terms of the intensities of neighbor voxels. The visual effect of using either the linear or convex array transducer is implemented by spatial filtering the extracted 2-D images with a stencil of rectangular or sector shape, for a linear array and a convex array transducer, respectively.

The assessment unit 728 implements the assessment of the performance of the individual tasks. One of its functions is to transform a given landmark in the 2-D ultrasound image that the learner was asked to locate back to the corresponding position in the 3-D images, as shown eq. (4). With the mock transducer 704 appropriately oriented and positioned, specific anatomical structures can be observed in the simulator's rendering window, i.e., the window displaying the ultrasound image, where the learner is to identify these structures on the display screen. The position of the learner-identified landmark in the coordinates of the display screen, e.g., laptop display screen, is first transformed to the corresponding position in the coordinates for the slicing plane and then to the position in the coordinates of the 3-D image volume. It can be considered a reverse procedure of generating the 2-D ultrasound image by reslicing the 3-D image volume.

P_{screen} [symbol] P_{2D slice} [symbol] P_{3D image} (4)

The assessment unit 728 determines whether the learner-identified anatomical landmarks (points) are within the corresponding landmark bounds, as defined in eq. (5). Landmark bounds are described in detail below. For the landmarks used in fetal biometry, the learner can click two or more times on the screen for the measurement to be performed. For simple length measurements, the simulator calculates the value by using eq. (6) in the 3D image volume coordinates and compares it to the stored value, obtained by a sonographer.

$$\begin{matrix}Outcome = \{ \begin{matrix}true & if x inside anatomical bounds \\ false & if x outside anatomical bounds\end{matrix} & ( 5 ) \\ d = ‖ ( \vec{p} - \vec{q} ) \cdot s ‖ & ( 6 )\end{matrix}$$

where \vec{p}, and \vec{q} denote the coordinates of two measurement points of a given anatomical structure, e.g. the fetal femur, in the 3-D image coordinates; s denotes the voxel space.

A software-based ultrasound console 730 is implemented such that the learner is able to select the scan depth, e.g., 12, 16, 20 cm, ultrasound probe type (convex array or linear array) and overall gain. These functions represent the most basic scan settings used in obstetric ultrasound.

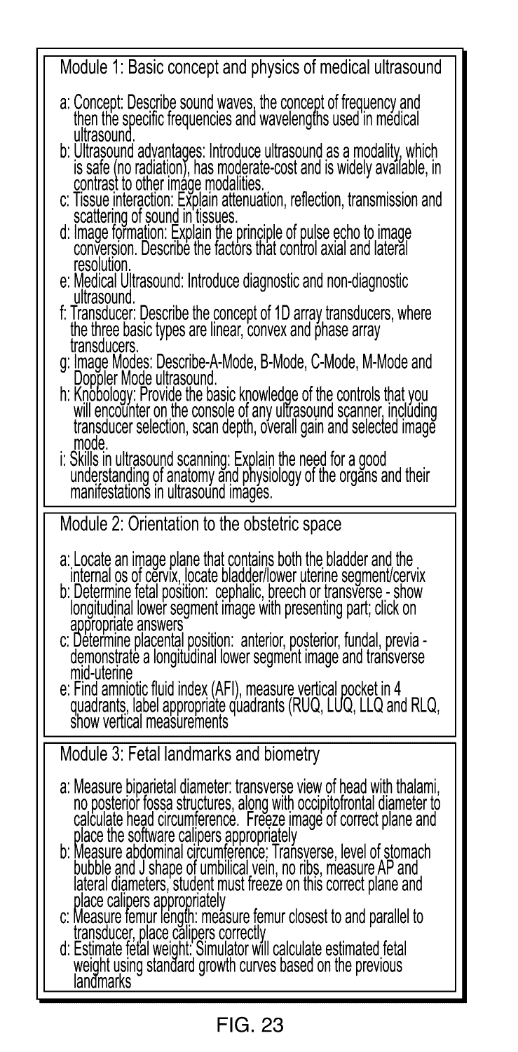

In particular exemplary embodiments, the obstetric ultrasound training focuses on the late stage of the second trimester of pregnancy and the early stage of the third trimester (24-36 weeks) where the fetus has developed sufficiently so that important anatomical structures can be observed. In prenatal scanning, the protocol requires the sonographer to identify fetal and placental position, which are two important indicators affecting clinical decision-making, and then perform biometric measurements on key anatomical structures, in particular biparietal diameter (BPD), abdominal circumference (AC) and femur length (FL), based on which fetal weight can be estimated. To provide the basic ultrasound physics background and to learn and practice obstetrics ultrasound scanning skills, the obstetrics simulator 700 provides three training modules, each of which includes several training tasks, as illustrated in FIG. 23, which is a schematic functional diagram of three modules of the training of the simulator 700, according to some exemplary embodiments. The three exemplary training modules are identified in FIG. 23 as Module 1, Module 2 and Module 3.

Referring to FIG. 23, Module 1 introduces basic ultrasound concepts such as tissue density, acoustic impedance, resolution and artifacts. It also familiarizes the learner with key aspects of ultrasound training, the proper use of the transducer, and techniques for adjusting gain and depth setting. In Module 2, the learner practices how to correctly manipulate the transducer so that the uterus, cervix, fetus and placenta are observed in the ultrasound image. This module trains the learner to correctly identify the anatomical structures in the B-mode image and to evaluate the fetal and placental position in the uterus. In Module 3, the learner performs biometric measurements to locate and measure important anatomical structures and then estimate fetal weight based on these measurements.

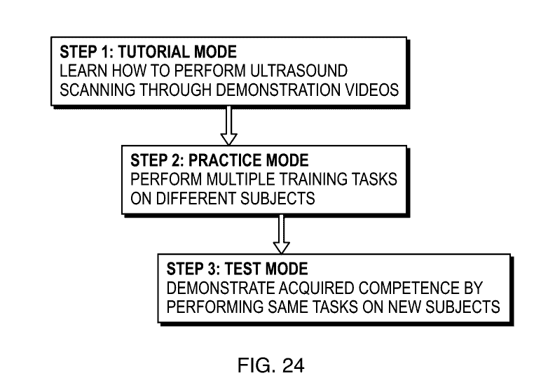

In exemplary embodiments, the training covered in Modules 2 and 3 is implemented as a sequence of three steps, as depicted in FIG. 24, which the learner should complete sequentially. FIG. 24 is a schematic logical flow diagram of the three steps executed in training modules, according to exemplary embodiments. Referring to FIG. 24, Step 1 is the tutorial mode, which includes a set of separate, pre-recorded videos, in which a sonographer demonstrates, using the simulator, how each individual task in Modules 2 and 3 is completed. Step 2 is the practice mode, in which the learner acquires and refines his/her scanning skills by identifying anatomical structures and completing biometric measurements, with the simulator verifying whether each task was correctly completed. The practice mode uses a set of 3-D image volumes, each obtained from a different pregnant subject. Thus, the learner's training is equivalent to scanning several human subjects. In the practice mode, the simulator provides additional guidance in identifying necessary anatomical structures while performing the biometric measurements, as well as informing the learner whether a task was correctly performed.

After the learner has acquired sufficient skills in carrying out the tasks in Modules 2 and 3, he/she can demonstrate his/her competence by completing Step 3, which is the test mode. Here, the training simulator 700 evaluates the learner's training performance using the same tasks in step 2, but based on a new 3-D image volume. In the test mode, the learner only receives the result of pass or fail from the simulator. The score of pass indicates that the learner has successfully completed all tasks within stipulated time slot. Otherwise, the learner receives the score of fail.

A component of the training simulator 700 is its ability to automatically assess whether the learner has correctly identified a specified landmark. In some embodiment, this is achieved by using a pre-inserted surface that surrounds, or bounds, the landmark at a close distance. Such a surface will be referred to herein as a “landmark bound.” In general, every training set includes a plurality of landmark bounds, placed by experienced sonographers or determined by segmentation algorithms. Utilizing these bounds, the simulator can automatically evaluate the learner's performance as well as provide scanning guidance during the practice. Two exemplary approaches to the creation and insertion of landmark bounds are described herein in detail.

Referring to FIGS. 23 and 24, in Task 2 of Module 2, the learner is asked to identify the fetal head from a given image volume as part of the process of determining fetal position, and in Task 1 of Module 3, the learner measures the diameter of the fetal head, referred to as the biparietal diameter (BPD). To establish the landmark bound for the fetal head, an iterative randomized Hough transform (IRHT) designed for 2-D images is modified to create a 3-D ellipsoid model for the fetal head of a given 3-D image volume.

In Task 3 of Module 2, the learner is required to locate the placenta and determine its position. Usually, the placenta in the uterus is crescent shaped or flat. It is therefore very challenging to use a single geometrical shape to model the whole placenta. Therefore, according to some exemplary embodiments, the whole placenta is segmented using, for example, an interactive segmentation process on a sequence of 2-D image planes, containing the entire placenta. In some exemplary embodiments, the interactive segmentation process can be, for example, “Grow Cut,” which is publicly available software and which is described in detail in, Vezhnevets, Vladimir, et al., “‘GrowCut’—Interactive Multi-Label N-D Image Segmentation By Cellular Automata,” Graphics and Media Laboratory, Moscow State University, Moscow, Russia, Proceedings of Graphicon, pp. 150-156, 2005. A copy of this paper is available at http://www.graphicon.ru/older/en/publications/text/gc2005vk.pdf, as accessed on May 6, 2015. Then, Fang's approach referred to above is used to create the placenta's isosurface with triangular meshes.

Landmark bounds for all other anatomical structures to be identified, such as thalami, stomach bubble, umbilical vein, bladder and cervix, are manually inserted under the guidance of an experienced sonographer. Each of them is defined as a bounded surface (a sphere with different radius in current design). The biparietal diameter (BPD), femur length (FL) and abdominal circumference (AC) are also measured by experienced sonographers and then stored with the above landmark bounds in the same file.

In performing task assessment, in exemplary embodiments, the simulator 700 evaluates the learner's understanding of medical ultrasound basics in Module 1 by a series of multiple choice questions randomly selected by the simulator from a pool. For the training tasks in Modules 2 and 3, the simulator 700 evaluates the learner's scanning performance based on whether the learner is able to:

1. Position the mock transducer 704 so that the 2-D image contains specific anatomical structures required by a given task and then freeze the 2-D image;
2. Identify specific landmarks by clicking on them with the mouse on the 2-D image;
3. Carry out specified biometric measurements on the 2-D image; and
4. Answer multiple choice questions associated with a given task and prompted by the simulator.

For a given biometric measurement task, the simulator 700 focuses on: 1) if the learner has correctly located the 2-D image needed for performing the measurement and 2) if the measurement is correct or not by comparing the measured value to the corresponding biometric value obtained by an experienced sonographer. The simulator 700 gives feedback to the learner regarding the accuracy of the measurement result, as follows: correct (<5% error), less accurate (5%-10% error) and incorrect (>10% error). This feedback function is only active for the tasks requiring biometric measurements. As to the landmark identification tasks, the simulator checks if the learner has correctly identified the specified landmark(s) and/or correctly answered questions presented by the simulator. The main assessment criteria for the tasks in Modules 2 and 3 are as follows:

Task 1 of Module 2 (task 2a): The simulator 700 examines if the selected 2-D image contains cervix and bladder. If not, the simulator 700 will point out which anatomical structure is missing. In addition the learner will need to identify the above mentioned landmarks by clicking them.

Task 2 of Module 2 (task 2b): The learner must identify the fetal head and then determine whether the fetal position is cephalic, breech or transverse.

Task 3 of Module 2 (task 2c): The learner must identify the placenta and then determine whether the placenta position is anterior, posterior, previa or fundal.

Task 4 of Module 2 (task 2d): The simulator checks if the learner has correctly measured the four quadrants depths of the amniotic fluid at correct positions. The learner needs to judge if the amniotic fluid is oligohydramnios, normal or polyhydramnios after completing the measurements. If the learner measures the quadrant depth at a wrong position, the simulator will point out that error.

Task 1 of Module 3 (task 3a): The simulator 700 examines first if the selected 2-D image contains the thalami of the fetal head and then compares the measured BPD value with the reference value.

Task 2 of Module 3 (task 3b): The simulator 700 examines first if the selected 2-D image contains the umbilical vein and stomach bubble and then check if the anterior-posterior diameter is roughly at right angle to the lateral diameter and finally compares the measured abdominal circumference with the reference value.

Task 3 of Module 3 (task 3c): The simulator 700 examines first if the selected 2-D image contains both ends of a femur and then compares the measured value with the reference value.

Task 4 of Module 3 (task 3d): Once the learner has completed Tasks 1-3 of Module 3, the simulator 700 loads the measured BPD, AC and FL values automatically and then calculates the fetal weight based on these values. In this task, if the estimate obtained from the learner's measurements is within +/−10% of the reference value, the simulator 700 considers the fetal weight to have been correctly estimated. The learner needs to determine if the fetal development is appropriate for gestational age, or there is intrauterine growth restriction or macrosomia, based on the completed biometric measurements.

In some exemplary embodiments, performance of the simulator 700 is evaluated based on the following qualities: i) an adequate image generation and rendering speed for the simulator, ii) a realistic 2-D ultrasound image quality and achievable biometric measurement, and iii) a structured training with skill-based evaluation by trained sonographers.

First, the results of the rendering speed testing of the simulator on two different laptops with different hardware configurations are presented below. Second, 2-D ultrasound images generated from the simulator are compared below to actual ultrasound images acquired from a pregnant subject at the same time that the 3-D image volumes were acquired. Third, a preliminary evaluation of the obstetric training by a small group of experienced obstetricians is presented below.

Regarding simulator rendering speed testing, in the simulator design, the 2-D image generation and rendering speed directly influence the training experience and realism of the simulator 700. The simulator 700 was tested on two moderately-priced laptops with different hardware configurations.
Laptop A: Core i7-3520 @ 2.90 GHz, 8 GB memory, Windows 7, 64 bit
Laptop B: Core i3-2350 @ 2.3 GHz, 6 GB memory, Windows 7, 64 bit

TABLE 1
THE RENDERING SPEED OF 2D
ULTRASOUND IMAGES ON LAPTOP A AND B

| | A | B | A | B |
|---|---|---|---|---|
| | (33 fps) | (33 fps) | (50 fps) | (50 fps) |
| Frame Rate | 30.17 | 29.48 | 39.37 | 30.60 |
| Total Rendering | 16.59 | 16.95 | 12.70 | 16.34 |
| Time (s) | | | | |

The rendering speeds on the two laptops are calculated in frames per second (fps), based on the total time of rendering 500 frames, with the results presented in Table 1. These numbers also include the time required for virtual torso and virtual transducer rendering. The simulator 700 was configured to render 2-D images at speeds of 33 fps and 50 fps. For the lower rendering speed, the simulator performance was almost the same on two platforms, but laptop A performed much better than laptop B if the rendering speed was set to 50 fps, mainly resulting from the difference in the CPUs and memory sizes of the two laptops. The results in Table 1 show that the simulator 700 is able to generate and render 2-D images at a speed above 30 fps. This satisfies the specification of greater than 25 fps, which is a widely accepted requirement for a smooth visual presentation and minimum interfering motion blur or jitter. The image volumes used for performance evaluation have an average size of 800 by 550 by 900 voxels. The voxel dimensions are 0.49 mm in the x, y and z directions of the 3-D image volume coordinate.

Regarding comparison between simulator-generated and actual biometric measurements and 2-D images, given that biometric measurements are an important aspect of obstetric ultrasound training, the values of BPD, AC and FL measured on the simulator-generated images against the values of BPD, AC and FL measured on the clinical ultrasound images obtained while scanning the human subjects are compared. This comparison of simulated images with real images is a demanding test, because the 3-D image volume is constructed from 2-D images acquired from multiple linear scans, while the real images for measurements are obtained directly. Even for the same pregnant subject, both the fetal biometric measurements and 2-D images used for the measurements vary from one scan to the next, due to unavoidable fetal movements.

The clinical fetal measurements were obtained with a Philips iU22 ultrasound scanner. The biometric measurements for two image volumes performed on the simulator-generated images and on the clinical ultrasound images are presented in Table 2.

TABLE 2
CLINICAL VS. SIMULATED BIOMETRIC
MEASUREMENTS (DIMENSIONS IN CM)

| Image | Image | Biparietal | Abdominal | Femur |
|---|---|---|---|---|
| Volume | Type | Diameter | Circumference | Length |
| 1 | Clinical | 6.48 | 22.31 | 4.68 |
| | Simulated | 7.6 | 24.67 | 5.21 |
| 2 | Clinical | 8.31 | 28.91 | 6.21 |
| | Simulated | 8.3 | 23.43 | 5.6 |

It is noted that the simulator-derived measurements are not fully consistent with clinical results. However, the level of error is acceptable for ultrasound training, considering that the clinical and simulated measurements were not taken at the exact same positions and orientations and that sonographers may define the anatomical locations used in biometric measurements slightly differently. That has been confirmed by the experienced sonographer who performed the measurements on the simulated images.

The realism of 2-D images is important to the user experience, so simulator-generated 2-D images are compared to the corresponding images directly from the Philips iU22 ultrasound scanner. The images required for measuring BPD, AC and FL were chosen for this comparison. FIG. 25 presents the comparison between clinical images and simulator-generated images from same subject (Volume 2). The first row contains fetal skull images for BPD measurement. The shapes of the skull outline in the two images are not exactly the same, which may result from the fact that the simulated image is generated from slightly different transducer positions and orientations, compared to the image obtained directly from the ultrasound scanner. The second row of images contains the fetal abdomen. Seen clearly in the simulated image are the stomach bubble (a round dark region at the lower of abdomen) and umbilical vein (above the stomach bubble and appearing like a “J”), which are two important references to judge if the 2-D image is suitable for the abdominal circumference measurement. The third row contains images required for the measurement of femur length.

Regarding the preliminary determination of the suitability of the ultrasound simulator as a valid training tool, an evaluation was undertaken of the following learning criteria: (i) are the tasks in Modules 2 and 3 achievable, (ii) do the tasks constitute an integrated learning experience, and (iii) do the simulator provide a realistic scanning experience and good image quality. Criterion (i) was obtained by measuring the completion times for Modules 2 and 3 tasks, while criteria (ii) and (iii) were assessed via a questionnaire. The evaluation of all three criteria was carried out by three experienced obstetrics sonographers from University of Massachusetts Medical Center.

For Criterion (i), the ability of the ultrasonographers to successfully complete six tasks in Modules 2 and 3 were evaluated, where each expert scanned two image volumes, volumes 1 and 2. The time for successful completion of each task was recorded, as shown in Table 3. The times on task for volumes 1 and 2 are listed in the left and right columns under each task, respectively.

The results indicate that the tasks required different amounts of time and effort; nonetheless, the times required for the task completion were fairly consistent across the three experts, with the exception of the time spent on task 3a (BPD measurement) by expert 1 who took longer time, mainly because a tight bound was defined around the thalami, thus making an error message for the BPD measurement likely.

From the responses in the questionnaire, all three sonographers agreed that the tasks were easily performed and well organized in sequence. In addition, the sonographers considered the simulated images to be adequately realistic for ultrasound training and found the simulator to provide a fully adequate level of processing speed.

The sonographers further noted that the simulator had the potential for becoming a good supplemental training tool for medical schools students and resident doctors and that the training tasks were appropriate for obstetrics training. One sonographer indicated that the absence of a beating fetal heart in the ultrasound image of the simulator somewhat detracted from the realism.

TABLE 3
SCANNING TIMES FOR SUCCESSFUL COMPLETION
OF MODULES 2 AND 3 TASKS ON IMAGE VOLUMES
1 AND 2 (TIMES IN SECOND)

| | Expert 1 | | Expert 2 | | Expert 3 | |
|---|---|---|---|---|---|---|
| Task 2b | 10 | 8 | 20 | 9 | 6 | 6 |
| Task 2c | 7 | 24 | 10 | 11 | 11 | 21 |
| Task 2d | 102 | 32 | 63 | 20 | 50 | 22 |
| Task 3a | 221 | 248 | 46 | 75 | 13 | 13 |
| Task 3b | 20 | 23 | 17 | 26 | 18 | 16 |
| Task 3c | 24 | 18 | 36 | 12 | 18 | 15 |

The goal of this work has been to develop an affordable simulator that is able to provide a realistic scanning experience. Making the simulator affordable requires that the simulator software be able to run on an ordinary laptop or PC. In addition, the design of the 5 DoF tracking system lowers the potential cost, a requirement met by using an Anoto pen and an IMU. The component cost of the IMU, the Anoto pen, the physical scan surface and transducer case totals less than $300.

The physical scan surface 706 provides the learner with a realistic scanning experience, that is, the learner can continuously scan an extended region while allowing angling and/or rotation of the mock transducer 704. This feature is beneficial to proper training in psychomotor skills. To provide further realism to the scanning experience, a display window including a virtual torso with a virtual transducer allows the learner to see the position and orientation of the (virtual) transducer on the (virtual) abdomen. The customized software design makes the simulator able to run on a regular laptop with a frame rate better than 25 fps.

As described in detail herein, the obstetric simulator 700 has the strength of supporting continuous scanning over an extended simulated body surface, using training volumes assembled from overlapping 3-D scans. This presents a challenge to the registration algorithm that assembles the individual 3-D volumes into one large image volume, due to both fetal and maternal movement during scanning as well as the occasional heavy shadowing in 2-D images. To that end, a new method that can mosaic 3-D ultrasound volumes based on Markov Random Field (MRF) is used.

The obstetrics simulator 700 is designed to provide self-paced, simulator-assisted training on the basic or even the intermediate obstetric ultrasound level, by integrating training guidance and scanning evaluation in the simulator software. Training tasks and assessment criteria are formulated based on standard practice of obstetric ultrasound. Specifically, the structured training tasks aim to train the learner in the proper obstetric ultrasound examination sequence, identification of critical anatomical structures and biometric measurements. This is achieved by inserting landmark bounds for all anatomical structures to be identified, a task either implemented with algorithms or under the guidance of an obstetrics sonographer.

The training simulator 700 described herein is well-suited for adaption to ultrasound training in other medical specialties. For example, the training simulator can be adapted to emergency medicine, especially for abdominal injuries, where the same physical scan surface can be utilized. Different training volume than those described herein would be produced. Since time-consuming scanning of injured individuals would not be feasible, mosaicked scans of various normal individuals would be utilized, followed by organ boundary segmentation and injury simulation by numerical techniques. The simulator 700 can also be adapted for training in ultrasound guided procedures, where a second Anoto pen with force sensing can be used to model the needle and where integrated force sensing will be used to simulate the needle tip progression across tissue layers.

A near-term development of the simulator 700 involves the integration of a beating fetal heart into the 3-D image volumes, for which the 4-D images material has been acquired. An additional development involves the design of automated segmentation and modeling algorithms to improve efficiency and accuracy of the insertion of landmark bounds.

Generation of the virtual scan surface (VSS) and virtual abdominal surface (VAS) according to some exemplary embodiments will be described in more detail below. The generations of the virtual scan surface and the virtual abdominal surface involve several coordinate systems, such as world coordinate, the physical scan surface coordinate, 3-D image volume coordinate, etc. Given that the VSS and VAS are directly derived from the abdominal image surface (AIS) of a 3-D image volume, all computations described herein are based on the Cartesian coordinate system for the original 3-D image volume (image coordinates), which was established during the 3-D image volume generation.

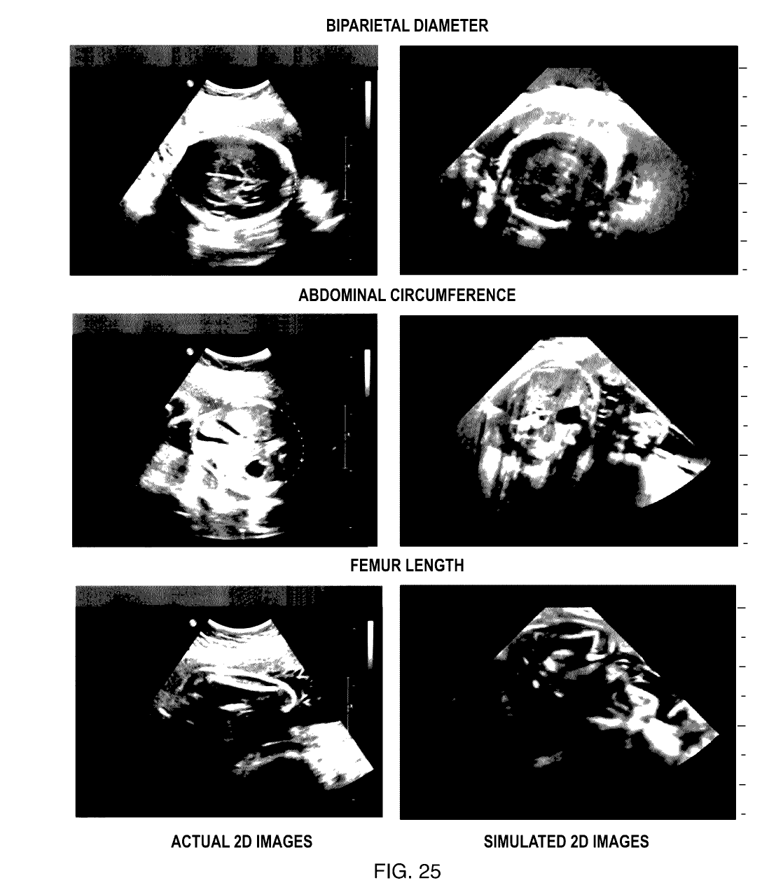

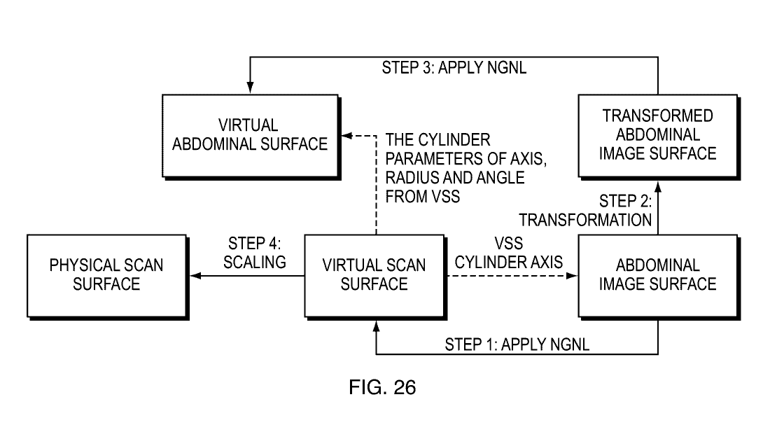

Both the VSS and the VAS are specified based on the geometry of the smoothed abdominal image surface using the Newton-Gauss non-linear algorithm (NGNL). As a general rule, an AIS cannot directly generate the corresponding VAS from a given image volume due to the deviations from an ellipsoidal shape (even after smoothing) and the limited number of vertices of abdominal image surface. Therefore, the process of generating the cylinder-to-ellipsoid model has been optimized, as shown in FIG. 26, which is a schematic functional block diagram of a procedure for generating the VSS and VAS, according to some exemplary embodiments.

Referring to FIG. 26, the first step is to determine the parameters of the VSS by a least square fit of the VSS to the AIS through the NGNL algorithm (step 1 in FIG. 26). Specifically, the radius, spanning angle and cylinder axis of the VSS are determined. It is noted that the VSS is coaxially aligned to the PSS, but has different dimensions and spanning angles. In general, the z axis (cylinder axis) of the VSS is initially not parallel to the z axis of the image coordinates. Second, a transformation matrix R is computed by aligning the VSS cylinder axis to z axis of image coordinates and then the AIS is transformed (step 2 in FIG. 26). The purpose of this step is to simplify the computation in step 3 by restricting the parameters that can be modified of the VAS only to the lengths of ellipsoid axes, instead of also including the rotation, translation and axes length parameters. The matrix of R⁻¹ will be integrated into the probe driver to offset the AIS transformation in this step. Third, a least-square-fit VAS is generated from the transformed AIS using NGNL algorithm, where the VAS has the same parameters as VSS except for the radii, which are the ellipsoid axes lengths in the image coordinates (step 3 in FIG. 26). In addition, its major axis is coaxially aligned with the cylinder (VSS) axis. Restricting the number of VAS DoF also guarantees that the VAS can be obtained successfully despite the limitation of 3D image volumes. Finally, the PSS and the VSS are normalized for later transformation.

In generating the VSS, an arbitrary point (x_{c}, y_{c}, z_{c}) on the cylinder surface that computes the final VSS can be expressed parametrically as:

$$[ \begin{matrix}{x}_{c} \\ {y}_{c} \\ {z}_{c}\end{matrix} ] = {R}_{x} * {R}_{y} * [ \begin{matrix}r cos θ \\ r sin θ \\ L\end{matrix} ] + [ \begin{matrix}{x}_{0} \\ {y}_{0} \\ {z}_{0}\end{matrix} ] \qquad ( 7 )$$

where θ is a free variable (0≦θ<2π); L is the length of the cylinder; (x₀, y₀, z₀) is a point on the axis of the cylinder; r is the cylinder radius; Rₓ and R_{y} are rotation matrices derived from θₓ and θ_{y} that represent rotation angles of the cylinder axis around x and y axes, respectively, as given in (8) and (9). The parameters of L, r, x₀, y₀, z₀, θₓ and θ_{y} are fixed values for a specific cylinder.

$$\begin{matrix}{R}_{x} = [ \begin{matrix}cos {θ}_{x} & - sin {θ}_{x} & 0 \\ sin {θ}_{x} & cos {θ}_{x} & 0 \\ 0 & 0 & 1\end{matrix} ] & ( 8 ) \\ {R}_{y} = [ \begin{matrix}cos {θ}_{y} & 0 & sin {θ}_{y} \\ 0 & 1 & 0 \\ - sin {θ}_{y} & 0 & cos {θ}_{y}\end{matrix} ] & ( 9 )\end{matrix}$$

To find the cylinder that is the least-square-fit (LSF) to the AIS, it is assumed the cylinder to be in a fixed position and instead transform the AIS in the following calculations. The fixed cylinder is described in eq. (10) as:

$$[ \begin{matrix}{x}_{c} \\ {y}_{c} \\ {z}_{c}\end{matrix} ] = [ \begin{matrix}r cos θ \\ r sin θ \\ s\end{matrix} ] \qquad ( 10 )$$

First, the AIS, which is described in terms of vertices, are translated by a vector vₜ=(0, 0, −z_{cent}) as shown in eq. (11), where (vₓᵢ, v_{yi}, v_{zi}) and (v′ₓᵢ, v′_{yi}, v′_{zi}) represent i^{th} initial and translated vertex of the AIS, respectively. N is total number of the AIS vertices. The variable went is obtained from the AIS centroid (x_{cent}, v_{cent}, z_{cent}), as shown in eq. (12)

$$\begin{matrix}[ \begin{matrix}{v}_{xi}^{′} \\ {v}_{yi}^{′} \\ {v}_{zi}^{′}\end{matrix} ] = [ \begin{matrix}{v}_{xi} \\ {v}_{yi} \\ {v}_{zi}\end{matrix} ] + [ \begin{matrix}0 \\ 0 \\ - {z}_{cent}\end{matrix} ] 1 \leq i \leq N & ( 11 ) \\ [ \begin{matrix}{x}_{cent} \\ {y}_{cent} \\ {z}_{cent}\end{matrix} ] = [ \begin{matrix}\frac{1}{N} {\sum }_{i = 1}^{N} {v}_{xi} \\ \frac{1}{N} {\sum }_{i = 1}^{N} {v}_{yi} \\ \frac{1}{N} {\sum }_{i = 1}^{N} {v}_{zi}\end{matrix} ] 1 \leq i \leq N & ( 12 )\end{matrix}$$

Thus, a five-parameter set s=(θₓ, θ_{y}, xₜ, yₜ, r), given in eq. (13), is used to manage the cylinder orientation and position. The solution of eq. (13) defines a cylinder that is a least square fit to the corresponding AIS. Similar to eq. (7), θ is a free variable (0≦θ<2π); L is the length of the cylinder; Rₓ and R_{y} are rotation matrices; r is the cylinder radius; (xₜ, yₜ, 0) is a point on the axis of the cylinder.

$$[ \begin{matrix}{x}_{c} \\ {y}_{c} \\ {z}_{c}\end{matrix} ] = {R}_{y} * {R}_{y} * [ \begin{matrix}r cos θ \\ r sin θ \\ L\end{matrix} ] + [ \begin{matrix}{x}_{t} \\ {y}_{t} \\ 0\end{matrix} ] \qquad ( 13 )$$

To solve it, the Newton-Gauss nonlinear method is used, which requires an initial guess. The original AIS suggests that the cylinder axis is roughly parallel to z-axis, so we set the initial guess as θₓ=θ_{y}=0, −x_{cent}, y^{t}=−y_{cent}, cent, r=c, where c is a constant number and associated with the 3D image volume. We define a vector d such that the i^{th} scalar is the distance of i^{th} vertex on the abdominal surface to the cylinder axis; hence, this vector can be written as:

$$[ \begin{matrix}{d}_{xi} \\ {d}_{yi} \\ {d}_{zi}\end{matrix} ] = {R}_{y}^{′} * {R}_{x}^{′} * ( [ \begin{matrix}{v}_{xi}^{′} \\ {v}_{yi}^{′} \\ {v}_{zi}^{′}\end{matrix} ] + [ \begin{matrix}- {x}_{t} \\ - {y}_{t} \\ 0\end{matrix} ] ) 1 \leq i \leq N \qquad ( 14 )$$

where dₓᵢ, d_{yi}, d_{zi} are the i^{th} distance that is projected to x, y and z axes. R′ₓ and R′_{y} are inverse matrices of Rₓ, R_{y}. The distance of a vertex to the cylinder surface is:

$${f}_{i} = [ \begin{matrix}{d}_{xi} & {d}_{yi} & {d}_{zi}\end{matrix} ] * Nt - r \\ where Nt = [ \begin{matrix}\frac{{d}_{xi}}{\sqrt{{d}_{xi}^{2} + {d}_{yi}^{2}}} \\ \frac{{d}_{yi}}{\sqrt{{d}_{xi}^{2} + {d}_{yi}^{2}}}\end{matrix} ] 1 \leq i \leq N \qquad ( 15 )$$

To minimize the f=[f₁, f₂, . . . fi, . . . f_{N}], (1≦i≦N), we construct a Jacobian Matrix in eq. (16),

$$J = [ \begin{matrix}\frac{\partial {f}_{i}}{\partial {s}_{1}} & \frac{\partial {f}_{i}}{\partial {s}_{2}} & \frac{\partial {f}_{i}}{\partial {s}_{3}} & \frac{\partial {f}_{i}}{\partial {s}_{4}} & \frac{\partial {f}_{i}}{\partial {s}_{5}} \\ … & … & … & … & … \\ \frac{\partial {f}_{N}}{\partial {s}_{1}} & \frac{\partial {f}_{N}}{\partial {s}_{2}} & \frac{\partial {f}_{N}}{\partial {s}_{3}} & \frac{\partial {f}_{N}}{\partial {s}_{4}} & \frac{\partial {f}_{N}}{\partial {s}_{5}}\end{matrix} ] \\ where \\ \{ \begin{matrix}\frac{\partial {f}_{i}}{\partial {s}_{1}} = {Nt}_{( i )} * {R}_{y}^{′} * {dR}_{x}^{′} * ( [ \begin{matrix}{v}_{xi}^{′} \\ {v}_{yi}^{′} \\ {v}_{zi}^{′}\end{matrix} ] - [ \begin{matrix}{x}_{t} \\ {y}_{t} \\ 0\end{matrix} ] ) \\ \frac{\partial {f}_{i}}{\partial {s}_{2}} = {Nt}_{( i )} * {dR}_{y}^{′} * {dR}_{x}^{′} * ( [ \begin{matrix}{v}_{xi}^{′} \\ {v}_{yi}^{′} \\ {v}_{zi}^{′}\end{matrix} ] - [ \begin{matrix}{x}_{t} \\ {y}_{t} \\ 0\end{matrix} ] ) \\ \frac{\partial {f}_{i}}{\partial {s}_{3}} = {Nt}_{( i )} * {R}_{y}^{′} * {R}_{x}^{′} * [ \begin{matrix}- 1 \\ 0 \\ 0\end{matrix} ] \\ \frac{\partial {f}_{i}}{\partial {s}_{4}} = {Nt}_{( i )} * {R}_{y}^{′} * {R}_{x}^{′} * [ \begin{matrix}0 \\ - 1 \\ 0\end{matrix} ] \\ \frac{\partial {f}_{i}}{\partial {s}_{5}} = - 1\end{matrix} \qquad ( 16 )$$

dR′ₓ, dR′_{y} are the derivatives of R′ₓ, R′_{y}

$$\begin{matrix}{dR}_{x}^{′} = [ \begin{matrix}1 & 0 & 0 \\ 0 & - sin {θ}_{x} & - cos {θ}_{x} \\ 0 & cos {θ}_{x} & - sin {θ}_{x}\end{matrix} ] & ( 17 ) \\ {dR}_{y}^{′} = [ \begin{matrix}- sin {θ}_{y} & 0 & cos {θ}_{y} \\ 0 & 1 & 0 \\ - cos {θ}_{y} & 0 & - sin {θ}_{y}\end{matrix} ] & ( 18 )\end{matrix}$$

The five-parameter set s is continuously updated using eq. (19), where p is the solution of eq. (20).

s=s+p (19)

p=−f/J (20)

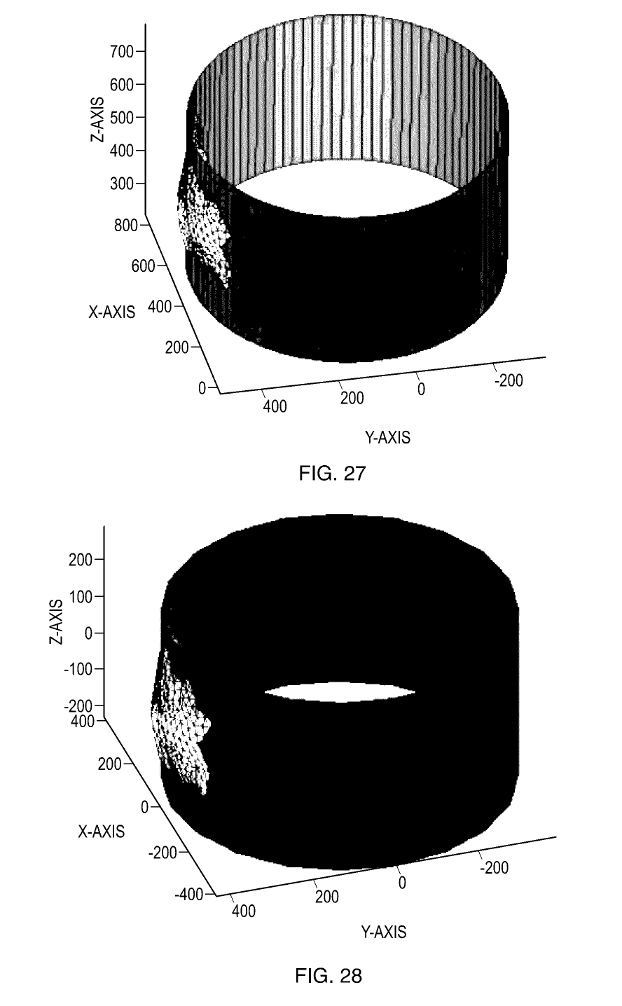

FIG. 27 is a pictorial image of a best fit cylinder for the abdominal surface, according to some exemplary embodiments. Once the tolerance level t, computed in eq. (21), is less than a predefined value (0.01 in one case), the update process terminates, allowing a LSF cylinder to be defined, as shown in FIG. 27 and described using eq. (13).

t=norm(p)/norm(s) (21)

To simplify generation of VAS and calculate the cylinder angle and length, the LSF cylinder and AIS are transformed as shown in eq. (22) where (x_{c}, y_{c}, z_{c}) and (x′_{c}, y′_{c}, z′_{c}) represent points on the pre-transformed and post-transformed LSF cylinder surface, respectively; (x₀, y₀, z₀) is the point on the cylinder axis and closest to the centroid of abdominal surface. As shown in FIG. 28, which is a pictorial image of the abdominal surface in standard position, the axis of cylinder passes through the origin and is aligned to the z axis.

$$[ \begin{matrix}{x}_{c}^{′} \\ {y}_{c}^{′} \\ {z}_{c}^{′}\end{matrix} ] = {R}_{2}^{′} * {R}_{1}^{′} * ( [ \begin{matrix}{x}_{c} \\ {y}_{c} \\ {z}_{c}\end{matrix} ] - [ \begin{matrix}{x}_{0} \\ {y}_{0} \\ {z}_{0}\end{matrix} ] ) = [ \begin{matrix}r cos θ \\ r sin θ \\ s\end{matrix} ] \qquad ( 22 )$$

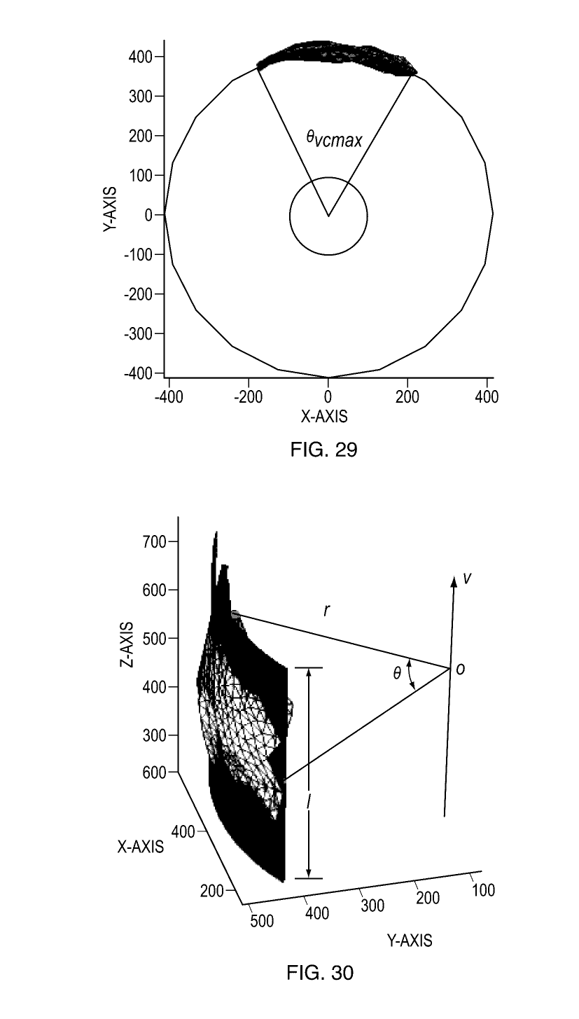

The cylinder segment angle θ_{vcmax}, as shown in FIG. 29, which is a pictorial image of the cylinder cross-section angle, is determined by two AIS vertices (p₁ and p₂), which can yield maximal angle. The angle θ_{vcmax} is calculated by eq. (23) using p′₁ and p′₂ which are the projections of p₁ and p₂ on the xy plane that passes the origin. The length of cylinder (l_{c}) is determined by the maximal length between two AIS vertices along the z-axis. The final VSS is shown in FIG. 30, which is a pictorial image of the virtual cylinder segment defining the VSS as a least square fit to a given AIS.

$${θ}_{vcmax} = {cos}^{- 1} ( \frac{{p}_{1}^{′} - {p}_{2}^{′}}{\vert {p}_{1}^{′} \vert \vert {p}_{2}^{′} \vert} ) \qquad ( 23 )$$

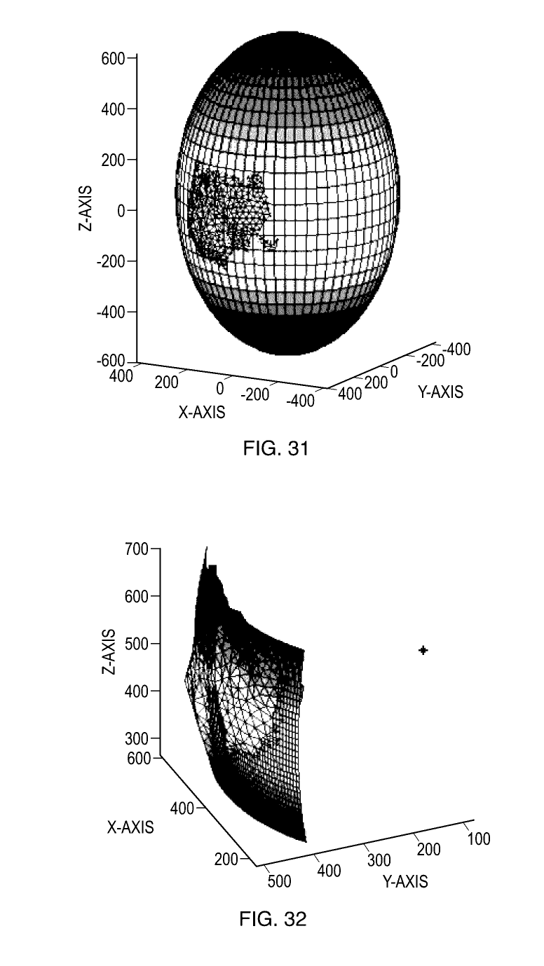

With regard to generation of the VAS, similar to the generation of the VSS, an ellipsoid that is a least square fit to the transformed AIS can be simply represented using eq. (24), where a, b and c are the radii of a specific ellipsoid along the x, y and z axes, φ and θ are two free variables, 0≦φ<π, 0≦θ<2π, as shown in FIG. 31, which is a pictorial image of the best fit ellipsoid. Thus, a parameter set s=(a,b,c) is used to control the ellipsoid geometry.

$$[ \begin{matrix}{x}_{e} \\ {y}_{e} \\ {z}_{e}\end{matrix} ] = [ \begin{matrix}a cos θ sin ϕ \\ b sin θ sin ϕ \\ c cos ϕ\end{matrix} ] \qquad ( 24 )$$

If an N-by-3 matrix f is defined whose i^{th} row vector is the distance from the i^{th} vertex (vₓᵢ, v_{yi}, v_{zi}) of the AIS to a point (xₑᵢ, yₑᵢ, zₑᵢ) on the ellipsoid surface that minimizes the distance between them:

$${f}_{i} = [ \begin{matrix}{f}_{i 1} \\ {f}_{i 2} \\ {f}_{i 3}\end{matrix} ] ′ = ( [ \begin{matrix}{v}_{xi} \\ {v}_{yi} \\ {v}_{zi}\end{matrix} ] - [ \begin{matrix}{x}_{ei} \\ {y}_{ei} \\ {z}_{ei}\end{matrix} ] ) ′ \qquad ( 25 )$$

To minimize the matrix f, another Jacobian matrix is constructed in equation (26). N is the total number of abdominal surface vertices.

$$J = [ \begin{matrix}\frac{\partial {f}_{i}}{\partial {s}_{1}} & \frac{\partial {f}_{i}}{\partial {s}_{2}} & \frac{\partial {f}_{i}}{\partial {s}_{3}} \\ … & … & … \\ \frac{\partial {f}_{N}}{\partial {s}_{1}} & \frac{\partial {f}_{N}}{\partial {s}_{2}} & \frac{\partial {f}_{N}}{\partial {s}_{3}}\end{matrix} ] \\ where \\ \{ \begin{matrix}\frac{\partial {f}_{i}}{\partial {s}_{1}} = [ \begin{matrix}- cos θ sin ϕ \\ 0 \\ 0\end{matrix} ] \\ \frac{\partial {f}_{i}}{\partial {s}_{2}} = [ \begin{matrix}0 \\ - sin θ sin ϕ \\ 0\end{matrix} ] \\ \frac{\partial {f}_{i}}{\partial {s}_{3}} = [ \begin{matrix}0 \\ 0 \\ - cos ϕ\end{matrix} ]\end{matrix} 1 \leq i \leq N \qquad ( 26 )$$

The parameter set s is continuously updated using eq. (19) and (20) until the tolerance t in eq. (21) reaches the predefined value (0.01 in one case). The initial guess of the ellipsoid radii are set to half of the AIS lengths along x, y and z axes. The LSF ellipsoid (FIG. 29) is actually coaxial with the LSF cylinder. In certain studies, all available 3-D image volumes have similar radii along the x and y axes, so a and b are replaced with their average value in the position transformation, as described below in detail. This makes VSS and VAS share the same segment angle θ_{vcmax} and simplify the position transformation. The VAS length is equal to the VSS length. The final VAS is shown in FIG. 32, which is a pictorial image of the virtual ellipsoid segment defining the VAS as a least square fit to a given AIS.

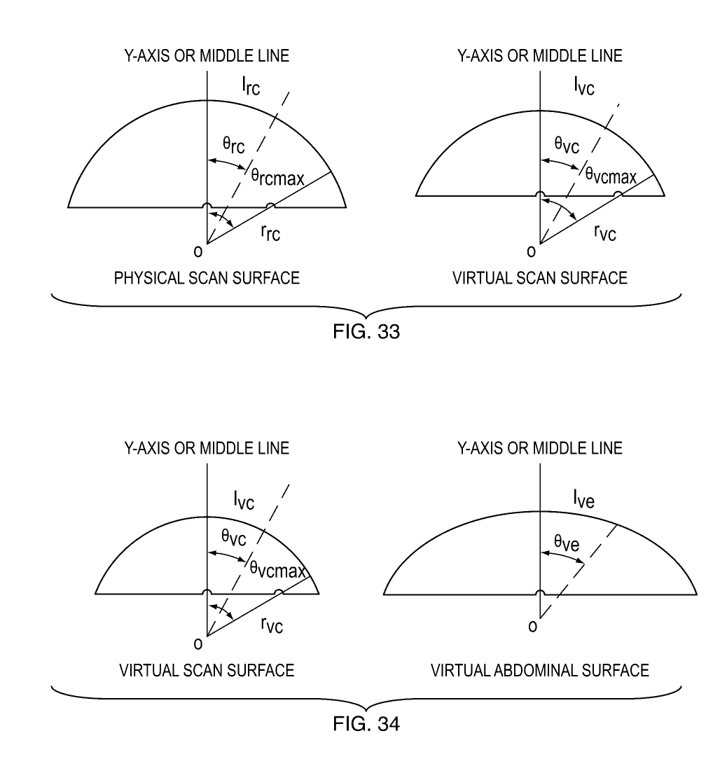

Position transformation from the physical scan surface (PSS) 106 to the virtual scan surface (VSS) will now be described in detail. In some exemplary embodiments, the PSS 106 is in the form of a cylindrical segment with fixed dimensions and spanning an angle of 120°, while the VSS is a best fit to the given image volume, under the constraints of cylindrical segment geometry with dimensions and spanning angle as variable parameters. Thus, the VSS and PSS are scaled so they can fully map to each other. The PSS and VSS length along the cylinder axis are normalized to the range [−0.5, 0.5]. The central angle θ_{vcmax} of VSS obtained as described above in detail is scaled to the PSS spanning angle of 120° so that a specific deviation angle (θ_{rc}) from the y-axis (middle line) of the PSS will yield the corresponding deviation angle (θ_{vc}) on the VSS through eq. (27), as shown in FIG. 33, which includes schematic cross-sectional diagrams of the PSS and VSS, illustrating deviation angles, according to exemplary embodiments. The normalized coordinate (z_{rc}) along cylinder axis (z-axis) of the PSS becomes the corresponding normalized coordinate (z_{vc}) on the VSS, as shown in eq. (28).

$$\begin{matrix}\frac{{θ}_{rc}}{2 π / 3} = \frac{{θ}_{vc}}{{θ}_{vcmax}} & ( 27 ) \\ {z}_{rc} = {z}_{vc} & ( 28 )\end{matrix}$$

Regarding position transformation from the virtual scan surface (VSS) to the virtual abdominal surface (VAS), for a specific position on the VSS, its unscaled coordinate (z_{vc}′) on z-axis is used to calculate angle φ in eq. (24). The θᵥₑ can be obtained in eq. (29), and then plugged into eq. (24), to calculate the x and y coordinates. All position transformations are actually referenced to the 3-D image volume coordinates, so the (x, y, z_{vc}′) is the position that guides 2-D ultrasound image extraction from the 3-D image volume, as illustrated in FIG. 34, which includes schematic cross-sectional diagrams of the VSS and VAS, illustrating deviation angles, according to exemplary embodiments.

θᵥₑ=θ_{vc} (29)

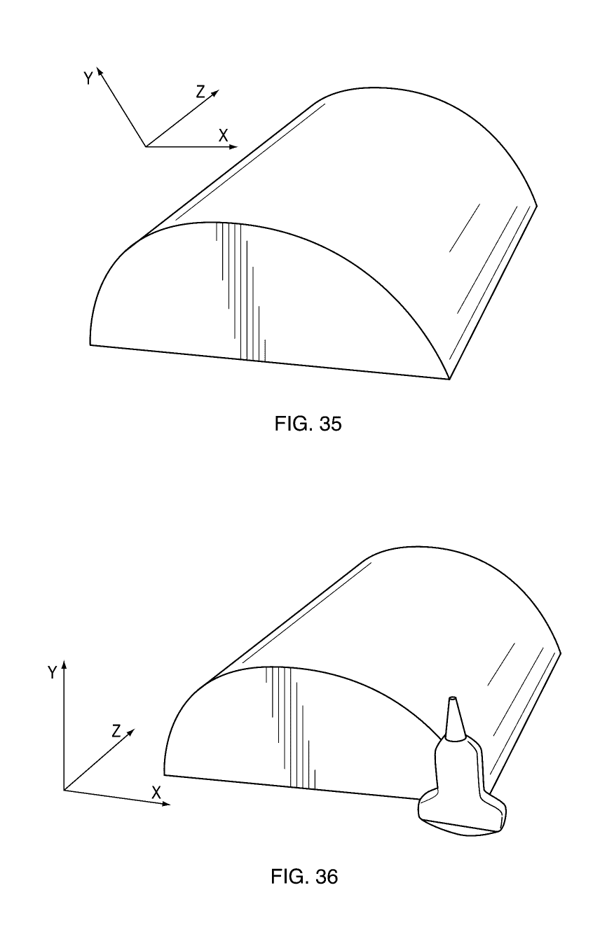

With regard to orientation transformation, the mock transducer orientation is measured in the IMU in the form of quaternions that reflect its orientation in world coordinates. As the IMU aligns to the magnetic north and the center of the earth, it will output an identity quaternion of (1,0,0,0). However, to determine the mock transducer orientation relative to the PSS, the IMU's world coordinates are transformed into a dynamic PSS-based local coordinate system defined by the normal (y-axis) to the PSS at the point of contact of the mock transducer, the long axis (z-axis) of the PSS and a vector (x-axis) tangential to the PSS and orthogonal to the other two axes, as is illustrated in FIG. 35, which is a pictorial image of a dynamic PSS-based local coordinate system, according to exemplary embodiments. A specific transducer orientation is calculated through two consecutive steps: 1) the transducer is only rotated along the PSS z-axis from identity quaternion orientation to a point on the PSS, as shown in FIG. 36, which is a pictorial image of an identity quaternion in PSS coordinates, according to exemplary embodiments, and then 2) rotated in the local coordinate at that point to make a smaller adjustment.

Assuming that the quaternion Qₚ is the orientation of the mock transducer at a specific position on the PSS referenced to world coordinates. Qₚ is then decomposed into three parts according to the following three coordinate operations, as shown in eq. (30).

Qₚ=Qₚ₁*Qₚ₂*Qₚ₃ (30)

Qₚ₁ is defined as the quaternion for the orientation of PSS in world coordinates; the calculation of Qₚ₁ is performed through an auto-calibration routine, described in detail below; Qₚ₂ is the quaternion that describes the mock transducer rotation only around z-axis of the PSS starting from the identity quaternion in the PSS coordinates, as shown in FIG. 36. This will generate a dynamic PSS-based local coordinate system at that specific position (FIG. 35). Qₚ₂ is derived from the deviation angle (θ_{rc} in FIG. 33). Qₚ₃ is the rotation referenced to this local coordinate system. By pre-multiplying the inverse of Qₚ₁ and Qₚ₂, the orientation referenced to local coordinate Qₚ₃ is obtained, as shown in eq. (31).

Qᵥ=Qₚ₁⁻¹*Qₚ₁⁻¹*Q^{p1}*Qₚ₂*Qₚ₂=Qₚ₃ (31)

In the position transformation, deviation angle (θ_{rc}) on the PSS is same as deviation angle (θᵥₑ) on the VAS, so Qᵥ can be directly used, which preserves the orientation referring to the dynamic PSS-based local coordinate system, to obtain quaternion Q.

Q=Qᵥₑ*Qᵥ (32)

Regarding auto calibration, when the transducer is roughly normal to the PSS in the local coordinate, the quaternion Qₚ₃ is mainly determined by the transducer spinning angle around its axis. Since the spinning angle can be obtained from the digital Anoto pen, Qₚ₃ is calculated through an Euler-to-quaternion transformation.

As Qₚ₂ is derived from the deviation angle (θ_{rc}) and Qₚ is the output of the transducer, the orientation of the PPS, Qₚ₁, can be obtained as given in eq. (33).

Qₚ₁=Qₚ*Qₚ₂⁻¹*Qₚ₂⁻¹=Qₚ₁*Qₚ₂*Qₚ₂*Qₚ₂⁻¹*Qₚ₂⁻¹ (33)

According to some exemplary embodiments, an ultrasound simulator, for example, ultrasound simulator 700 described in detail above, provides users, e.g., clinicians and medical students, with basic scanning training and that operates in either synchronous mode (group instruction) or asynchronous mode (independent learning). While implemented specifically for obstetrics ultrasound, the simulator architecture is sufficiently generic to allow the ultrasound training simulator to be applied to other medical disciplines, with the goal of helping to meet the training needs due to the expanding use of Point of Care (POC) ultrasound.

As described herein in detail, the simulator offers freehand, self-paced scanning training on an abdomen-sized curved surface and utilizes 3-D ultrasound image volumes. In some particular exemplary embodiments, the training covers orientation to obstetric space and fetal biometry, using a set of tasks based on the Obstetric Ultrasound Guidelines from the American Institute of Ultrasound in Medicine (AIUM). In the asynchronous mode, the learning is self-paced, and the learner's scanning performance is assessed by the simulator. The synchronous mode allows all training participants to observe a demonstration by the instructor in real-time or view the scanning ability of a chosen learner. The training effectiveness was evaluated by training twenty-four medical students on the simulator operating in the asynchronous mode, followed by a survey-based assessment.

The training of and assessment by the 24 medical students confirmed the training capabilities of the simulator, by showing reduction in training time as a function of the number of image volumes scanned. The accuracy of the biometric measurements was based on comparisons to reference values obtained by an expert sonographer. While the simulator was programmed to require that all measurements be performed with less than 10% error, in order to proceed to the next task, approximately 60% of the measurements were performed with an error of 5% or lower. The technical performance evaluation of the simulator in synchronous mode demonstrated that instructor-led training is feasible even in low-bandwidth networks, while the clinical evaluation indirectly confirmed the value of providing instructor-led introduction and assistance with specific tasks to the learners in synchronous mode.

E-learning encompasses the electronic delivery of texts, audios and streaming videos via internet, CDs and DVDs. E-learning in didactic ultrasound gives students the flexibility to plan their learning schedules without time and location constraints. In contrast, E-training in ultrasound scanning is challenging and has seen only limited use. Described in detail herein is an approach to ultrasound E-training utilizing networked simulators.

According to the exemplary embodiments, an inexpensive, compact ultrasound obstetric simulator, its evaluation as a training tool and its suitability for E-training are provided herein. The simulator is designed with low-cost hardware components for scanning emulation, utilizes a user-friendly software interface and provides a realistic scanning experience in obstetric ultrasound training. The training material is generated from mosaicked image volumes that include the fetus, the amniotic fluid and the placenta. In addition, the simulator can connect to other simulators located at any networked site to form an E-training system, where the training can be conducted as synchronous training (group training), or as asynchronous training (self-paced individual training), as determined by the instructor.

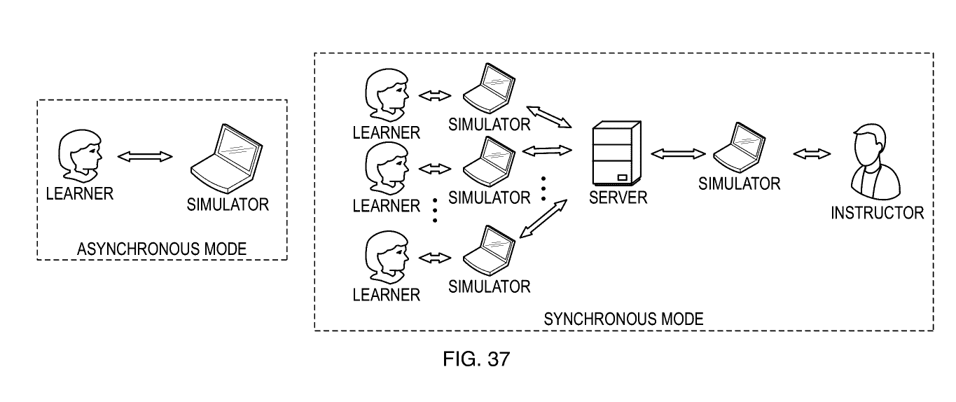

FIG. 37 is a schematic diagram depicting the ultrasound simulator 700 in synchronous mode and in asynchronous mode, i.e., stand-alone simulator, in accordance with exemplary embodiments. Referring to FIG. 37, regarding the synchronous/asynchronous modes of the ultrasound simulator system 700, in some particular exemplary embodiments, for the initial part of the learning and at regular intervals thereafter, a group of learners training with networked simulators can receive instructor-led training delivered in a synchronous format, i.e., E-training in ultrasound scanning, while for the majority of the time the training format is self-paced, asynchronous learning. Considering a traditional obstetric ultrasound scanning training scenario, involving an actual ultrasound system, a pregnant subject and an instructor teaching a small group of learners at the same time, typically, the instructor first demonstrates the ultrasound scanning approach required to locate and identify the specific anatomical structure(s) in question. The individual learners may then in turn perform the scanning under the instructor's guidance. Ideally, the learners should later have the opportunity to perform the scanning by themselves with minimal supervision. According to the exemplary embodiments, this training scenario is emulated using the obstetric ultrasound simulator 700, with the unique advantage that each group member can perform the scanning at a separate geographic location. The training format is implemented by first carrying out group learning in the synchronous mode, followed by individualized learning in the asynchronous mode, as illustrated in FIG. 37.

The synchronous mode allows all participants to observe the scanning ability of a chosen learner, or the demonstration of a given task by the instructor, using one active simulator. Thus, the active simulator generates all the images, virtual torso appearances, etc., that are displayed on the monitors of the networked passive simulators. The active simulator will hereafter be referred to as the operator simulator, whereas the passive simulators will be referred to as the observer simulators. The synchronous mode uses a dedicated server to accomplish the data transmission and the communication among networked simulators. During training in the synchronous mode, the assignment of operator simulator status is dynamically managed by the instructor. In contrast, the asynchronous mode is used for individualized training where the instructor configures all simulators to work independently as operator simulators. Training in the asynchronous mode is achieved by using a series of simulator-guided obstetric ultrasound training tasks, supported by tutorial videos, help functions and assessment capabilities.

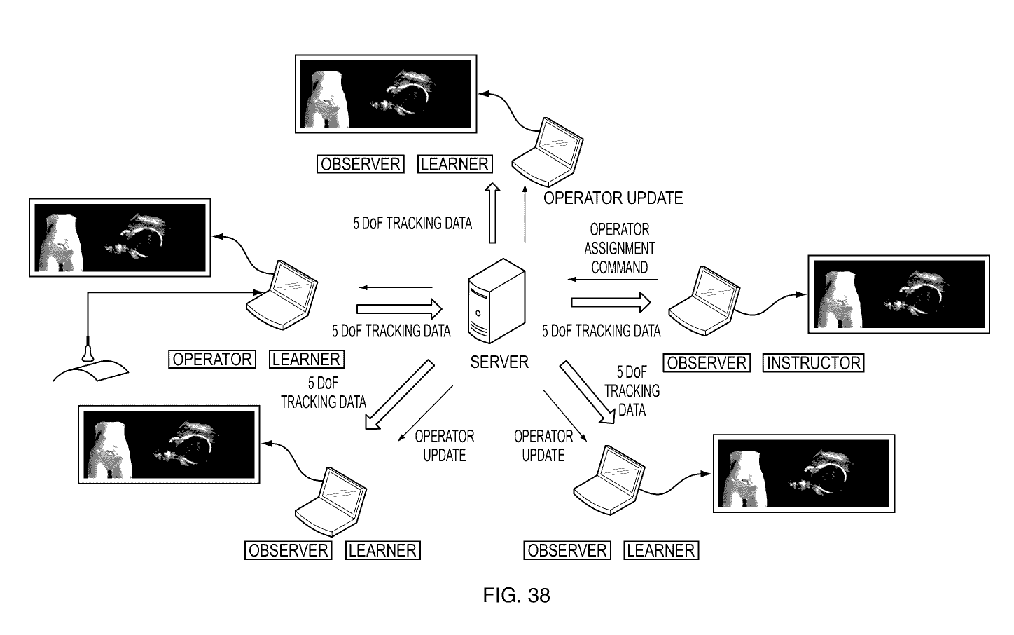

Regarding the implementation of the synchronous training system, the complete E-training system consists of several networked simulators and a dedicated server, as shown in FIG. 38, which is a schematic functional block diagram illustrating workflow of the ultrasound training simulators in synchronous mode, according to exemplary embodiments. Referring to FIG. 38, the bold straight arrow indicates the flow direction of the tracking data, while the narrow straight arrow shows the flow direction of instructor commands. In exemplary embodiments, the client-server architecture of E-training system provides several advantages. First, the instructor simulator has supervisory rights over all other simulators in order to manage the training and specifically assign a given simulator to have operator status, and a client-server architecture is appropriate for handling an incoming connection request based on the sender's identity (an instructor or a learner). Second, given that routers or gateways are widely used in modern networks, simulators not operating in the public network require network address translation (NAT) to make them visible to other networked simulators. Using a client-server architecture makes the implementation of NAT easier in the case of a simulator operating in a mobile network. Third, since only a limited number of learners (assumed less than 10) need to be accommodated into a synchronous training session at any given time, a client-server architecture is feasible.

In the exemplary embodiment of the synchronous mode, all networked simulators synchronously mirror the images on the operator simulator. That is, all networked simulators show on their own screens the movements of the virtual transducer on the virtual torso and display the 2D ultrasound images, identical to the images on the operator simulator. Transmitting this video stream in real time would pose a difficult challenge to 2G/3G mobile or low speed networks, often encountered in developing countries. However, the E-training system provided herein overcomes this challenge by only transmitting the tracking data, i.e., the transducer's position and orientation data, resulting in a very-low-bit-rate data transmission. In order for the observer simulators to synchronously mirror the operator simulator, they have the same image volume loaded. This is ensured through software commands from the instructor.

The central server shown in FIG. 38 has a public IP address to handle the process of establishing the connection to each client (or simulator); in addition, it manages the clients and relays tracking data. Since routers are likely to exist in the simulator network, a UDP hole punching mechanism is used to translate the private IP of a simulator connected to a router into a visible public IP address. For a simulator in the synchronous mode, its role either as operator or observer is determined by the instructor and thus must be dynamically changeable. At any time, there is only one operator simulator in the network, broadcasting the transducer's tracking data to other observer simulators. The instructor simulator and student simulators share the same software design except that the instructor simulator has, as described above, supervisory rights to manage the system.

With the communication channel established, the operator simulator can send the mock transducer's tracking data to the server through the “punched” UDP port. The server then relays these data to all observer simulators using the UDP protocol. At the client side, a first-in-first-out buffer is used to queue the incoming tracking data so that each observer simulator is able to smoothly render the 2D images. In addition to the transducer tracking data, the system also establishes text channels among all clients based on the TCP protocol.

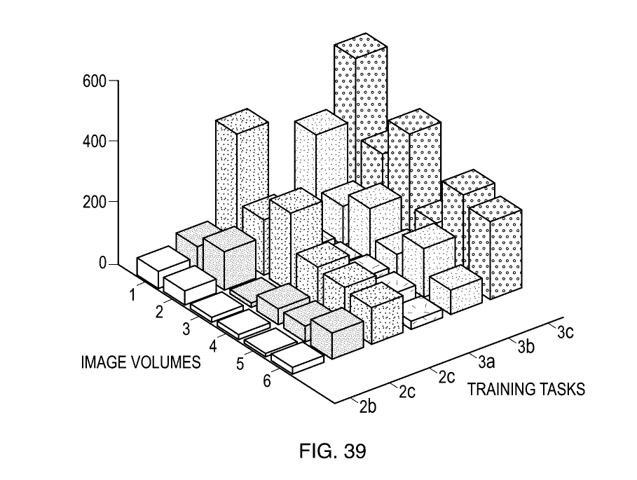

The training efficacy was primarily evaluated by comparing the scanning time of each task across the six available training image volumes. FIG. 39 includes a 3D presentation of the average scanning times, for all 24 medical students, for each of the 6 tasks, as the learners progressed through the 6 image volumes. While this figure shows that the average scanning time was reduced with increased training, the trend is not monotonic, partially due to the somewhat varying image quality across the six image volumes.

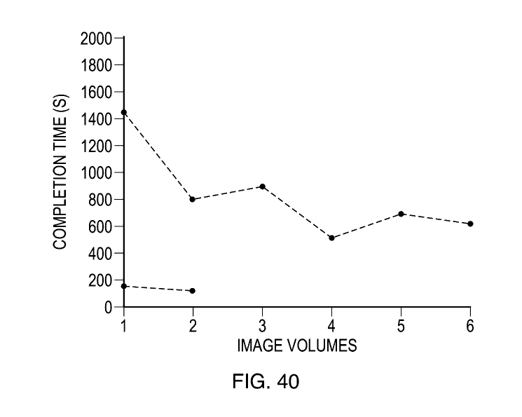

FIG. 40 is a graph illustrating the average scanning times of each image volume during the evaluation, according to exemplary embodiments. The upper curve in FIG. 40 shows the total scanning time for all six tasks associated with each image volume and averaged over all 24 medical students, as further evidence that increased training on the simulator does improve ultrasound scanning skills. On average, the students needed roughly 25 minutes to complete the six scanning tasks in image volume 1, while the scanning time was reduced to 8-12 minutes for the last three image volumes. However, the scanning time of image volume 5 can be observed to be longer than that for image volume 4, which is likely a consequence of two factors. First, most students completed image volumes 1 through 4 in their first session and thus required some re-learning time when starting their second session with image volume 5. Second, the image quality of image volume 4 is better than that of image volume 5. The lower curve in FIG. 40 is average scanning time for the six tasks, Task 2b to Task 3c, when carried out by two experienced sonographers, for image volumes 1 and 2. They completed each set of scanning tasks in about the same time, roughly 2 minutes. This contrasts the skill levels of an experienced sonographer with that of a learner with just a few hours of training.

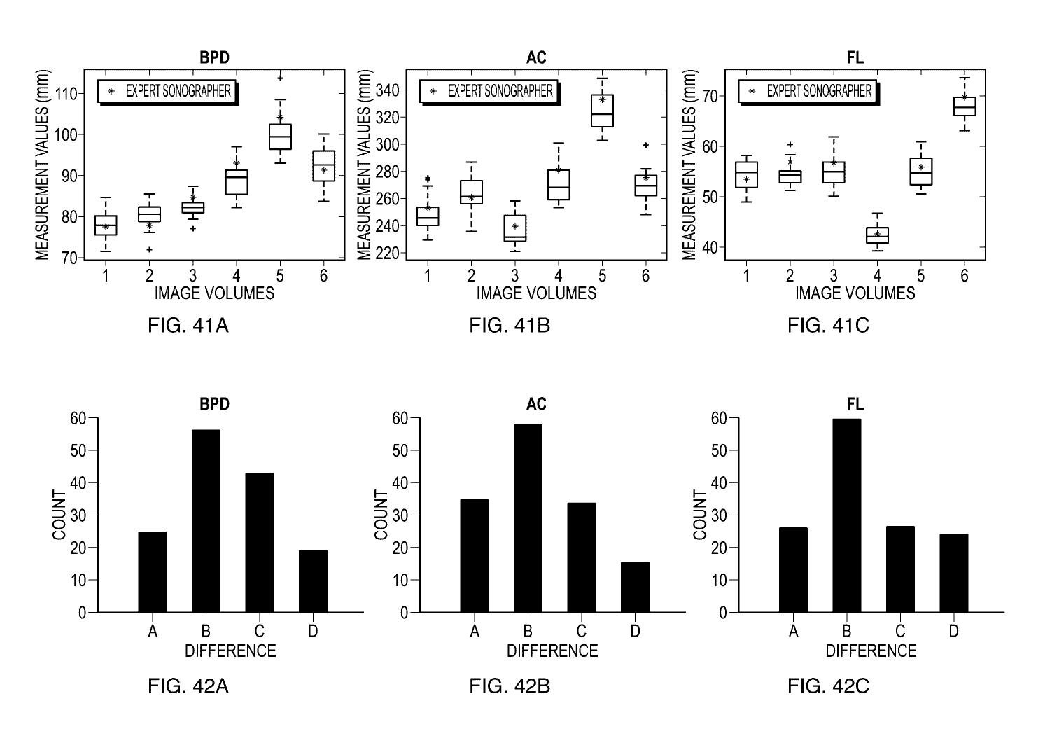

Regarding biometric measurements analysis, in some exemplary embodiments, the training tasks on the simulator 700 include three biometric measurements, Biparietal Diameter (BPD), Abdominal Circumference (AC) and Femur Length (FL). The training data show that 62.5%, 65.2% and 54.9% of the students performed BPD, AC and FL measurements, respectively, within +/−5% of the correct measurement values, as defined by the values obtained by an expert sonographer. The criterion for correct completion of a given biometric measurement task was a maximum error of 10%. FIGS. 41A, 41B and 41C shows box plots of BPD, AC and FL values, respectively, measured by the students and by the expert sonographer, according to exemplary embodiments. In FIGS. 41A-41C, the whiskers depict the minimum and maximum values of a given biometric measurement. FIGS. 42A, 42B and 42C include bar graph plots of the relative error in the BPD, AC and FL measurement values, respectively, when using as reference the values measured by the expert sonographer, according to exemplary embodiments. Each bar graph of FIGS. 42A, 42B and 42C illustrates distribution of the difference of the biometric measurements values by the students and by the sonographer (histogram). The error was calculated using eq. (34). The 4 bars span the error range from −0.10 to +0.10, where bars A, B, C and D represent the intervals of [−0.1, −0.05), [−0.05, 0.0), [0.0, 0.05], (0.05, 1.0], respectively.

$$error = \frac{user measured value - sonographer measured value}{sonographer measured value} * 100 \% \qquad ( 34 )$$

The performance evaluation of the synchronous mode of the simulator, i.e. the E-training system, focused on the quality of the transmitted tracking data by measuring latency, data loss and bit rate in the transmission, and relating this to the image quality of the observer simulators. The E-training system operation was evaluated in two major types of networks, i.e., cellular networks and 802.11 wireless networks. Currently, major wireless carriers in United States have upgraded their cellular networks to 3G/4G. Hence, the system was tested in 3G/4G. The carrier's channel access technology was not considered in the evaluation. For 802.11 wireless networks, the most common scenario is that an end-user accesses the internet through a router at his/her hospital, clinic or office; therefore, the system was tested in a router-based wireless network. The current E-training system is designed to support a limited number of users in a given training session, and the system was tested with the minimal number of participants, specifically, three simulators (one instructor and two learner simulators), under the following three conditions.

A. All simulators in wireless network.
B. All simulators in cellular network.
C. Same condition as A, except that the data from the operator simulator were routed via a laptop located in China.

The above three conditions cover most of cases where the system would be operating. Condition C was intended to emulate the case where international learners participate in the training. The test in each condition lasted 3 to 5 minutes.

Three simulator computers were utilized for this evaluation: Computer 1 served as the instructor simulator, in observer mode, Computer 2 served as a learner simulator, in observer mode, while Computer 3 served as a learner simulator, but in operator mode. Computers 1 and 2 were configured with Intel i7 processors and 8 GB memory whereas Computer 3 was configured with Intel Xeon processor and 16 GB memory. All three computers have 64-bit Windows 7 and Intel HD graphic cards installed.

The test matrix includes three performance parameters:

(1) Bit rate: The operator simulator updates tracking data approximately 25 times per second to guarantee a smooth visual experience. Each update contains less than 100 bytes of tracking data. This is a very low bit rate so that we recorded both the peak bit rate and average bit rate.
(2) Data loss: The E-training system uses the UDP protocol for transmission of tracking data. A significant loss of tracking data not only degrades the quality of the image stream and the diagnostic utility (as would be encountered with skipped frames), but also makes the 2D image display on simulators lose synchronization. As will be shown, the actual observed data loss was very small. In order to find the upper limit for data loss that does not noticeably impact visual smoothness of the ultrasound images and is able to keep all simulators synchronized, we also tested the E-training system performance under manually controlled data loss.
(3) Latency: This is an important factor that affects the degree to which the simulated 2D image rendering is synchronized between the operator simulator and any of the observer simulators. Given that we are not able to synchronize the system clocks of the three laptops to millisecond level, we measured the two-way transmission latency instead of the one-way latency.

The test results showed that the average bit rate under all three conditions was approximately 3-4 kB/s. The data loss was less than 1% and no frameskip was detected in any of the experiments. The tests also showed that the tracking data from the operator simulator usually reached the observer simulators in less than 100 ms so that the transmission latency did not negatively impact the quality of the image stream. That is, the 2D images on all simulators could be considered to be synchronous.

An additional test was designed to determine the maximum data loss that does not impact the visual smoothness of the image stream, by using a normal distribution function to determine whether a given tracking data packet would be randomly discarded or not during the transmission. The test showed that there was no observable frameskip as long as the tracking data loss was less than 35%. This evaluation was performed under condition A.

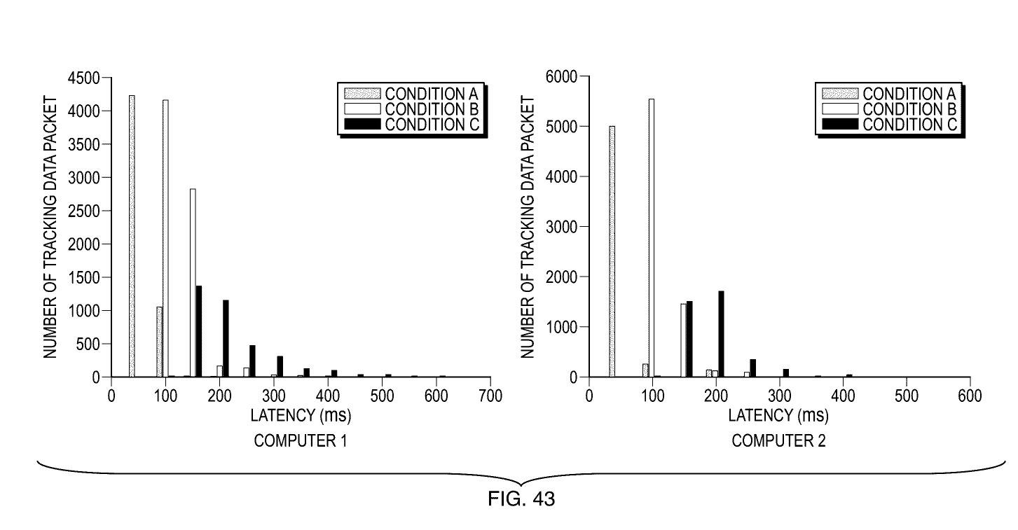

The latencies under the three conditions were not exactly identical, but they all met the requirement that the E-training system was operationally synchronous, meaning that human observers, looking simultaneously at the screens of the operator simulator and an observer simulator, could not detect any delay difference between the images on these two displays. FIG. 43 includes bar graphs, illustrating two-way latencies for the 3 test conditions, from Computers 1 and 2. In the graphs of FIG. 43, the left and right columns are the histograms of two-way latencies for packets from Computers 1 and 2, respectively. It can be seen that the one-way latency is less than 100 ms for 90% of packets, under condition A and B. A latency of 100 ms is widely accepted as a threshold to distinguish between detectable and indiscernible latency. That is, the E-training system according to the exemplary embodiments is considered synchronous. In condition C, the one-way latency mostly ranges from 100-200 ms. Although it is larger than the 100 ms threshold, 2D images were not observed to be out-of-sync in the experiments.

While the present teachings have been described above in terms of specific embodiments, it is to be understood that they are not limited to these disclosed embodiments. Many modifications and other embodiments will come to mind to those skilled in the art to which these present teachings pertain, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

We claim:

1. An ultrasound training simulator system, comprising:
a physical scan surface for simulating an anatomical surface;
a mock transducer for moving over the physical scan surface to simulate an ultrasound transducer scanning the anatomical surface;
a memory for storing data for a three-dimensional (3-D) image volume; and
a processor for receiving one or more signals generated by the mock transducer related to position and orientation of the mock transducer as the mock transducer is moved over the physical scan surface, the processor identifying data for a two-dimensional (2-D) image data slice within the data for the 3-D image volume based on the signals related to position and orientation of the mock transducer; wherein:
the mock transducer comprises an optical tracking system for tracking the position of the mock transducer on the physical scan surface and an inertial tracking system for tracking orientation of the mock transducer, the optical tracking system and the inertial tracking system generating signals from which the one or more signals related to position and orientation of the mock transducer are generated.

2. The ultrasound training simulator system of claim 1, wherein the optical tracking system comprises a digital-paper-based optical tracking system.

3. The ultrasound training simulator system of claim 2, wherein the digital-paper-based optical tracking system is an Anoto® system.

4. The ultrasound training simulator system of claim 1, wherein the optical tracking system comprises a 2-D array of optically detectable elements on the physical scan surface.

5. The ultrasound training simulator system of claim 4, wherein the optical tracking system comprises an optical detector in the mock transducer for detecting the optically detectable elements on the physical scan surface.

6. The ultrasound training simulator system of claim 1, wherein the optical tracking system comprises an optical detector in the mock transducer for detecting optically detectable elements of a 2-D array of optically detectable elements on the physical scan surface.

7. The ultrasound training simulator system of claim 1, wherein the optical tracking system is an infrared (IR) optical tracking system.

8. The ultrasound training simulator system of claim 1, wherein the inertial tracking system comprises an inertial measurement unit (IMU).

9. The ultrasound training simulator system of claim 1, wherein the inertial tracking system comprises a three-axis gyroscope.

10. The ultrasound training simulator system of claim 1, further comprising a display coupled to the processor for presenting a 2-D image generated by reslicing the 3-D image volume.

11. The ultrasound training simulator system of claim 1, wherein the processor presents ultrasound training tasks on display to be performed by a trainee moving the mock transducer over the scanning surface.

12. The ultrasound training simulator system of claim 11, wherein the training tasks comprise at least one of identifying anatomical structures and performing biometric measurements.

13. The ultrasound training simulator system of claim 11, wherein the processor generates an assessment of the trainee's performance of the ultrasound training tasks.

14. The ultrasound training simulator system of claim 13, wherein assessment criteria for acceptable accuracy of a biometric measurement performed by the trainee are adjustable.

15. The ultrasound training simulator system of claim 1, wherein the 3-D image volume includes at least one landmark bound comprising a surface at least partially enclosing an anatomical landmark in the 3-D image volume, an assessment generated by the processor comprising a determination as to whether an identification of the anatomical landmark is within the landmark bound in the 3-D image volume.

16. The ultrasound training simulator system of claim 15, wherein accuracy of the assessment is adjustable by adjusting a distance between the landmark bound and the anatomical landmark.

17. The ultrasound training simulator system of claim 13, wherein the assessment is displayed on a display such that feedback is provided to the trainee.

18. The ultrasound training simulator system of claim 1, wherein a user interface permits the trainee to access instructional information stored in the memory to assist with performance of the training tasks.

19. The ultrasound training simulator system of claim 17, wherein the instructional information accessed by the trainee is related to a specific training task being performed by the trainee.

20. The ultrasound training simulator system of claim 1, wherein the physical scan surface is associated with a virtual torso and the mock transducer is associated with a virtual transducer, the processor performing a transformation between the physical scan surface and the virtual torso and between the mock transducer and the virtual transducer such that the signals related to position and orientation of the mock transducer as the mock transducer is moved over the physical scan surface are associated with positions in the 3-D image volume.

21. The ultrasound training simulator system of claim 1, further comprising:
at least one second ultrasound training simulator system remote from the first ultrasound training simulator system and coupled to the first ultrasound training simulator system over a network; and
at least one second memory coupled to the at least one second ultrasound training simulator system for storing the data for the 3-D image volume; wherein
the at least one second ultrasound training simulator system receives over the network the one or more signals generated by the mock transducer related to position and orientation of the mock transducer as the mock transducer is moved over the physical scan surface, the at least one second ultrasound training simulator system identifying data for a 2-D image data slice within the data for the 3-D image volume based on the signals related to position and orientation of the mock transducer.

22. The ultrasound training simulator system of claim 21, wherein one of the first and second ultrasound training simulator systems is an active system defined as an operator simulator, and another of first and second ultrasound training simulator systems is a passive system defined as an observer simulator.

23. The ultrasound training simulator system of claim 22, wherein an input provided via a user interface defines which of the first and second ultrasound training simulator systems is defined as the operator simulator.

24. The ultrasound training simulator system of claim 23, wherein one of the ultrasound training simulator systems is operable by an instructor, and at least one second ultrasound training simulator system is operable by a trainee, wherein the status of operator simulator is assignable by the instructor to either himself or to a selected trainee, wherein at least one second ultrasound training simulator system is assignable the status of observer simulator, and wherein a signal defining the operator simulator and the observer simulators is generated by the instructor's simulator.

25. The ultrasound training simulator system of claim 24, wherein a 2-D image display on at least one of the observer simulators is generated by reslicing the 3-D image volume based on signals received over the network from the operator simulator.
